(19) United States
(12) Patent Application Publication
(10) Pub. No.: US 2025/0298470 A1
(43) Pub. Date: Sep. 25, 2025

(54) Devices, Methods, and Graphical User Interfaces for Navigating User Interfaces within Three-Dimensional Environments

(71) Applicant: Apple Inc., Cupertino, CA (US)

(72) Inventors: Evgenii Krivoruchko, San Francisco, CA (US); Jonathan Ravasz, Sunnyvale, CA (US); Matan Stauber, San Francisco, CA (US); Stephen O. Lemay, Palo Alto, CA (US); Zoey C. Taylor, San Francisco, CA (US); Christopher D. McKenzie, Burlingame, CA (US); Alexander T. Wing, Fremont, CA (US); Jonathan R. Dascola, San Francisco, CA (US); Israel Pastrana Vicente, Spring, TX (US)

(21) Appl. No.: 19/039,505

(22) Filed: Jan. 28, 2025

Related U.S. Application Data
(60) Provisional application No. 63/567,364, filed on Mar. 19, 2024.
(60) Provisional application No. 63/662,377, filed on Jun. 20, 2024.

(51) Int. Cl. G06F 3/01; G06F 3/04815; G06F 3/0482; G06F 3/04845; G06F 3/0485; G06F 3/0486

(52) U.S. Cl. CPC G06F 3/017; G06F 3/013; G06F 3/04815; G06F 3/0482; G06F 3/04845; G06F 3/0485; G06F 3/0486; G06F 2203/04806

(57) ABSTRACT

While a view of an environment is visible via a display generation component, a computer system detects a first user input. In response to detecting the first user input, if the first user input is performed while a hand of a user is oriented with a palm of the hand facing toward a viewpoint of the user, the computer system performs a system operation that includes displaying, in the environment, multiple representations of applications. In response to detecting the first user input, if the first user input is performed while the hand of the user is oriented with the palm of the hand facing away from the viewpoint of the user, the computer system performs an operation associated with a location in the environment toward which the user's attention is directed.

### RELATED APPLICATIONS

This application claims priority to U.S. Provisional Patent Application No. 63/662,377, filed Jun. 20, 2024, and U.S. Provisional Patent Application No. 63/567,364, filed Mar. 19, 2024, each of which is hereby incorporated by reference in its entirety.

### TECHNICAL FIELD

The present disclosure relates generally to computer systems that are in communication with a display generation component and, optionally, one or more input devices that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for navigating user interfaces within environments that include at least some virtual elements (e.g., between system user interfaces, and/or between application user interfaces, applications, augmented reality environments, mixed reality environments, and virtual reality environments) are cumbersome, inefficient, and limited. For example, systems that require extensive input to invoke system user interfaces or systems that require a series of inputs to switch between application user interfaces are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for navigating system user interfaces and application user interfaces that make interaction with the computer systems more efficient and intuitive for a user. Such methods and interfaces optionally complement or replace conventional methods for navigating between user interfaces when providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is a portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for navigating user interfaces within a three-dimensional environment. Such methods and interfaces may complement or replace conventional methods for navigating user interfaces within a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In accordance with some embodiments, a method is performed at a computer system that is in communication with a display generation component and one or more input devices. The method includes, while a view of an environment is visible via the display generation component, detecting a first user input. The method includes, in response to detecting the first user input in accordance with a determination that the first user input includes movement in depth relative to a viewpoint of the user and that the first user input is directed to a user interface element that is moveable in depth in the view of the environment, displaying the user interface element at an updated location within the environment that corresponds to the first user input. The method includes in accordance with a determination that the first user input includes movement in depth relative to the viewpoint of the user that meets first criteria, wherein the first criteria include a requirement that the first user input is not directed to a user interface element that is moveable in depth in the view of the environment in order for the first criteria to be met, displaying a system user interface in the view of the environment.

In accordance with some embodiments, a method is performed at a computer system that is in communication with a display generation component and one or more input devices. The method includes, while a view of an environment is visible via the display generation component, displaying an application user interface that includes content associated with a first hierarchy level of a plurality of hierarchy levels in the application. The method includes, while displaying the application user interface, detecting a first user input and in response to detecting the first user input, and in accordance with a determination that the first user input includes movement in depth relative to a viewpoint of a user that meets first set of one or more criteria, displaying content associated with a respective hierarchy level that was displayed prior to displaying the content associated with the first hierarchy level.

In accordance with some embodiments, the method is performed at a computer system that is in communication with a display generation component and one or more input devices. The method further includes, while a view of an environment is visible via the display generation component, detecting a first user input. The method includes, in response to detecting the first user input: in accordance with a determination that the first user input is performed while a hand of a user is oriented with a palm of the hand facing toward a viewpoint of the user, performing a system operation that includes displaying, in the environment, multiple representations of applications and; in accordance with a determination that the first user input is performed while the hand of the user is oriented with the palm of the hand facing away from the viewpoint of the user, performing an operation associated with a location in the environment toward which the user's attention is directed.

In accordance with some embodiments, a method is performed at a computer system that is in communication with a display generation component and one or more input devices. The method includes, while an environment is visible via the display generation component, detecting a first air gesture. The method includes, in response to detecting the first air gesture, displaying an application switching user interface. The method includes, while displaying the application switching user interface, detecting a first input that includes movement of a first input element followed by an event corresponding to a request to select an active application user interface. The method includes, in response to detecting the first input: in accordance with a determination that the event corresponding to the request to select an active application user interface occurs while the first input element is directed toward a first location on the application switching user interface, displaying a first application user interface corresponding to the first location as the active application user interface; and in accordance with a determination that the event corresponding to the request to select an active application user interface occurs while the first input element is directed toward a second location on the application switching user interface, where the second location is different from the first location, displaying a second application user interface corresponding to the second location as the active application user interface. The second application user interface is different from the first application user interface.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing extended reality (XR) experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate an XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7M illustrate example techniques for displaying a system user interface based on an air gesture, in accordance with some embodiments.

FIGS. 8A-8M illustrate example techniques for navigating content of different hierarchy levels in an application, in accordance with some embodiments.

FIGS. 9A-9Y illustrate example techniques for performing different operations based on an orientation of a palm of a user's hand, in accordance with some embodiments.

FIGS. 10A-10J illustrate example techniques for interacting with an application switching user interface, in accordance with some embodiments.

FIGS. 11A-11D are flow diagrams of methods of displaying a system user interface based on an air gesture, in accordance with various embodiments.

FIGS. 12A-12B are flow diagrams of methods of navigating content of different hierarchy levels in an application, in accordance with various embodiments.

FIGS. 13A-13D are flow diagrams of methods of performing different operations based on an orientation of a palm of a user's hand, in accordance with various embodiments.

FIGS. 14A-14D are flow diagrams of methods of interacting with an application switching user interface, in accordance with various embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system detects a first user input, and if the first user input includes movement in depth relative to a viewpoint of the user and that the first user input is directed to a user interface element that is moveable in depth in the view of the environment, the computer system displays the user interface element at an updated location within the environment that corresponds to the first user input. If the first user input includes movement in depth relative to the viewpoint of the user and is not directed to a user interface element that is moveable in depth in the view of the environment, the computer system displays a system user interface in the view of the environment. This enables a user to display system user interfaces more quickly by using a simple gesture (e.g., an air pinch-and-push gesture) while attention is directed to a location within the three-dimensional environment that is without a user interface element that is moveable in depth. The same gesture, when directed to an applicable user interface element, can be used to move the user interface element in depth.

In some embodiments, a method is performed at a computer system that is in communication with a display generation component and one or more input devices. The method includes, while a view of an environment is visible via the display generation component, displaying an application user interface that includes content associated with a first hierarchy level of a plurality of hierarchy levels in the application. The method includes, while displaying the application user interface, detecting a first user input and in response to detecting the first user input, and in accordance with a determination that the first user input includes movement in depth relative to a viewpoint of a user that meets first set of one or more criteria, displaying content associated with a respective hierarchy level that was displayed prior to displaying the content associated with the first hierarchy level. This enables content associated with different hierarchy levels to be more easily accessed of a user increases the range of inputs supported and thus enables operations to be performed more quickly and intuitively on the computer system and without displaying additional controls.

In some embodiments, the computer system detects a first user input, and if the first user input is performed while a hand of a user is oriented with a palm of the hand facing toward a viewpoint of the user, the computer system performs a system operation that includes displaying, in the environment, multiple representations of applications. If the first user input is performed while the hand of the user is oriented with the palm of the hand facing away from the viewpoint of the user, the computer performs an operation associated with a location in the environment toward which the user's attention is directed. This allows disambiguation between displaying a system user interface or performing an operation associated with attention of the user based on an orientation of the user's palm, allowing operations to be performed more quickly and intuitively on the computer system and without displaying additional controls.

In some embodiments, the computer system detects a first air gesture, and displays an application switching user interface. The computer system, while displaying the application switching user interface, detects a first input that includes movement of a first input element followed by an event corresponding to a request to select an active application user interface. If the event corresponding to the request to select an active application user interface occurs while the first input element is directed toward a first location on the application switching user interface, the computer system displays a first application user interface corresponding to the first location as the active application user interface. If the event corresponding to the request to select an active application user interface occurs while the first input element is directed toward a second location on the application switching user interface, the computer system displays a second application user interface corresponding to the second location as the active application user interface. This enables a user to easily switch between applications, including immersive applications, while interacting with the three-dimensional environment.

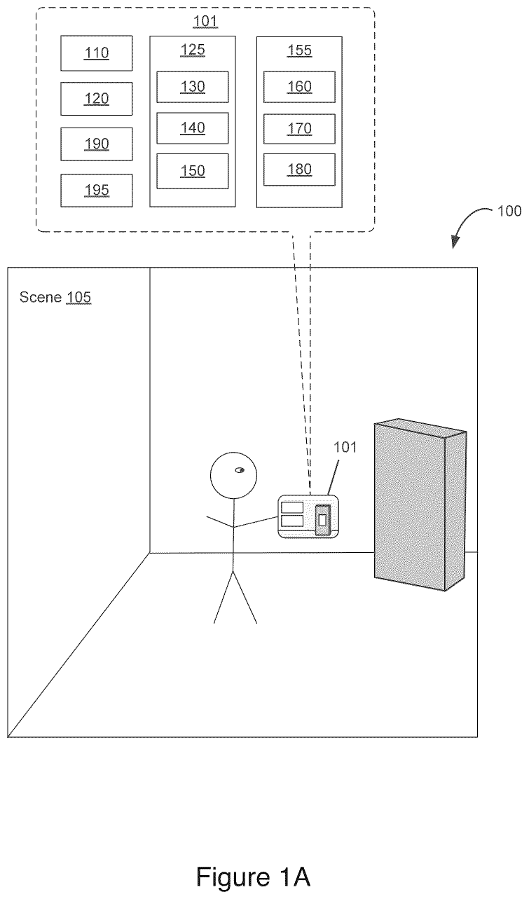

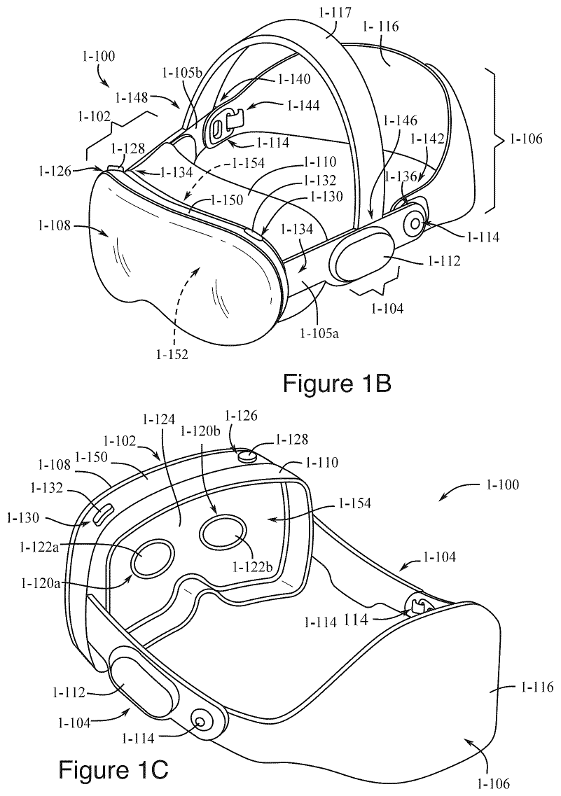

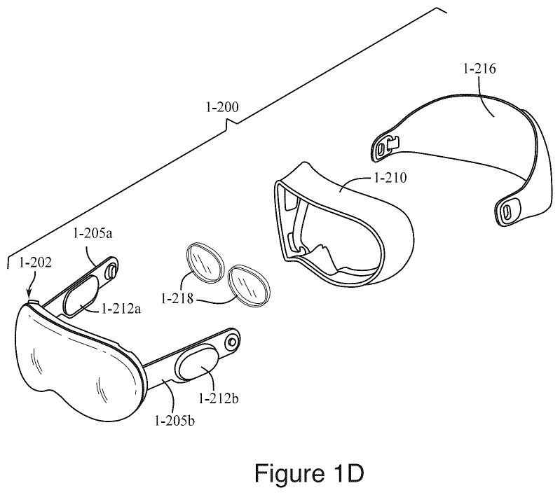

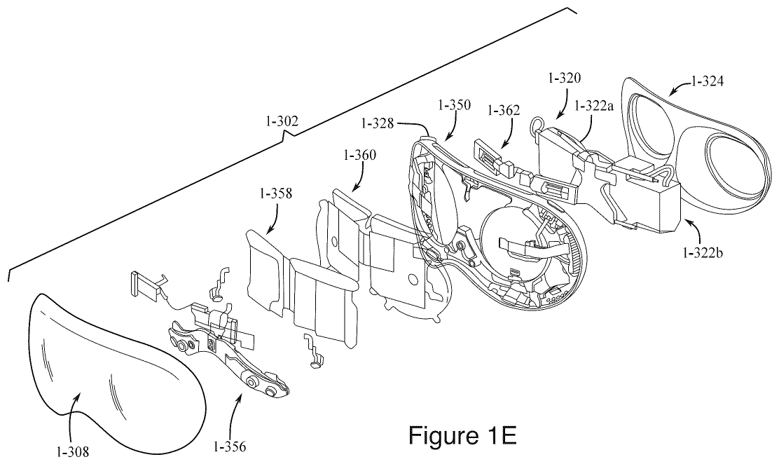

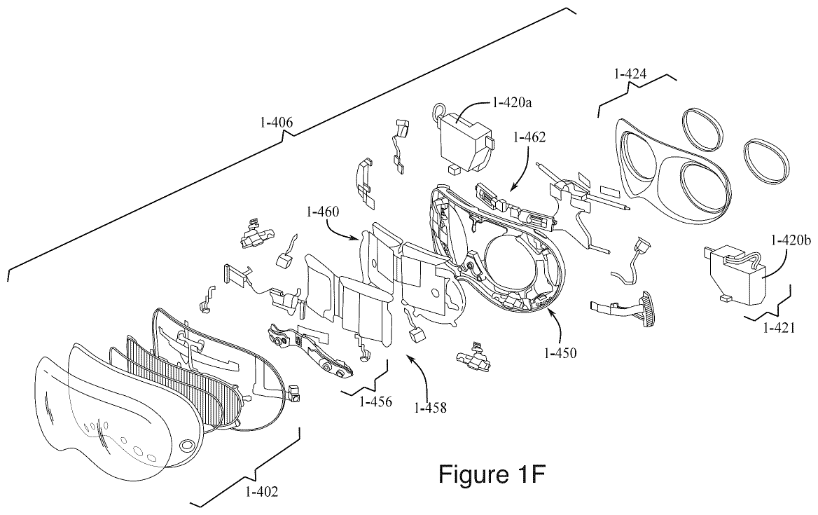

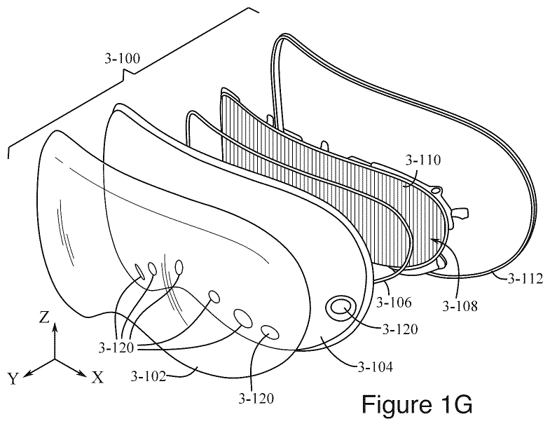

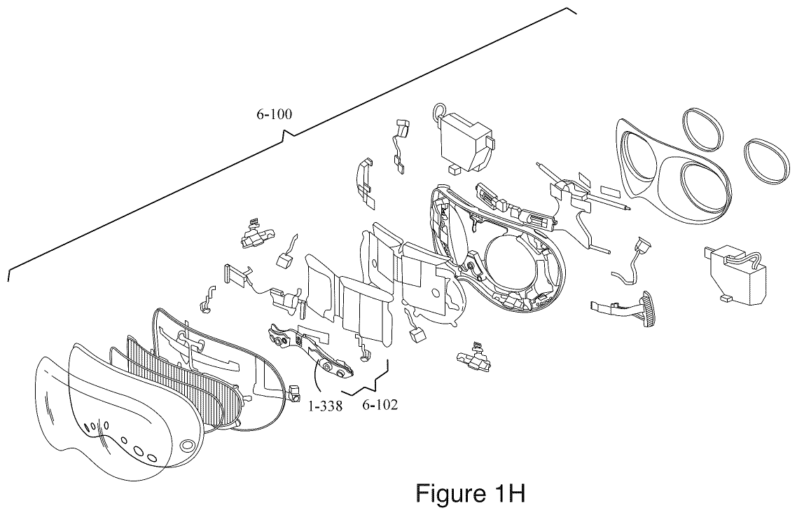

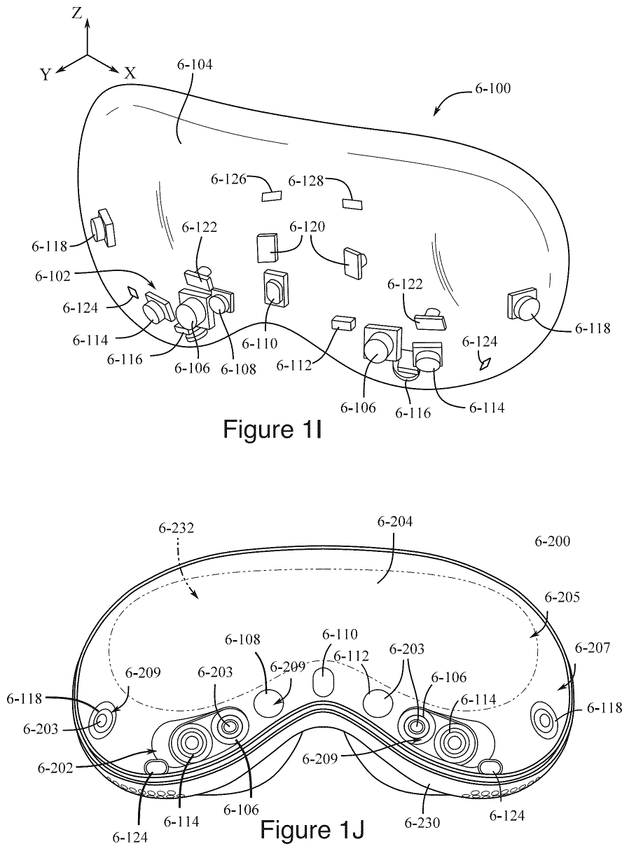

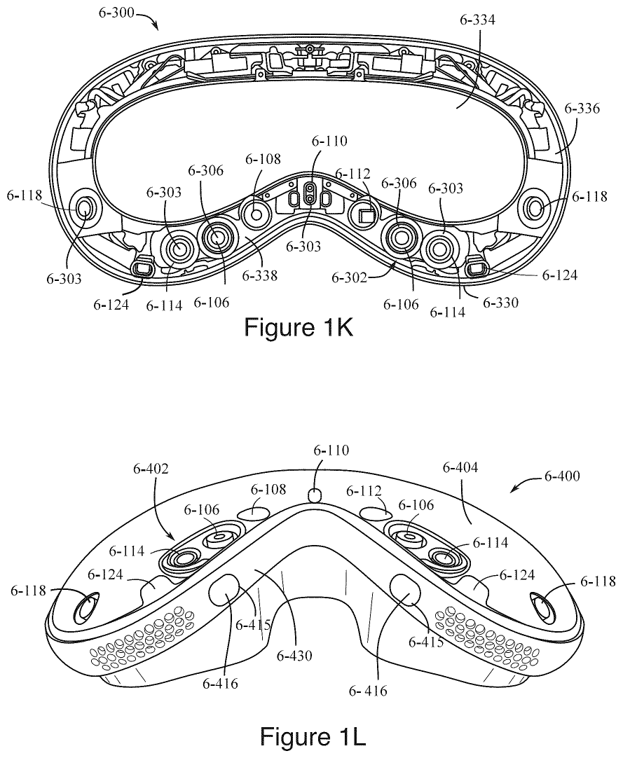

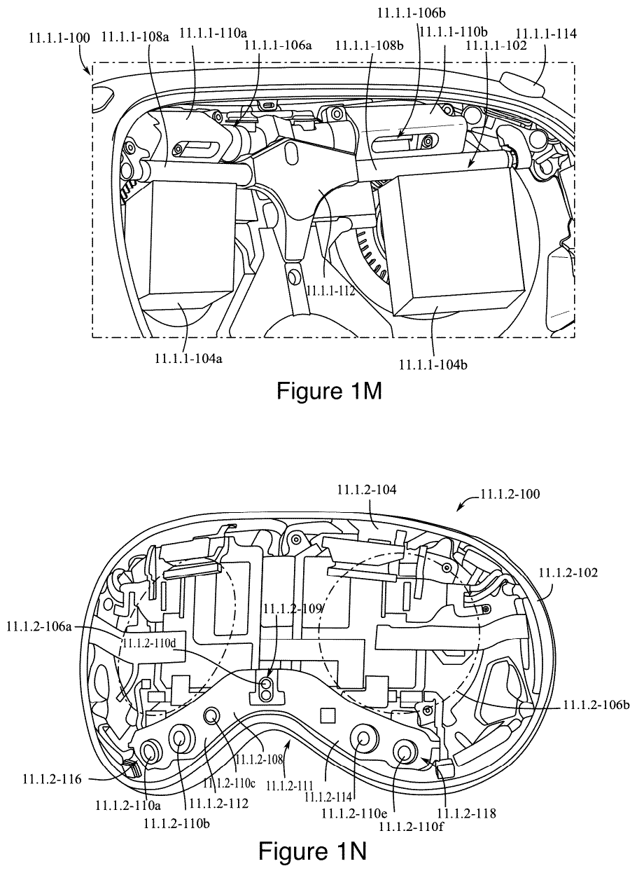

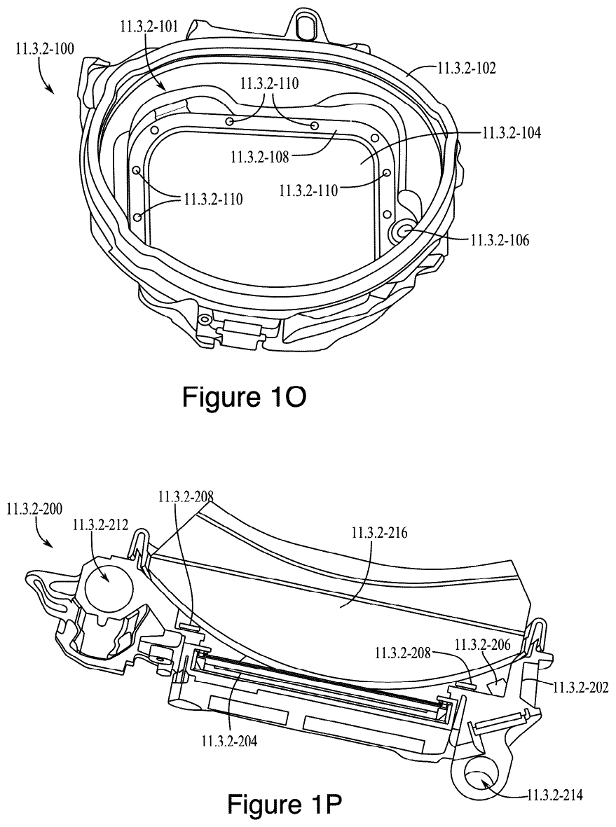

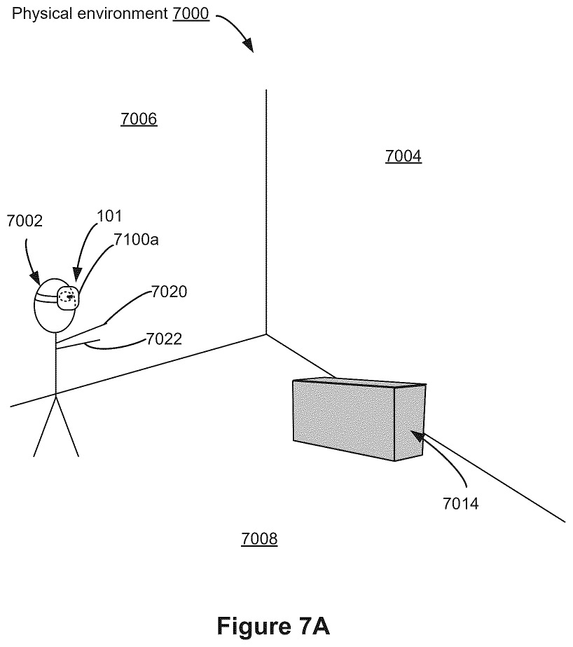

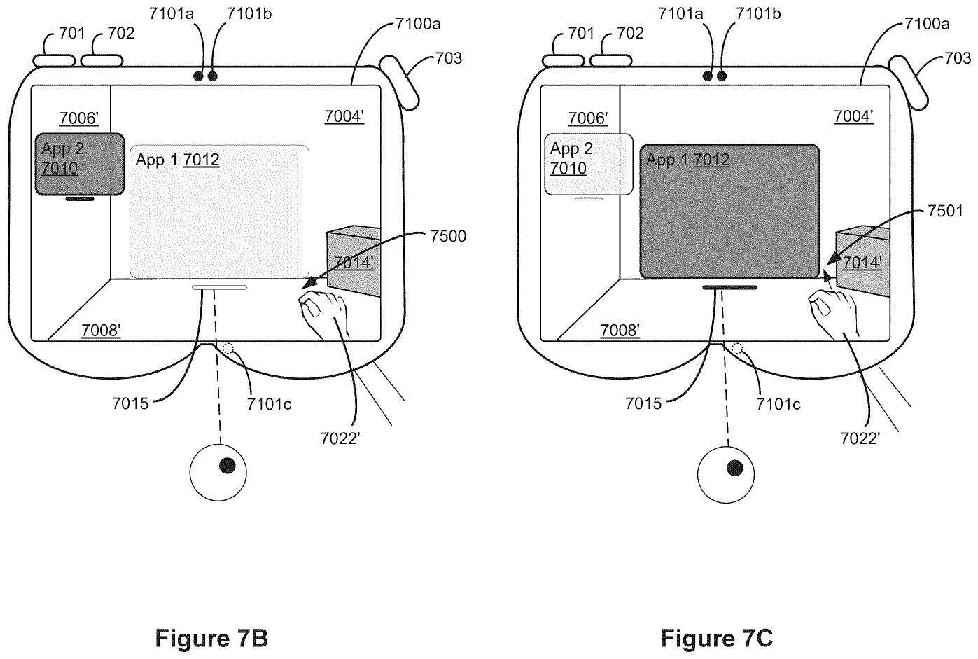

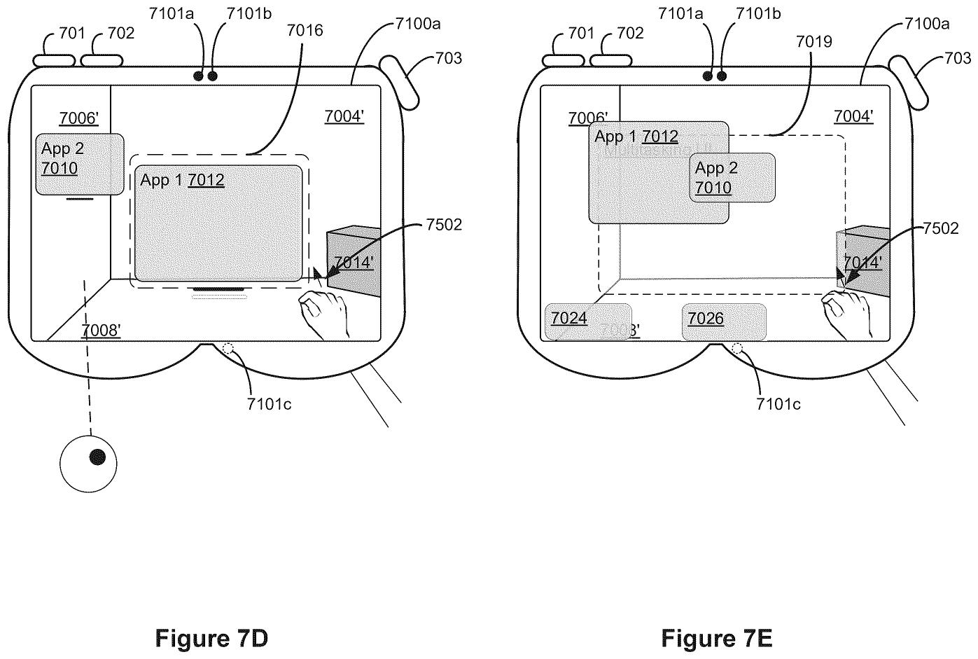

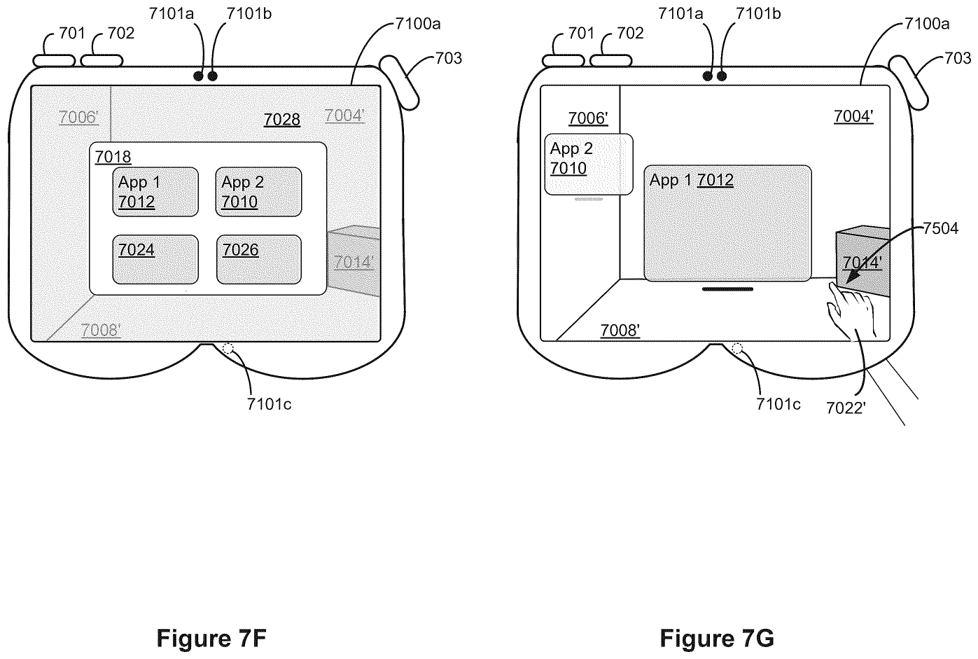

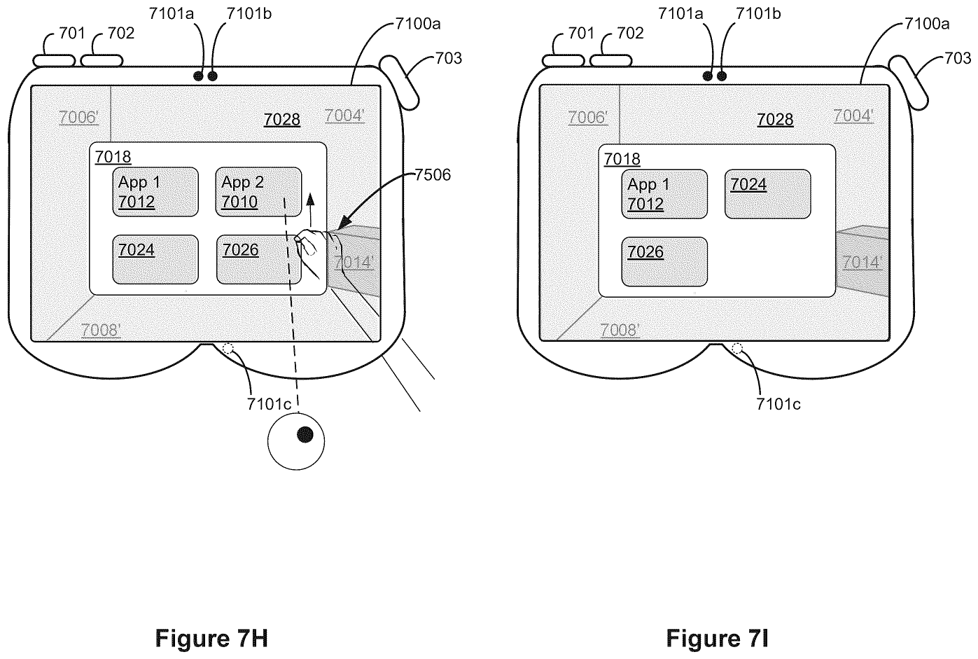

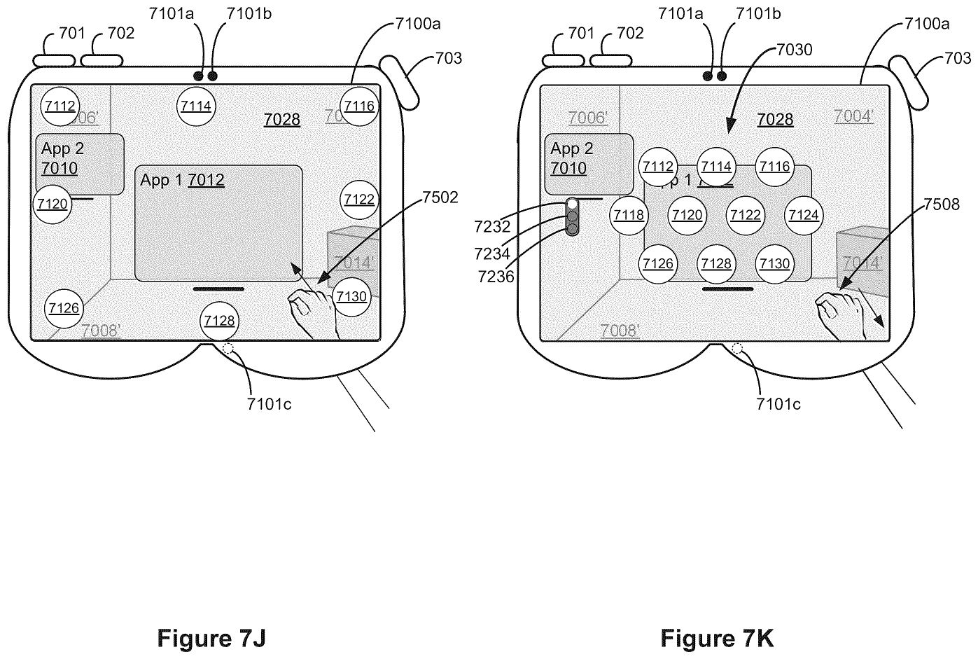

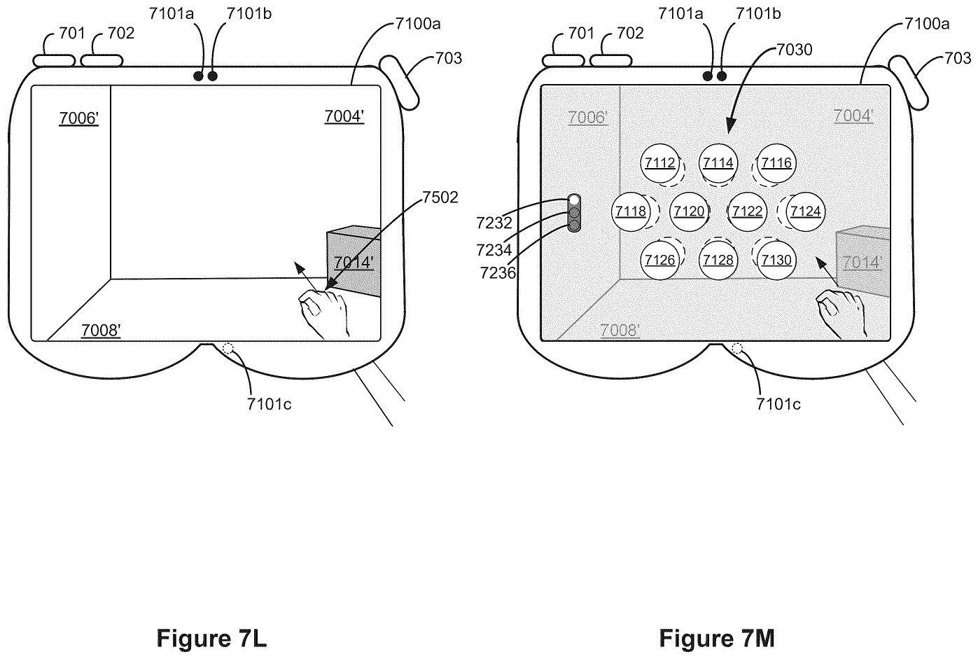

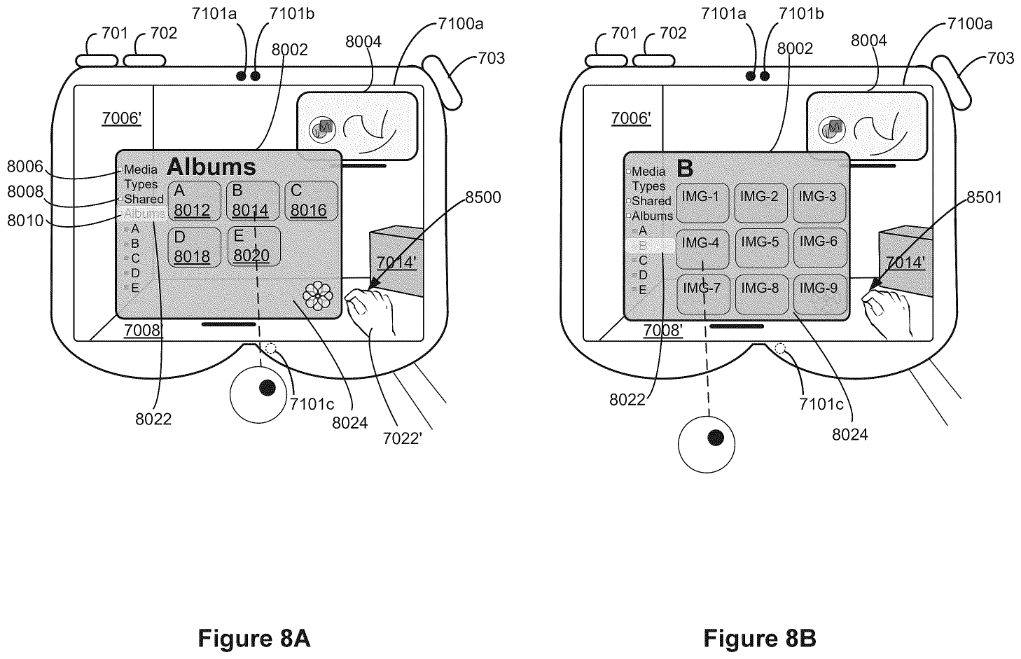

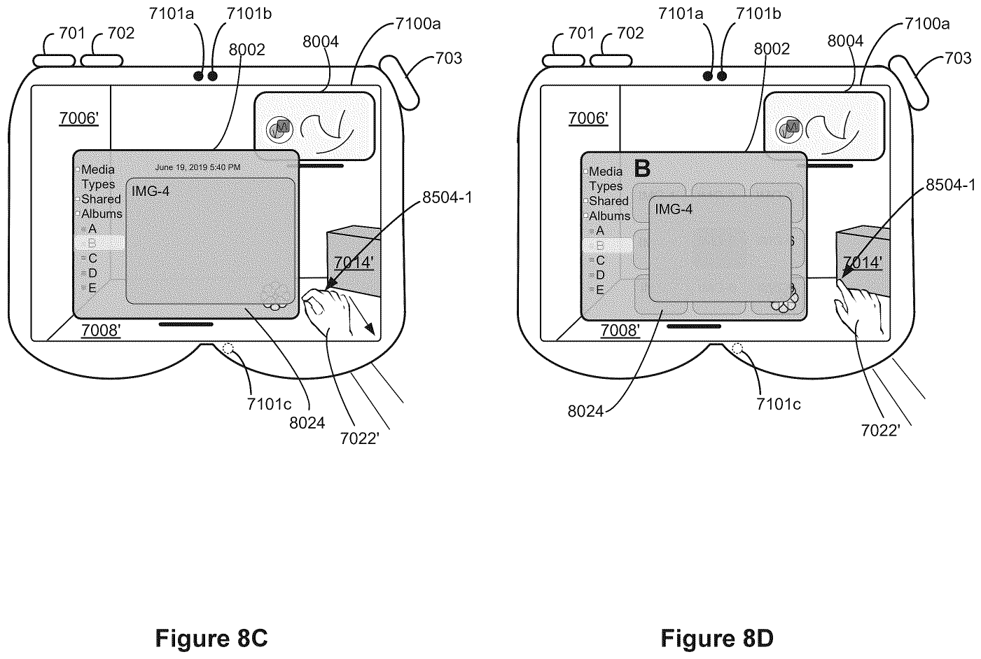

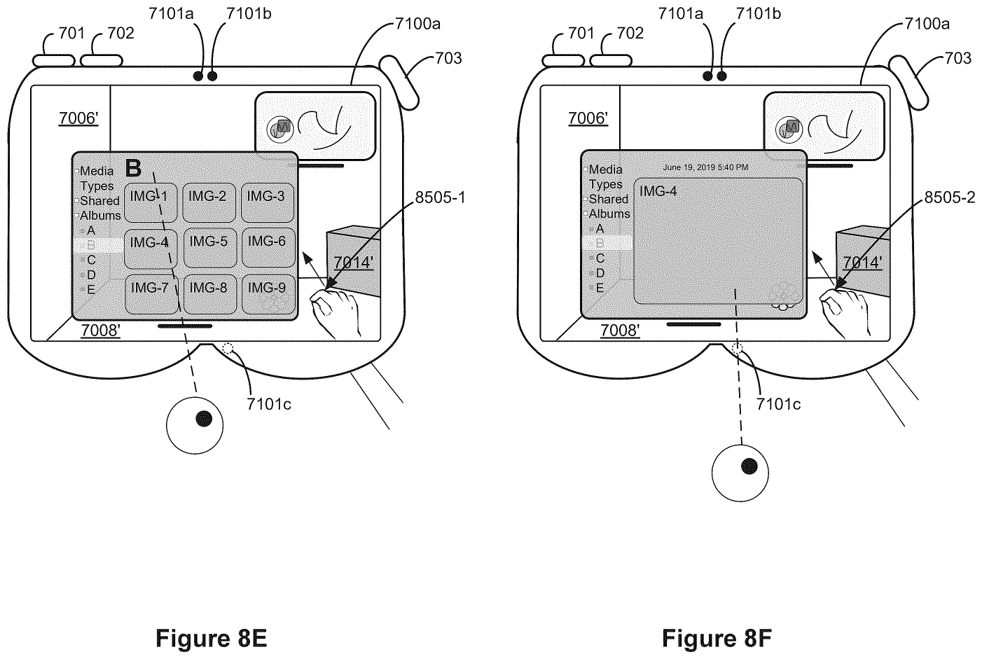

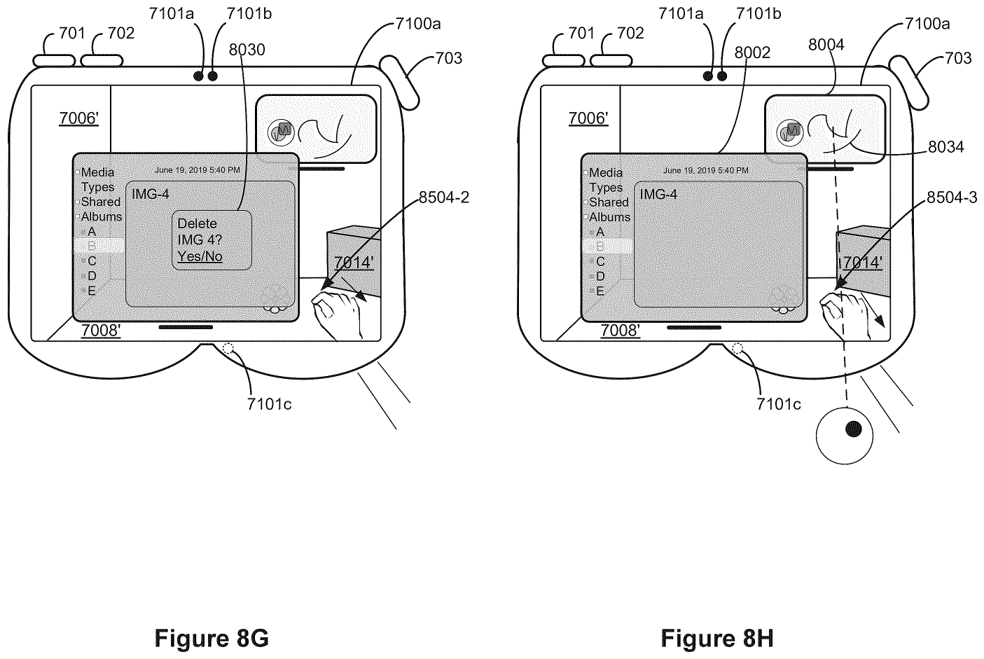

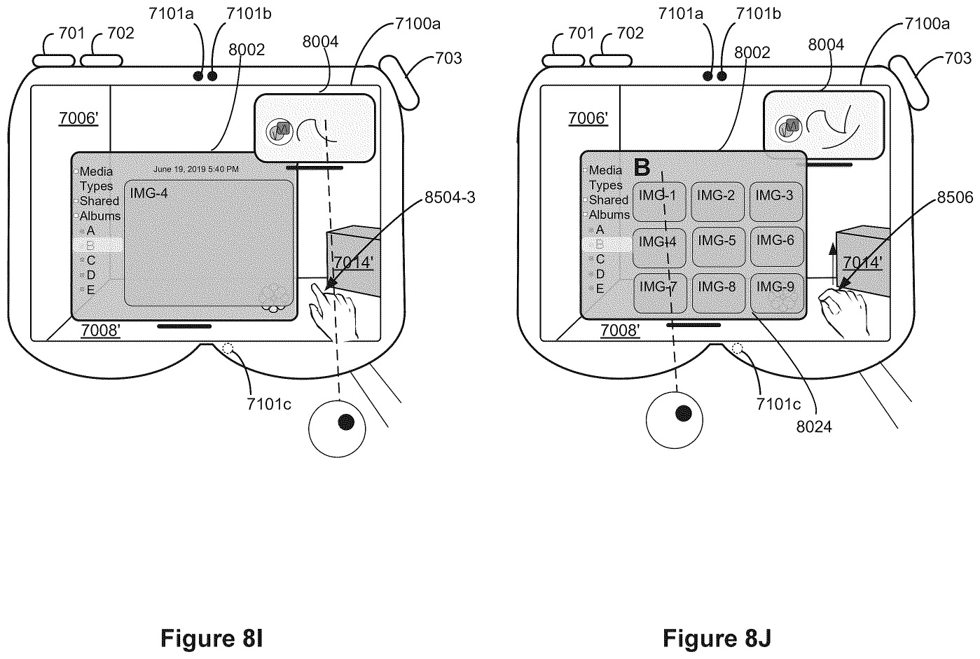

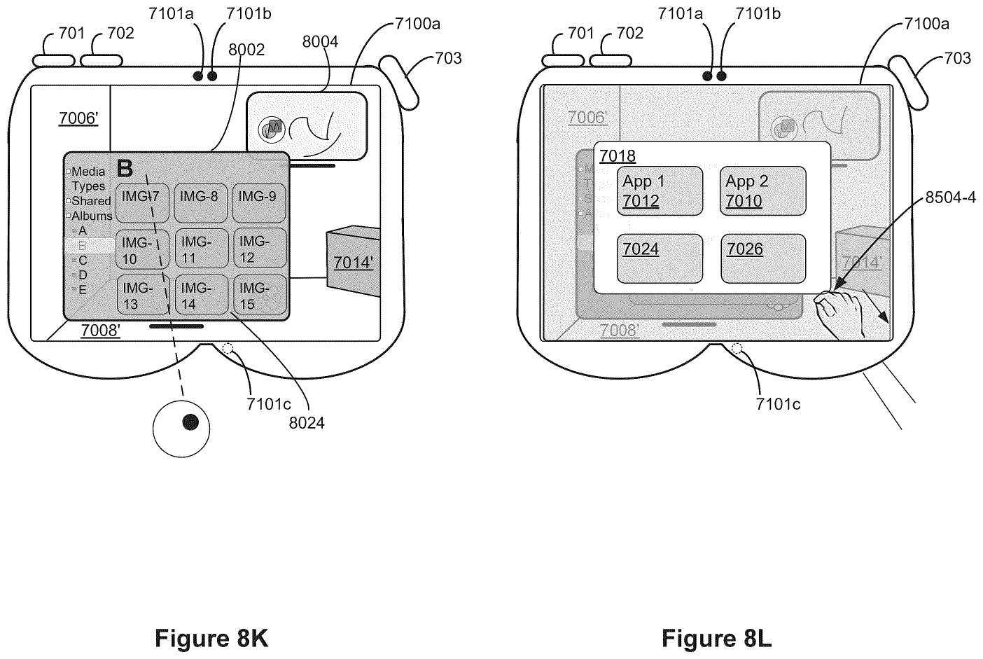

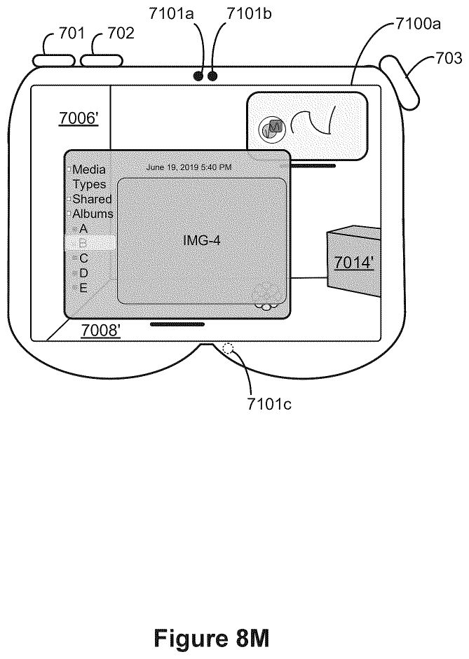

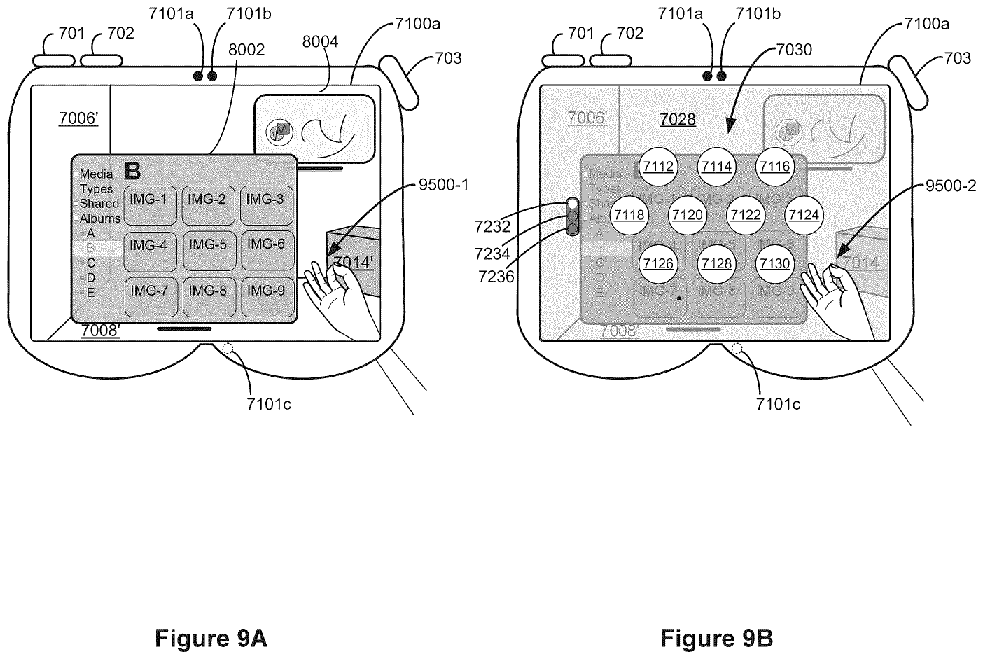

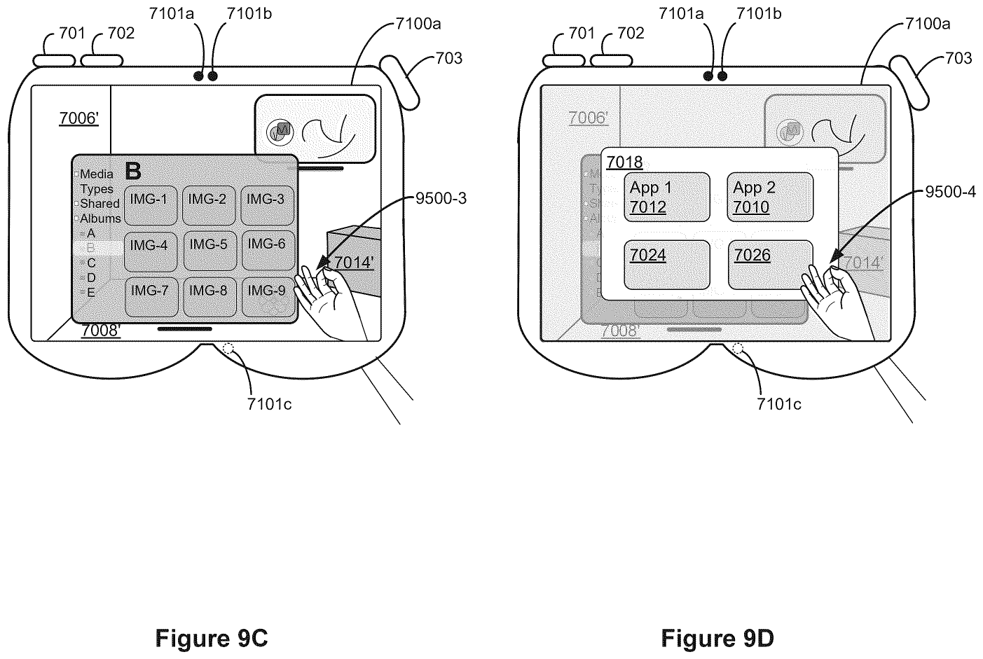

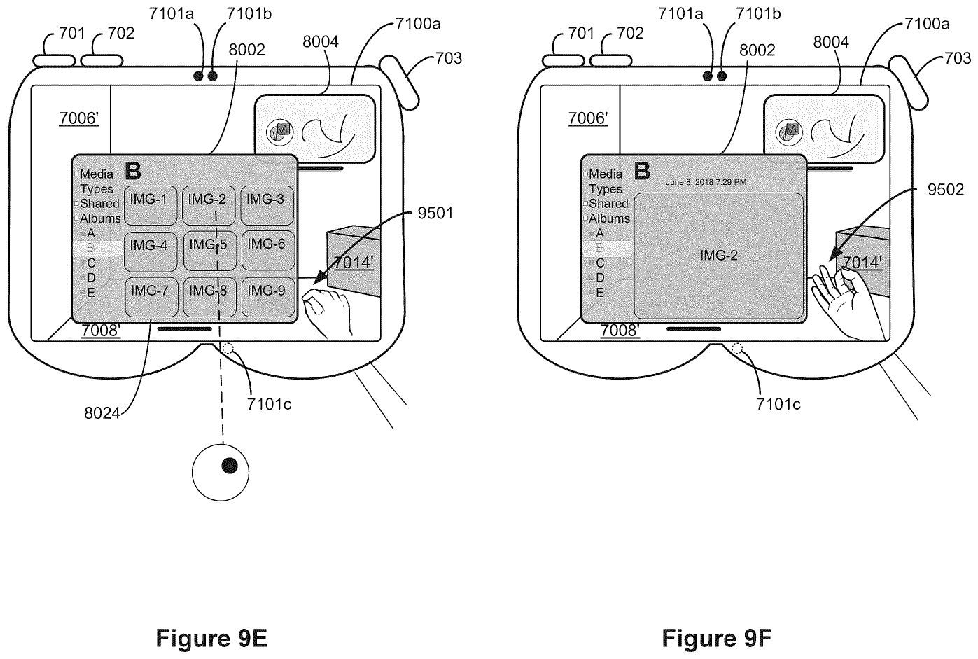

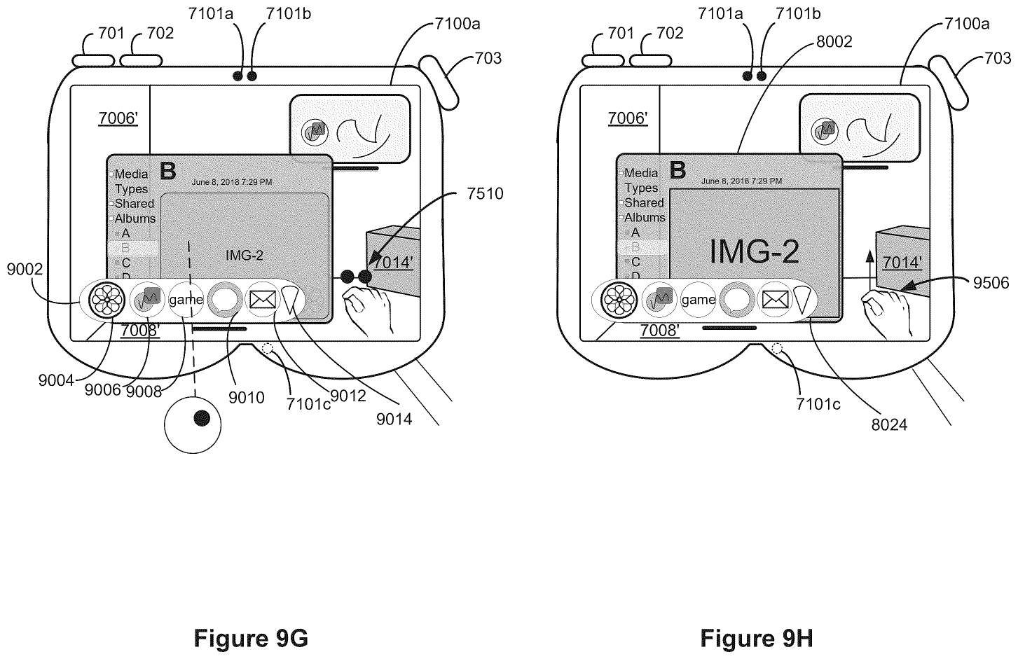

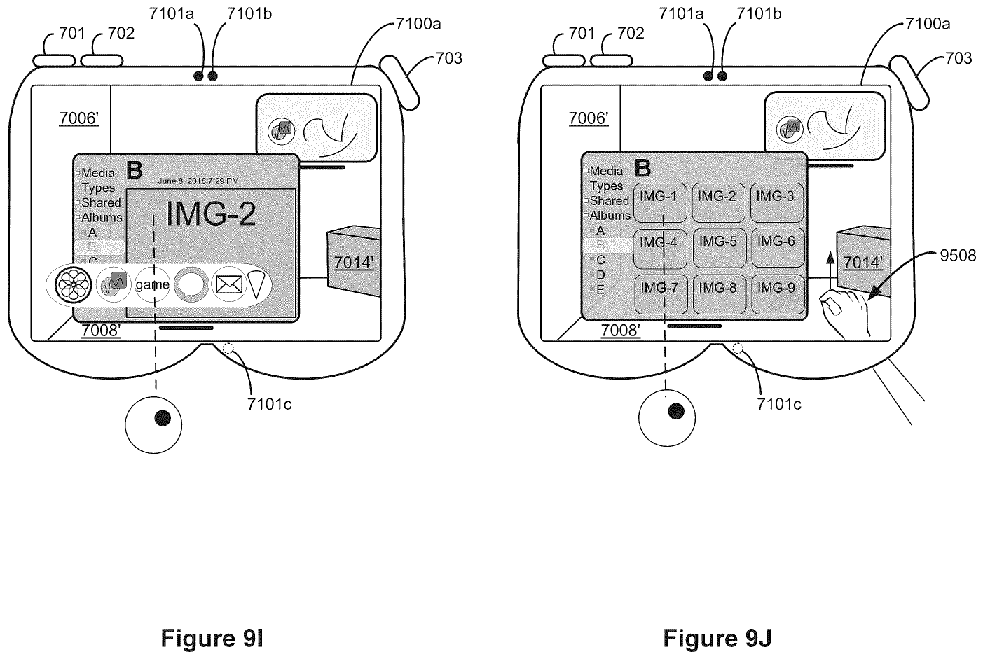

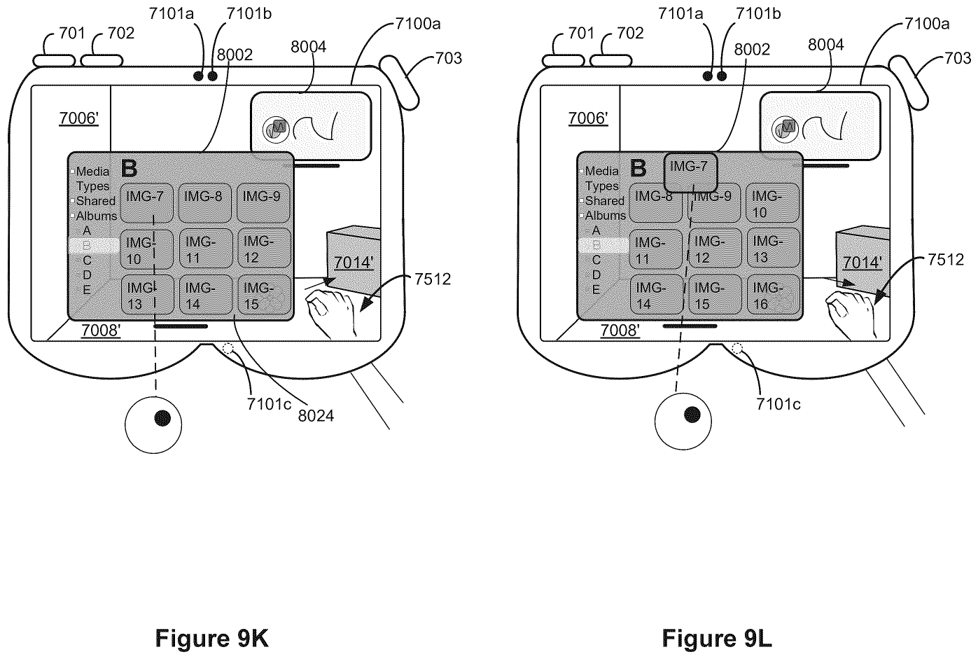

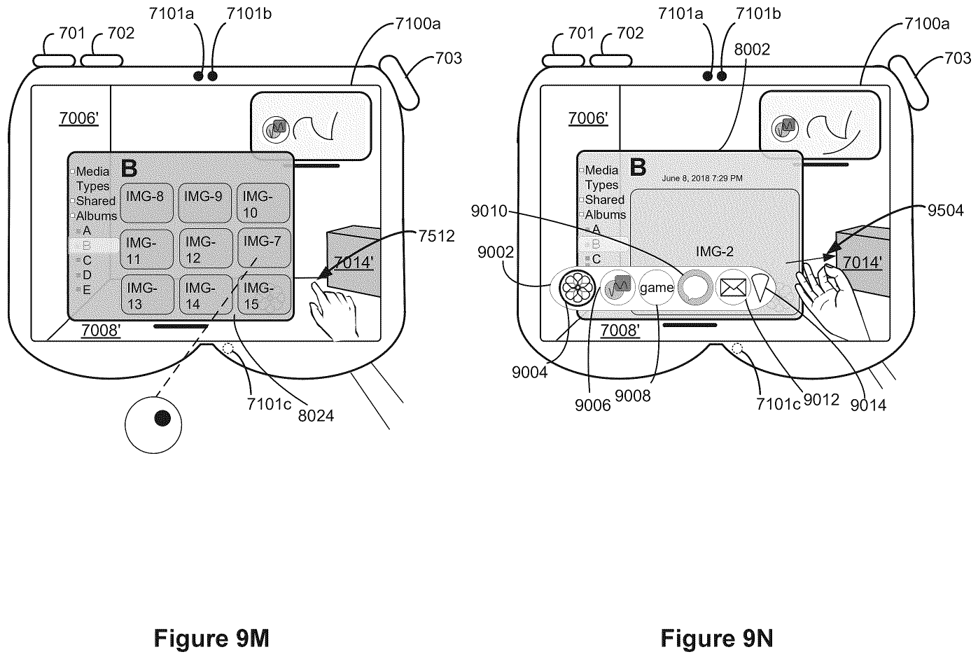

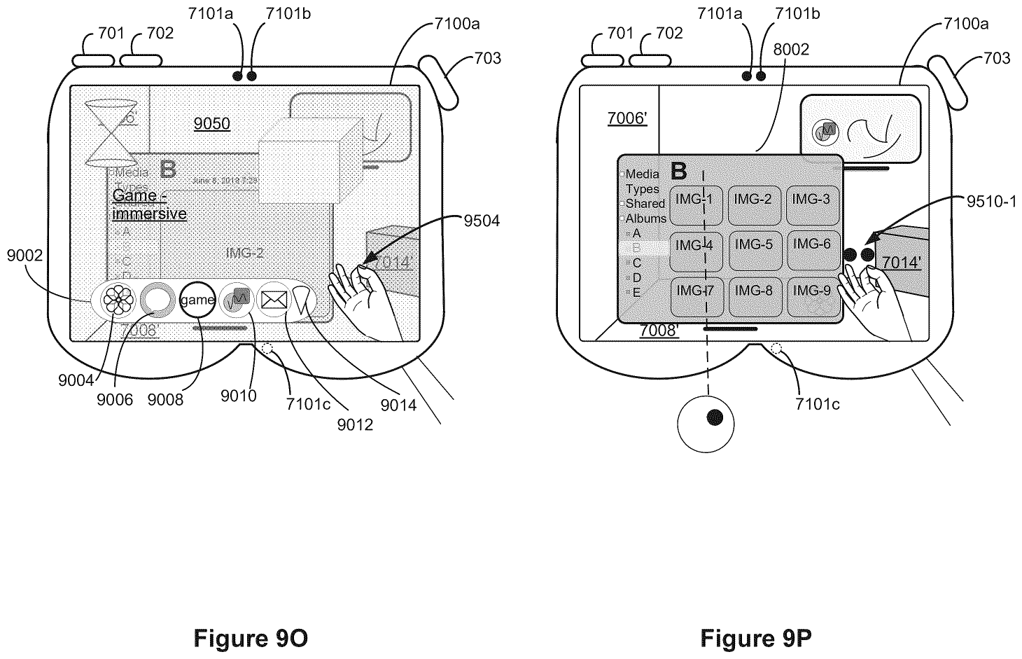

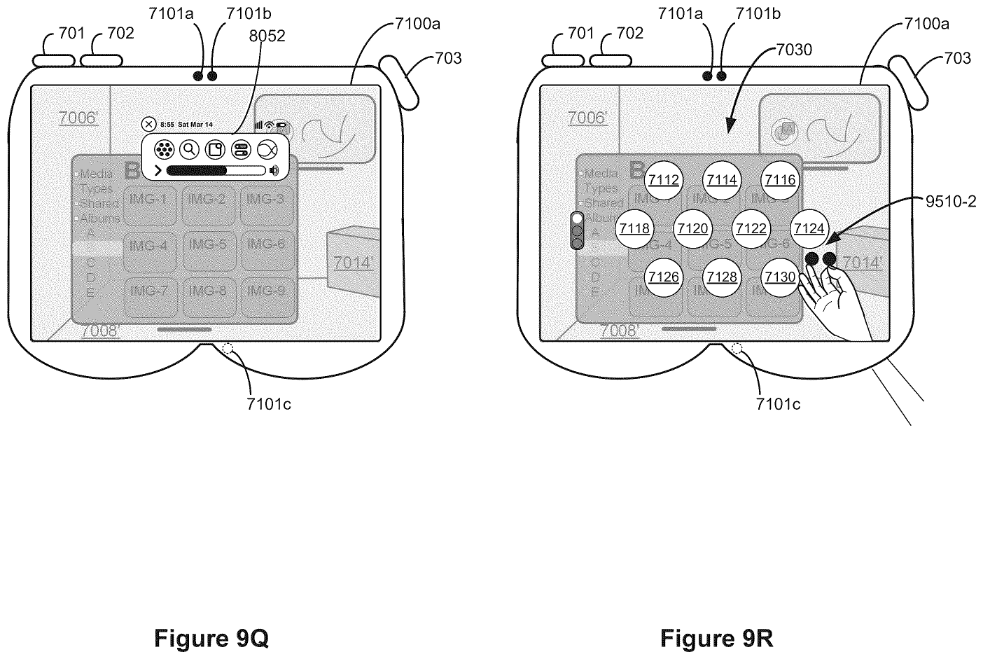

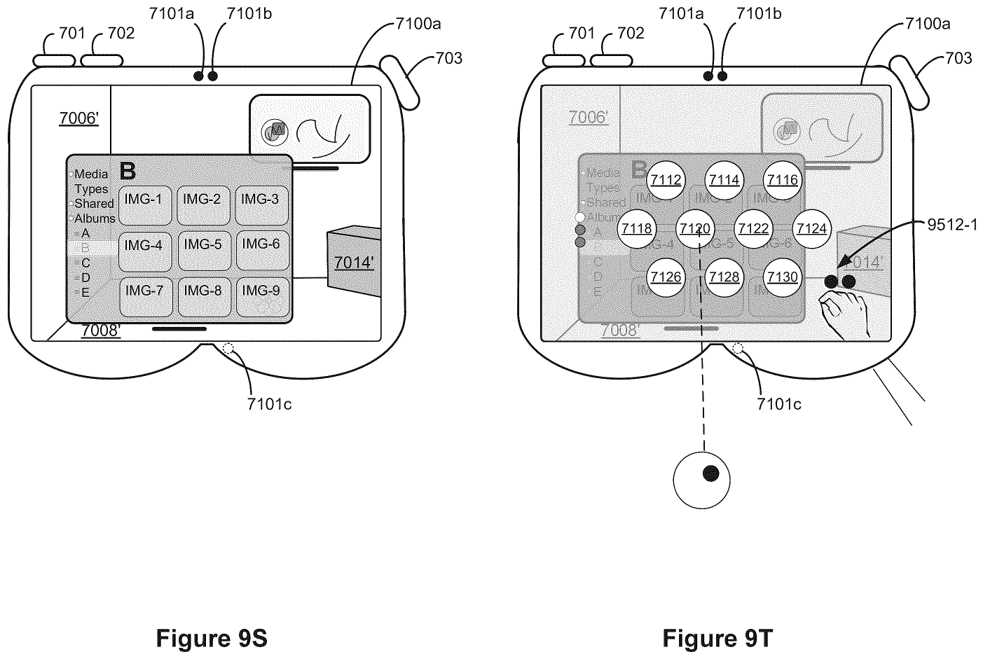

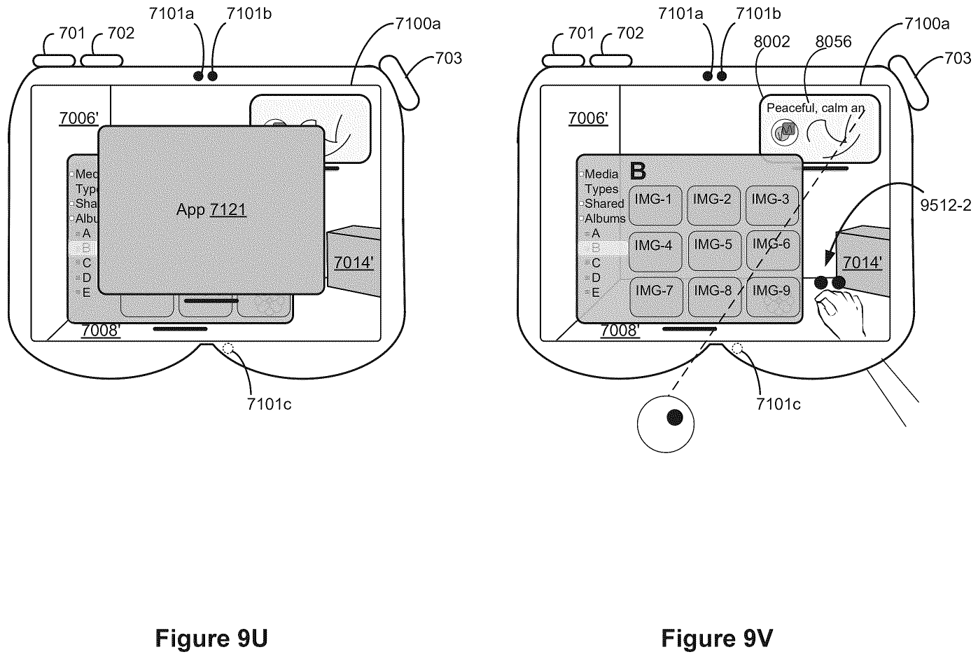

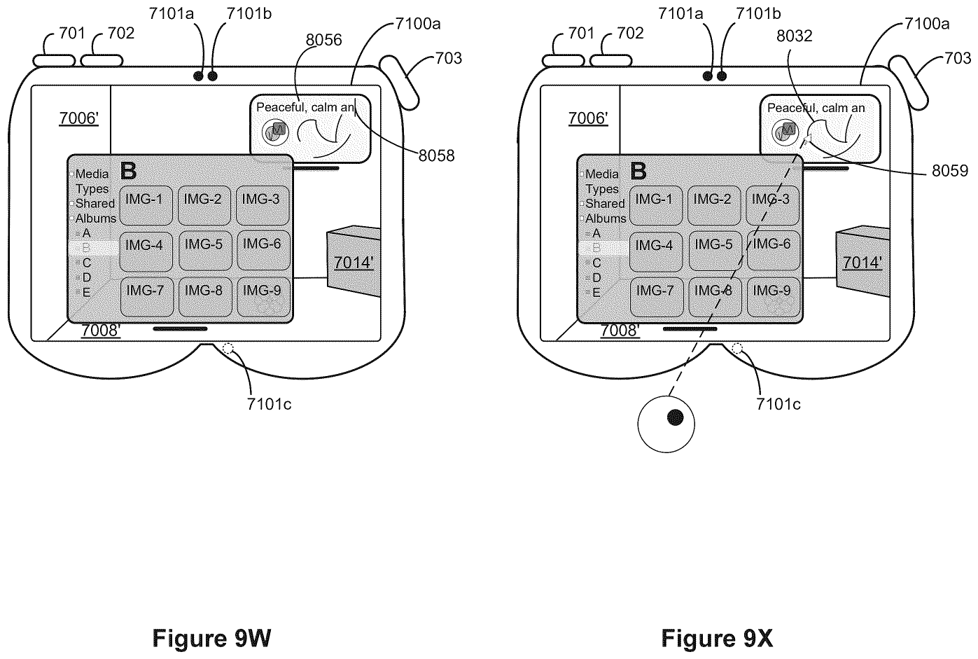

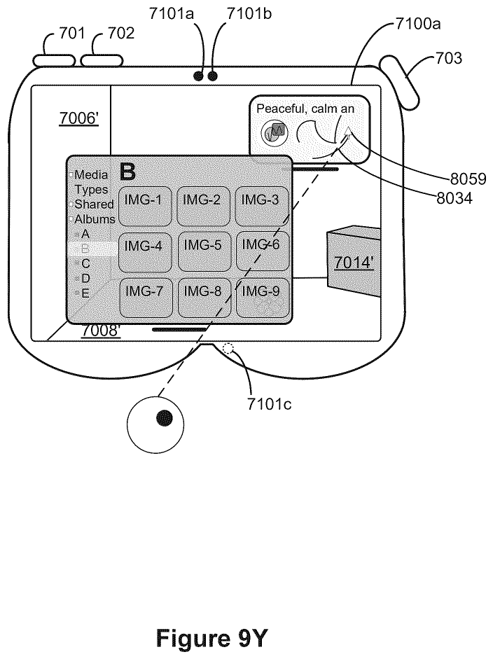

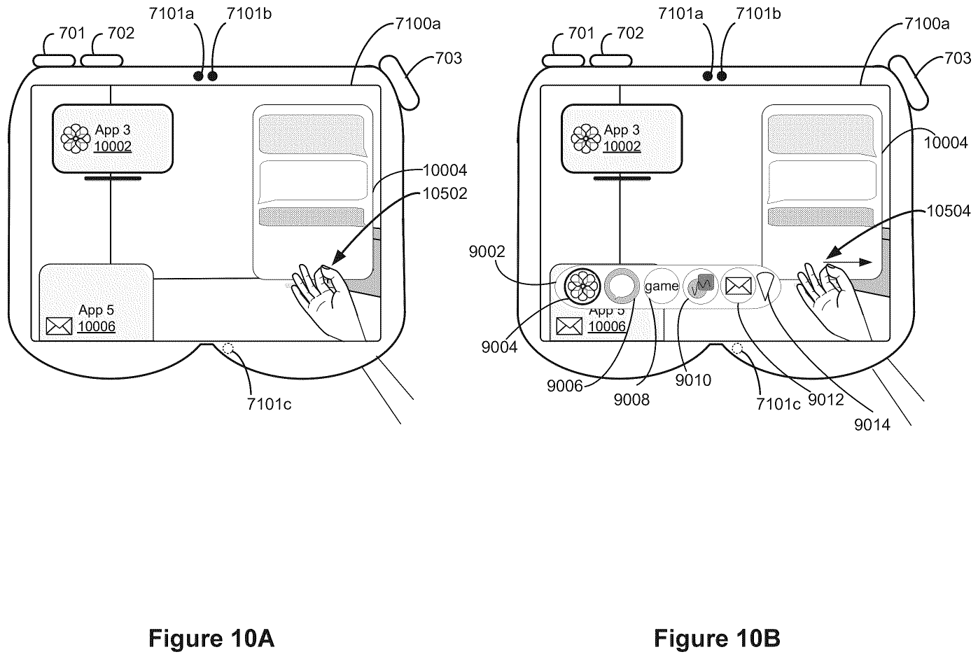

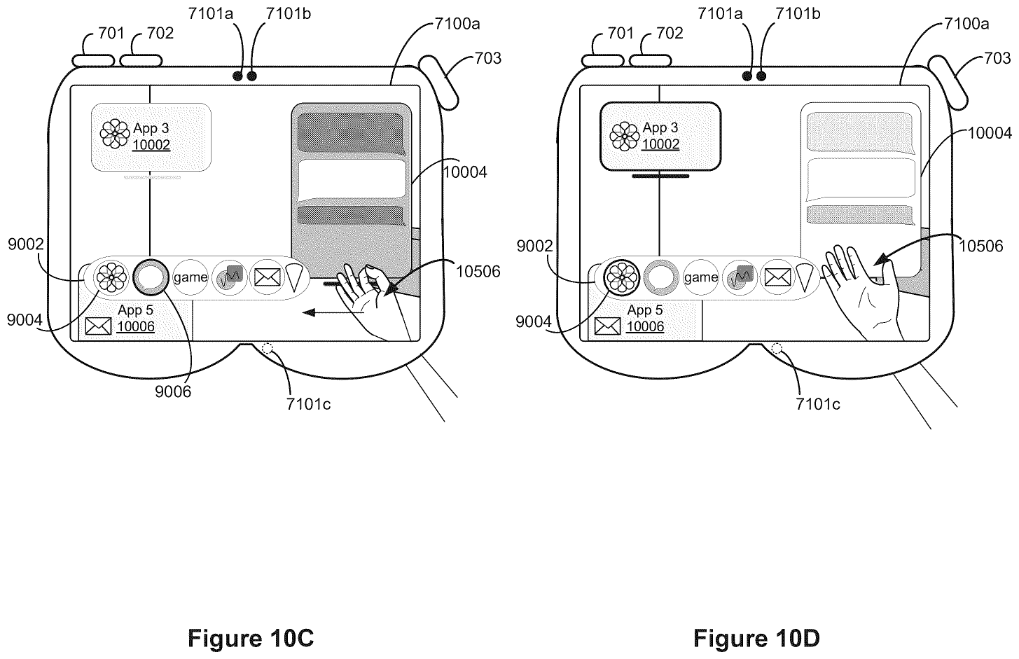

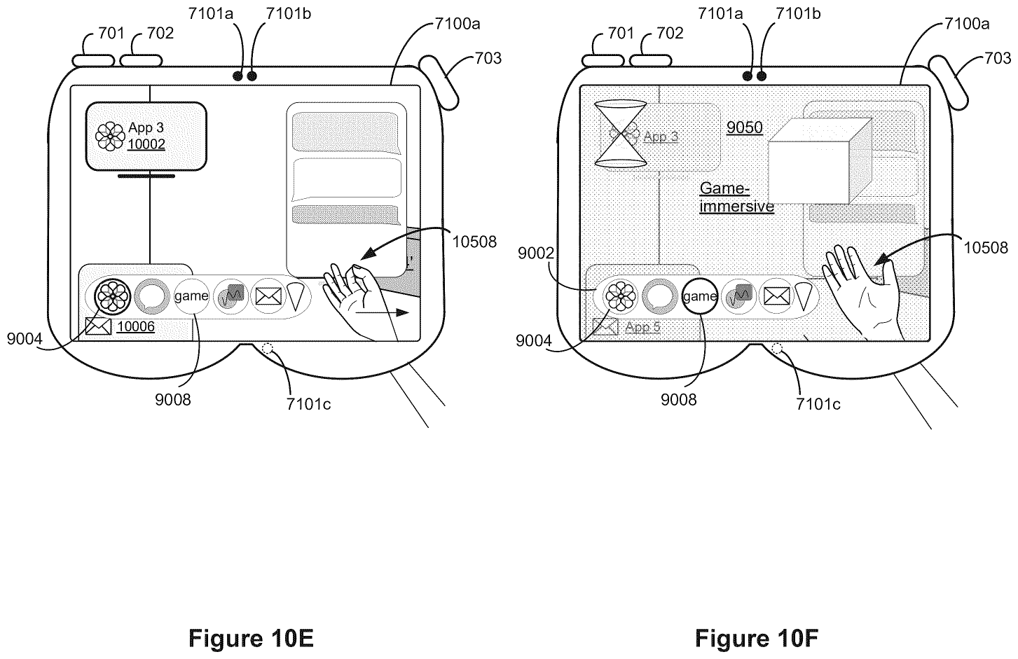

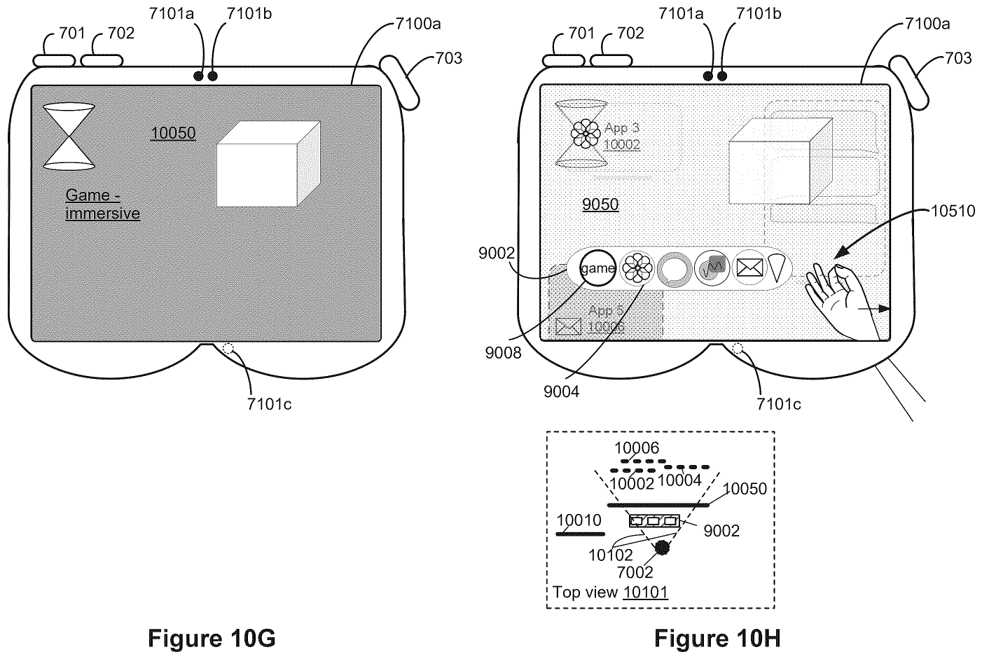

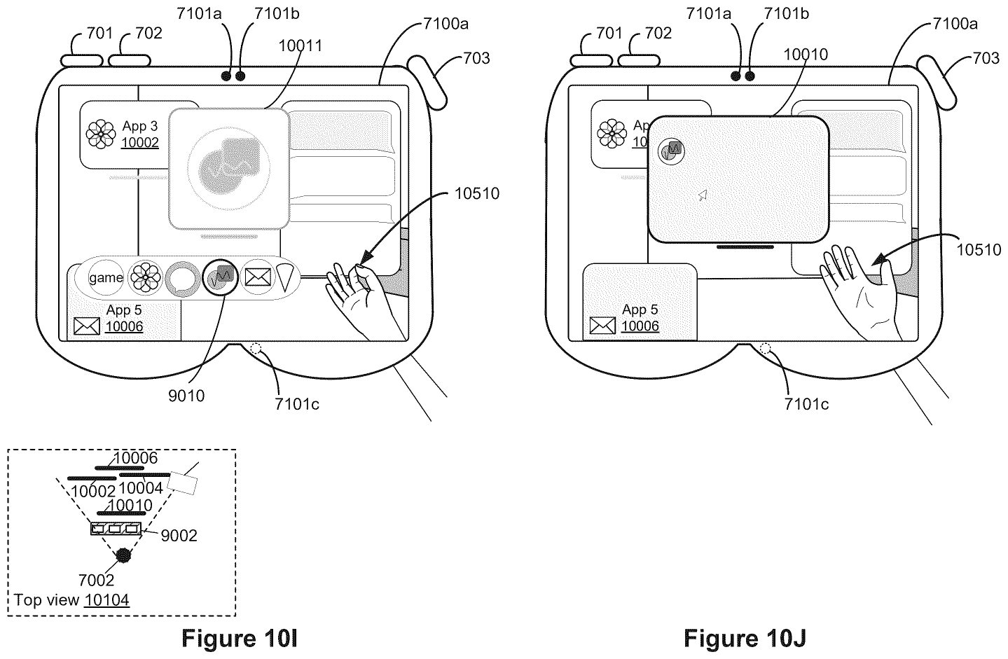

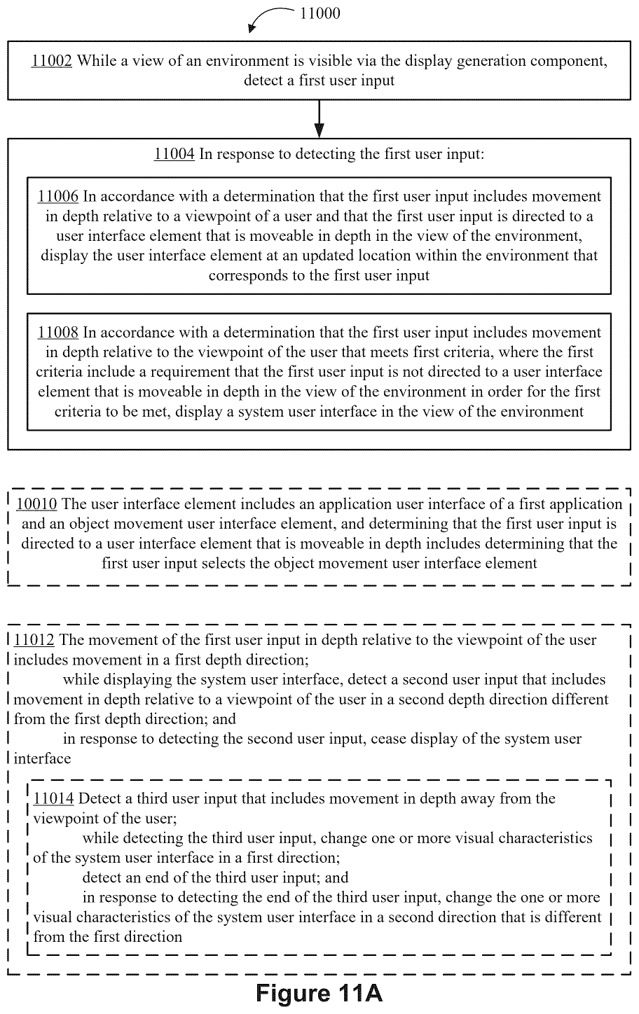

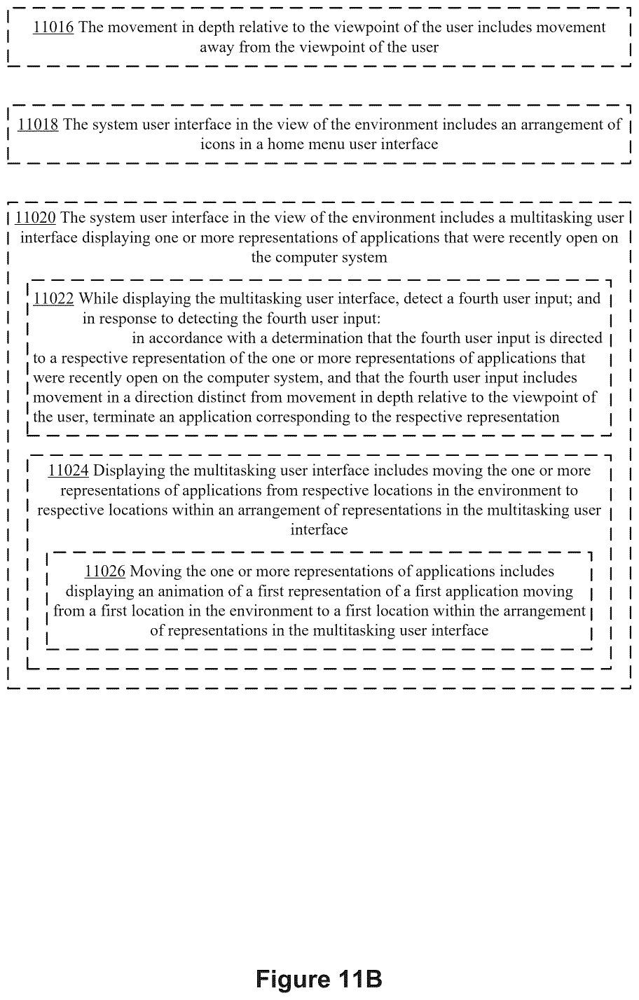

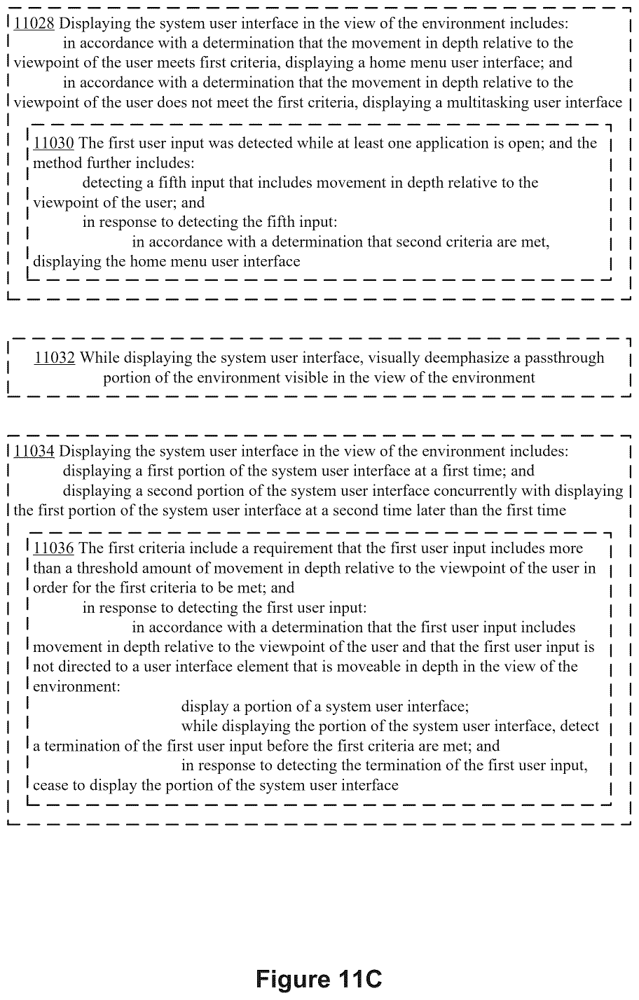

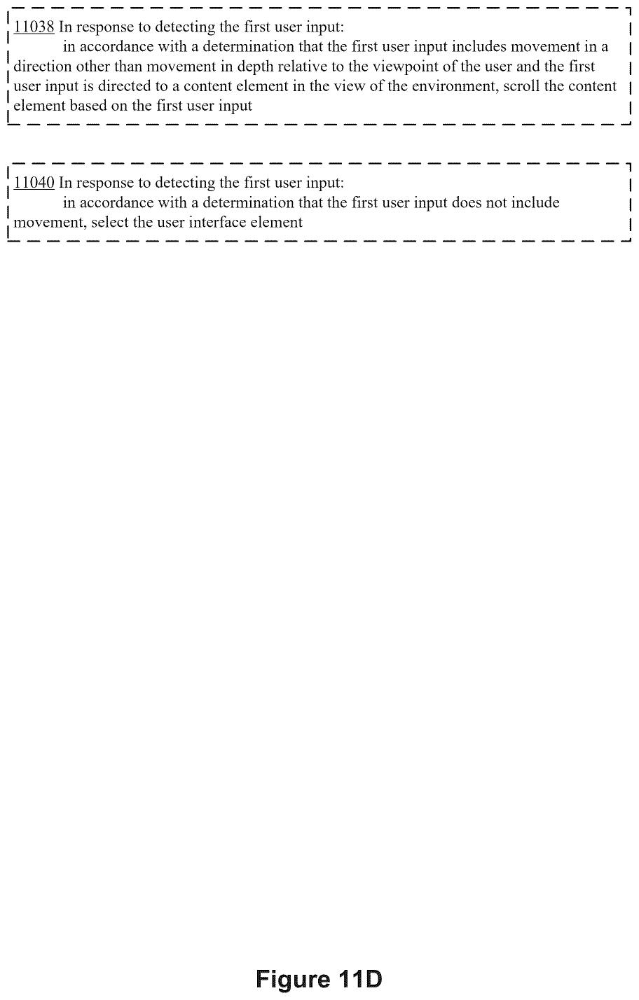

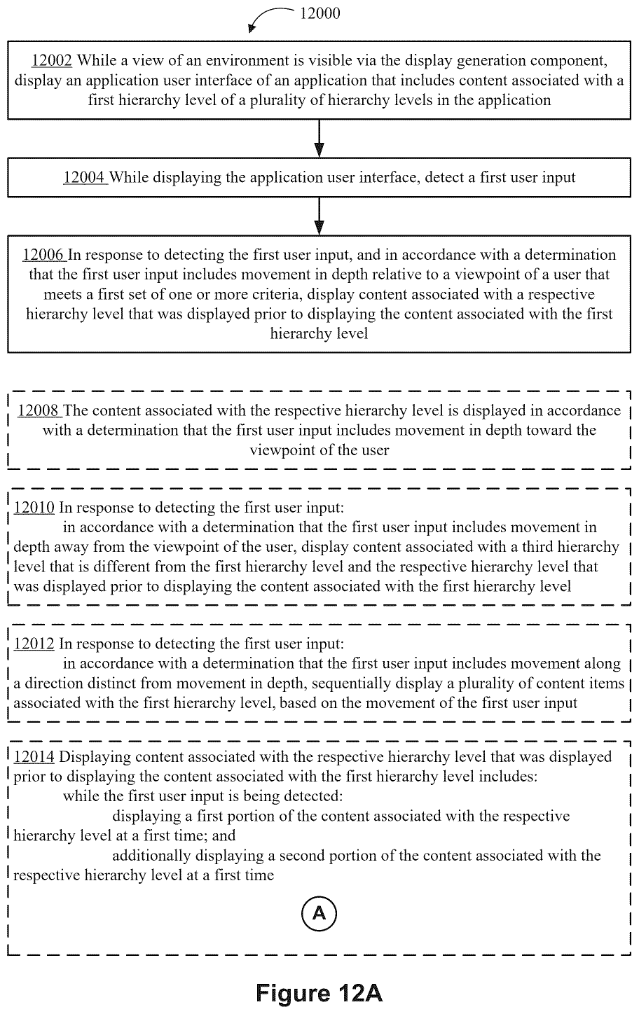

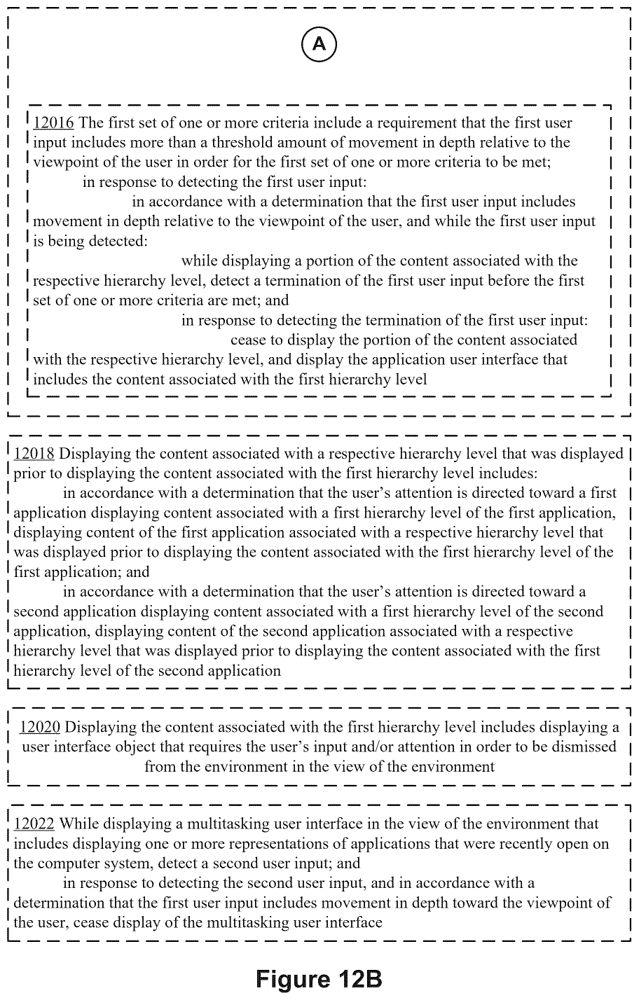

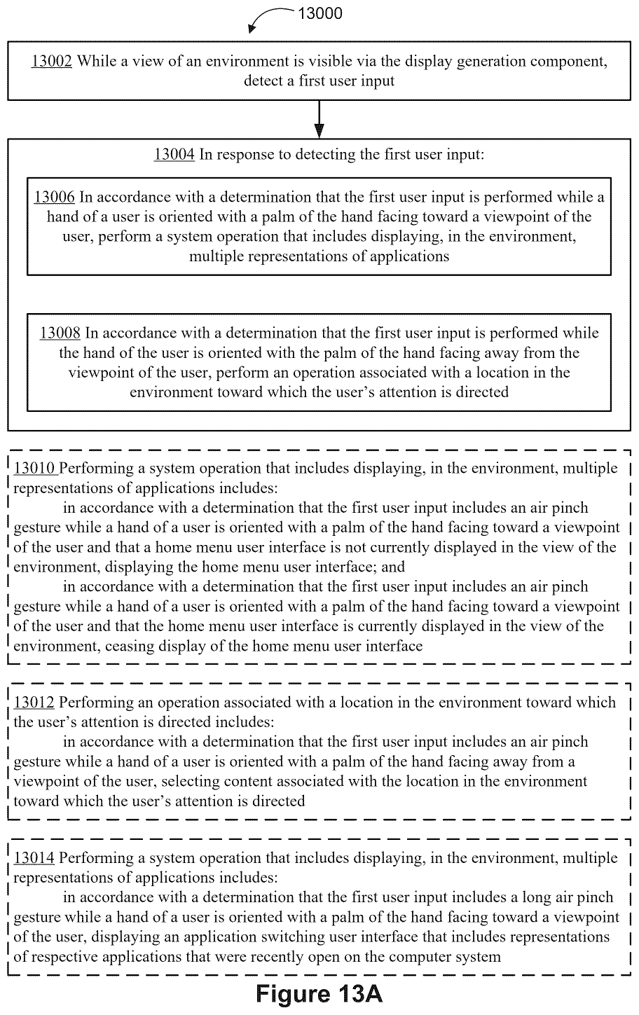

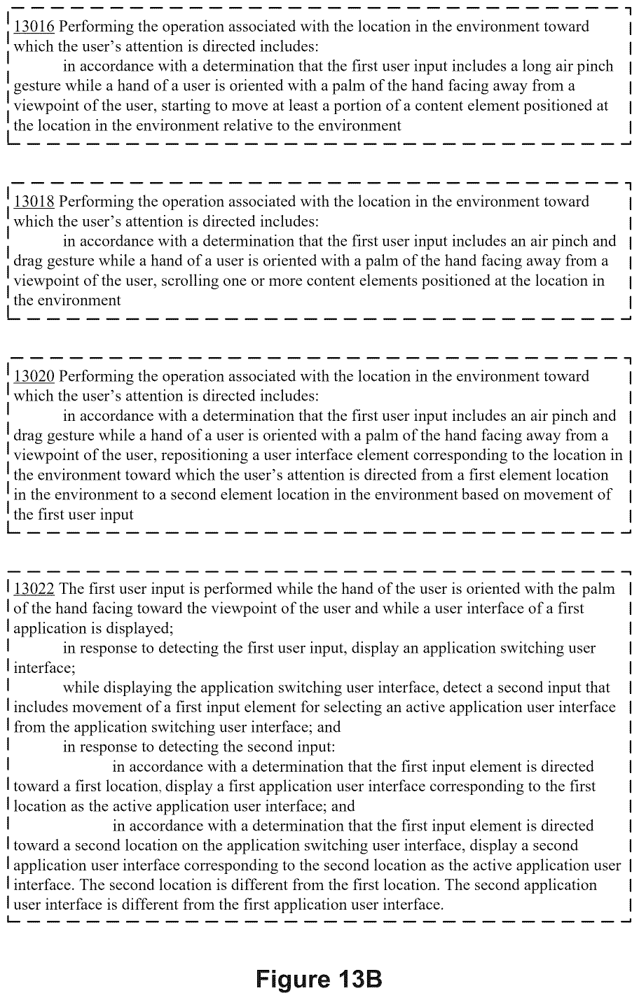

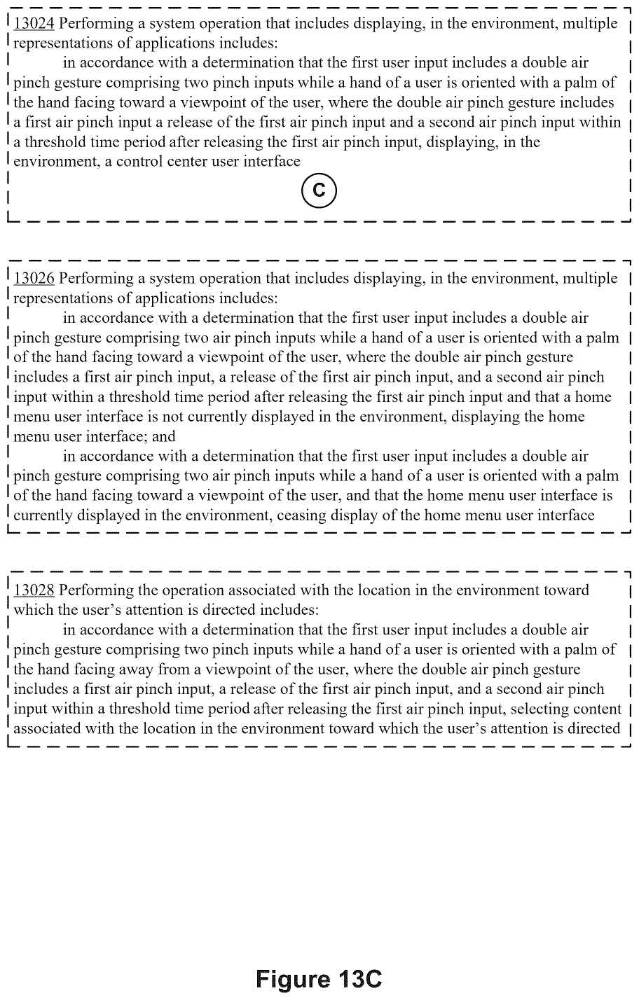

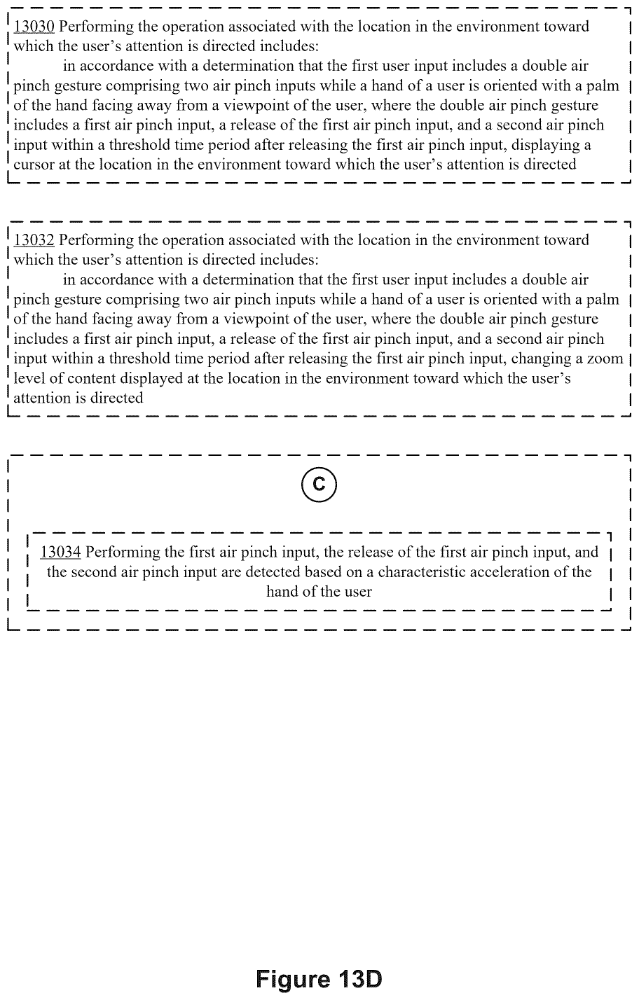

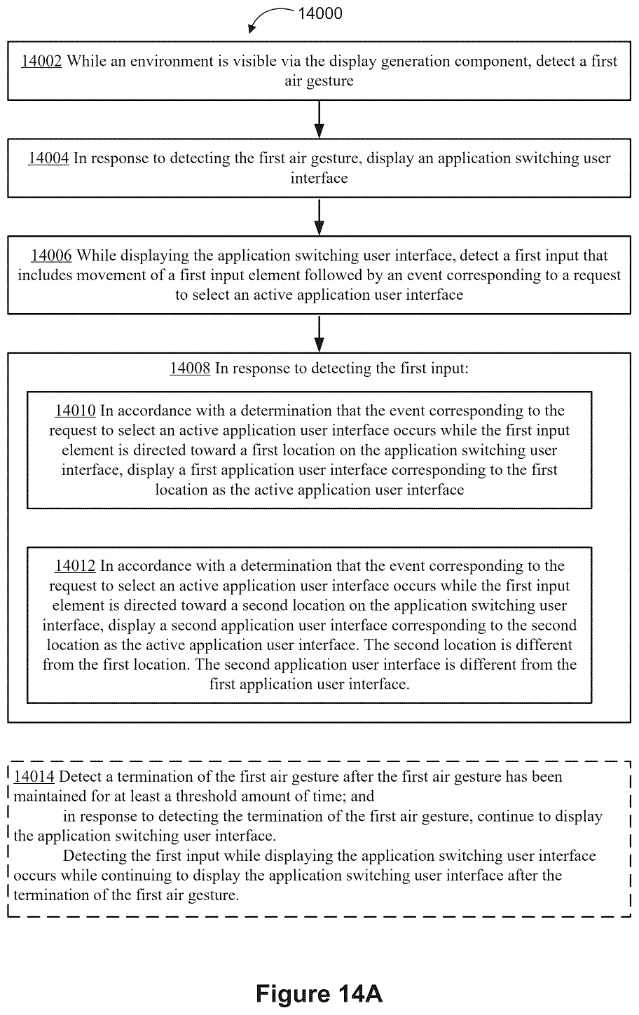

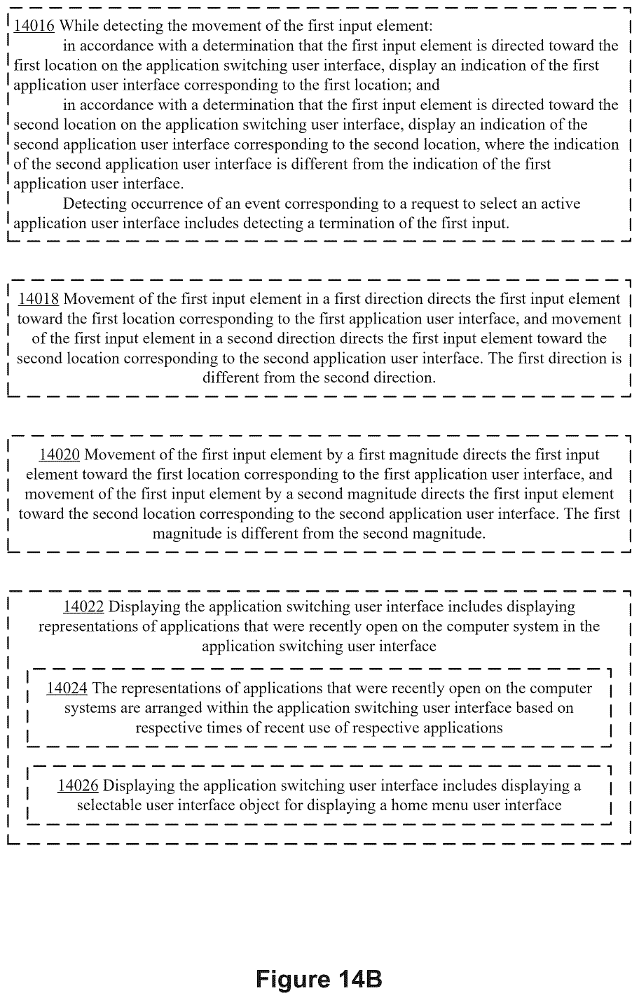

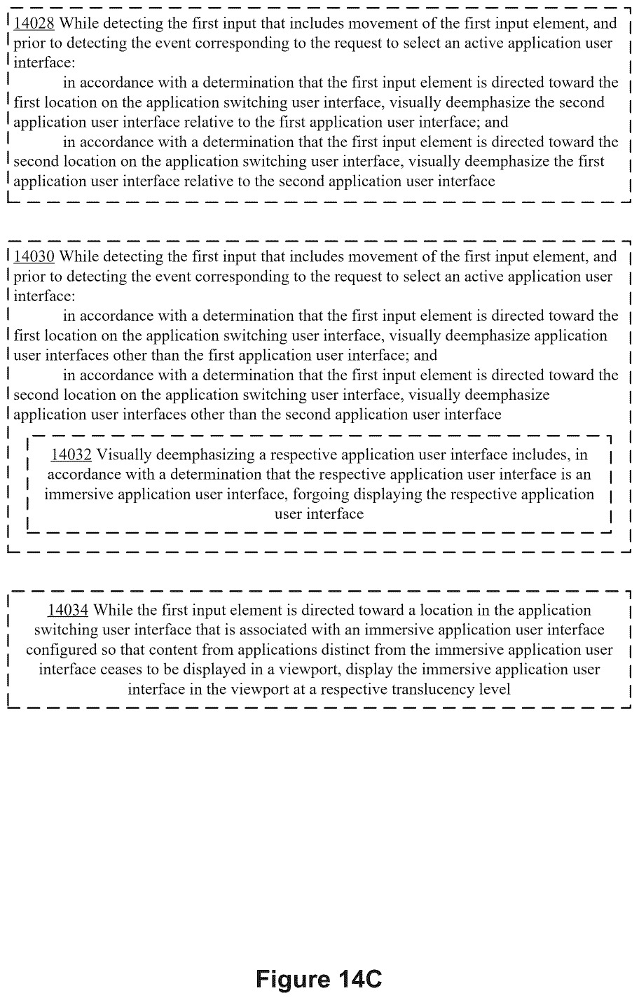

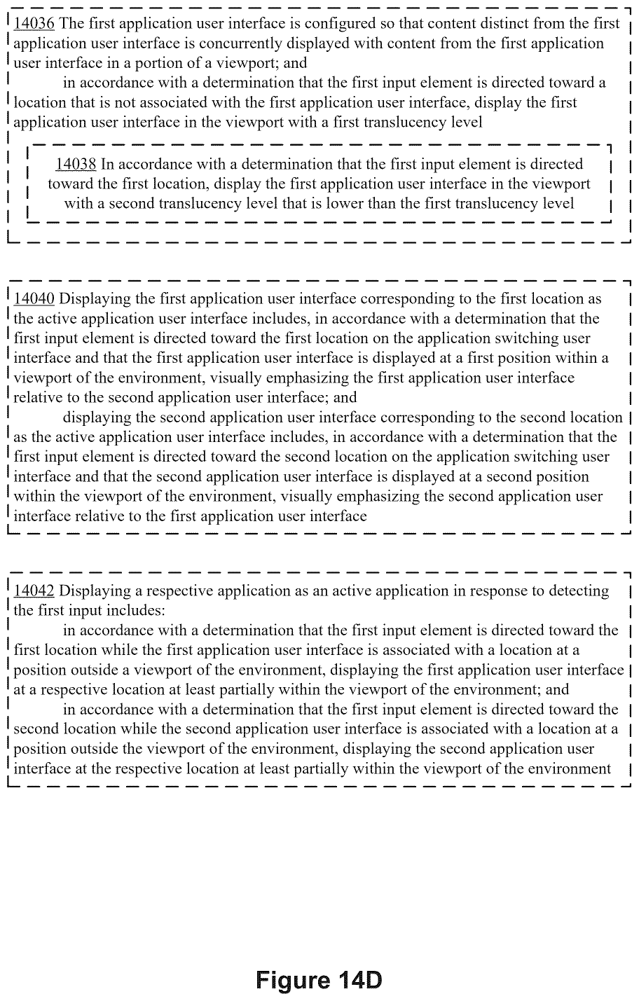

FIGS. 1A-6 provide a description of example computer systems for providing XR experiences to users (such as described below with respect to methods 11000, 12000, 13000, and/or 14000). FIGS. 7A-7M illustrate example techniques for displaying a system user interface based on an air gesture, in accordance with some embodiments. FIGS. 8A-8M illustrate example techniques for navigating content of different hierarchy levels in an application, in accordance with some embodiments. FIGS. 9A-9Y illustrate example techniques for performing different operations based on an orientation of a palm of a user's hand, in accordance with some embodiments. FIGS. 10A-10J illustrate example techniques for interacting with an application switching user interface, in accordance with some embodiments. FIGS. 11A-11D are flow diagrams of methods of displaying a system user interface based on an air gesture, in accordance with various embodiments. The user interfaces in FIGS. 7A-7M are used to illustrate the processes in FIGS. 11A-11D. FIGS. 12A-12B are flow diagrams of methods of navigating content of different hierarchy levels in an application, in accordance with various embodiments. The user interfaces in FIGS. 8A-8M are used to illustrate the processes in FIGS. 12A-12B. FIGS. 13A-13D are flow diagrams of methods of performing different operations based on an orientation of a palm of a user's hand, in accordance with various embodiments. The user interfaces in FIGS. 9A-9Y are used to illustrate the processes in FIGS. 13A-13D. FIGS. 14A-14D are flow diagrams of methods of interacting with an application switching user interface, in accordance with various embodiments. The user interfaces in FIGS. 10A-10J are used to illustrate the processes in FIGS. 14A-14D.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, an XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in an XR environment may be made in response to representations of physical motions (e.g., vocal commands). A person may sense and/or interact with an XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location and direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

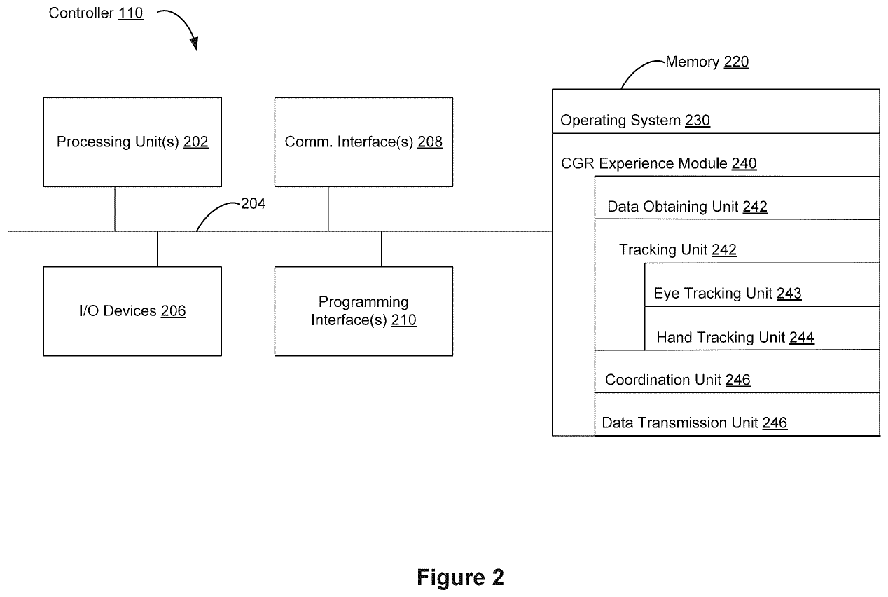

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate an XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

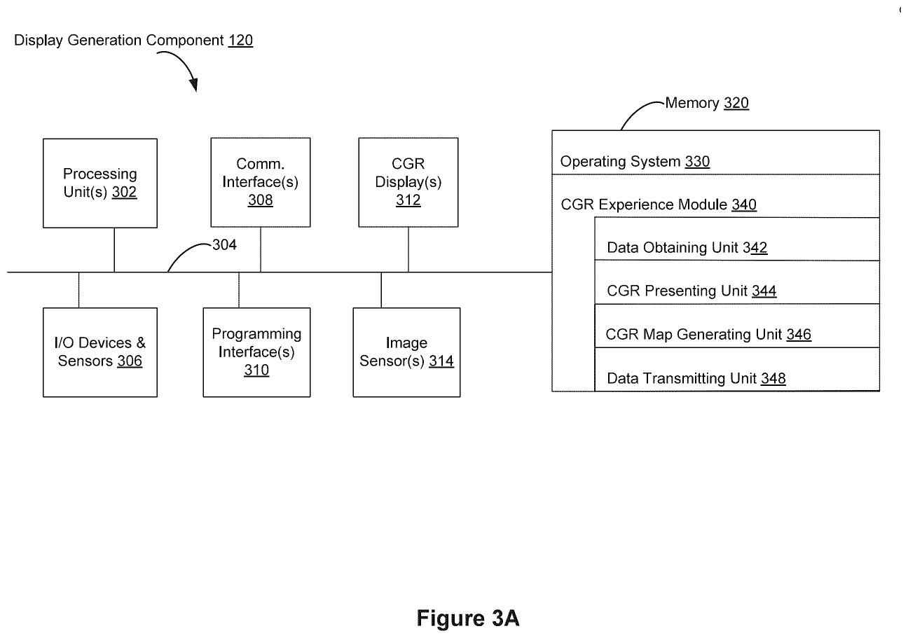

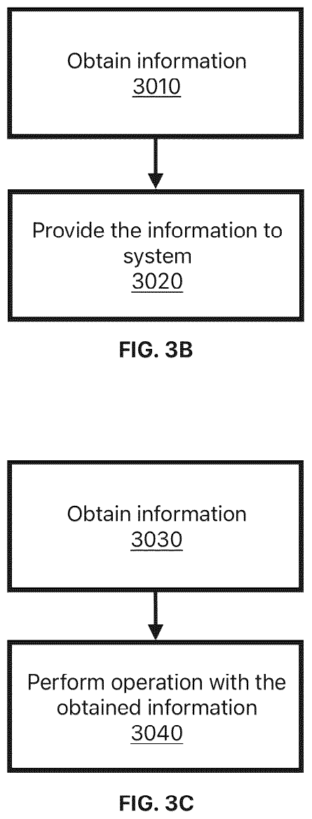

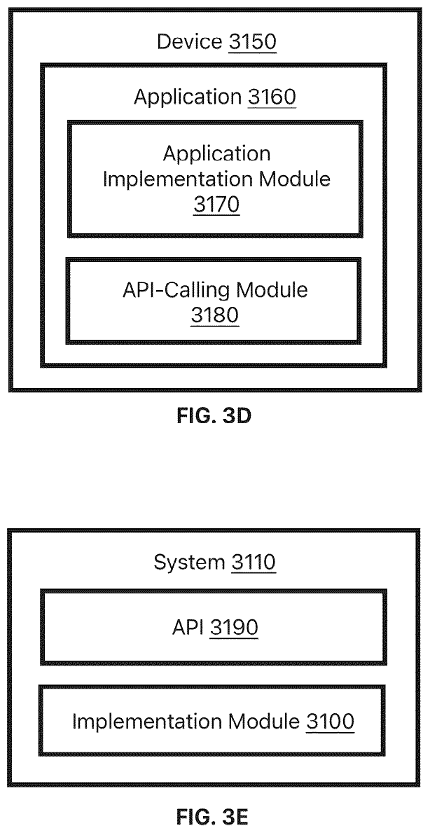

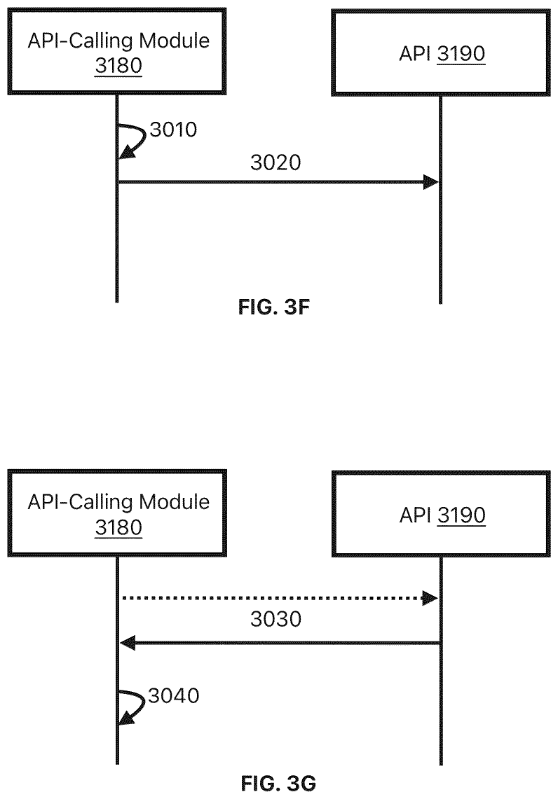

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is an XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMID relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HMD device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin.

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HMD 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 11 and 1K-1L and described herein. Likewise, any of the features, components, and/or parts, including the arrangements and configurations thereof shown and described with reference to FIGS. 11 and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HMD devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and an XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 242, a tracking unit 244, a coordination unit 246, and a data transmitting unit 248.

In some embodiments, the data obtaining unit 242 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 242 includes instructions and/or logic therefor, and heuristics and metadata therefor.

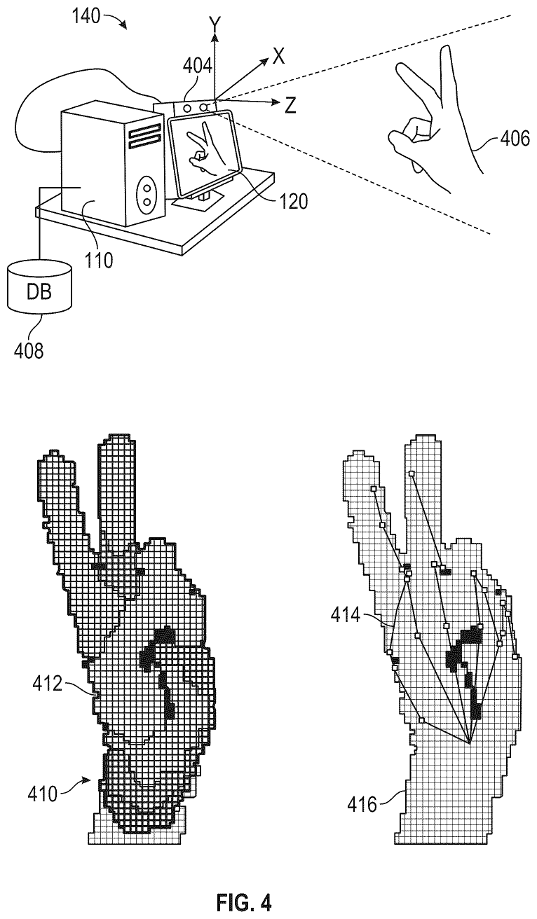

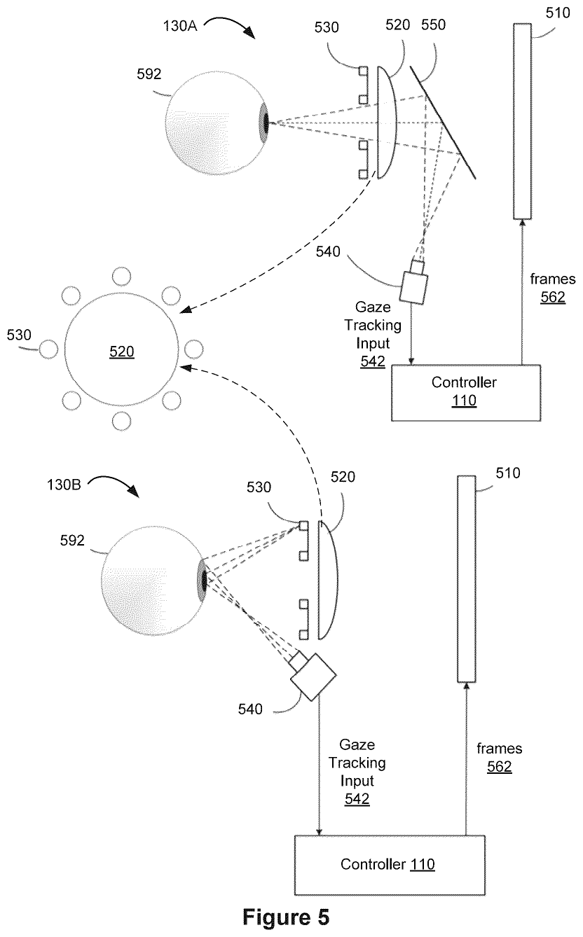

In some embodiments, the tracking unit 244 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 244 includes instructions and/or logic therefor, and heuristics and metadata therefor. In some embodiments, the tracking unit 244 includes hand tracking unit 245 and/or eye tracking unit 243. In some embodiments, the hand tracking unit 245 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 245 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 242, the tracking unit 244 (e.g., including the eye tracking unit 243 and the hand tracking unit 245), the coordination unit 246, and the data transmitting unit 248 are shown as residing on a single device (e.g., the controller 110), it should be understood that in other embodiments, any combination of the data obtaining unit 242, the tracking unit 244 (e.g., including the eye tracking unit 243 and the hand tracking unit 245), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes an XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and an XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, an XR presenting unit 344, an XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate an XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 11000 (FIGS. 11A-11D), method 12000 (FIGS. 12A-12B), method 13000 (FIGS. 13A-13D) and/or method 14000 (FIGS. 14A-14D) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 4 is a schematic, pictorial illustration of an example embodiment of the hand tracking device 140. In some embodiments, hand tracking device 140 (FIG. 1A) is controlled by hand tracking unit 245 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environment of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving their hand 406 and/or changing their hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves their hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long air pinch gesture, a pinch and drag gesture, or a double air pinch gesture. For example, a pinch gesture that is an air gesture includes movement of two or more fingers of a hand to make contact with one another, that is, optionally, followed by an immediate (e.g., within 0-1 seconds) break in contact from each other. A long air pinch gesture that is an air gesture includes movement of two or more fingers of a hand to make contact with one another for at least a threshold amount of time (e.g., at least 1 second), before detecting a break in contact with one another. For example, a long air pinch gesture includes the user holding a pinch gesture (e.g., with the two or more fingers making contact), and the long air pinch gesture continues until a break in contact between the two or more fingers is detected. In some embodiments, a double air pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long air pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long air pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture is performed using a first hand of the user (e.g., a pinch input, a long air pinch input, or a pinch and drag input), and, in conjunction with performing the pinch input using the first hand, a second pinch input is performed using the other hand (e.g., the second hand of the user's two hands). In some embodiments, movement between the user's two hands is performed (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double air pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, fingertips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or an XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs)), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

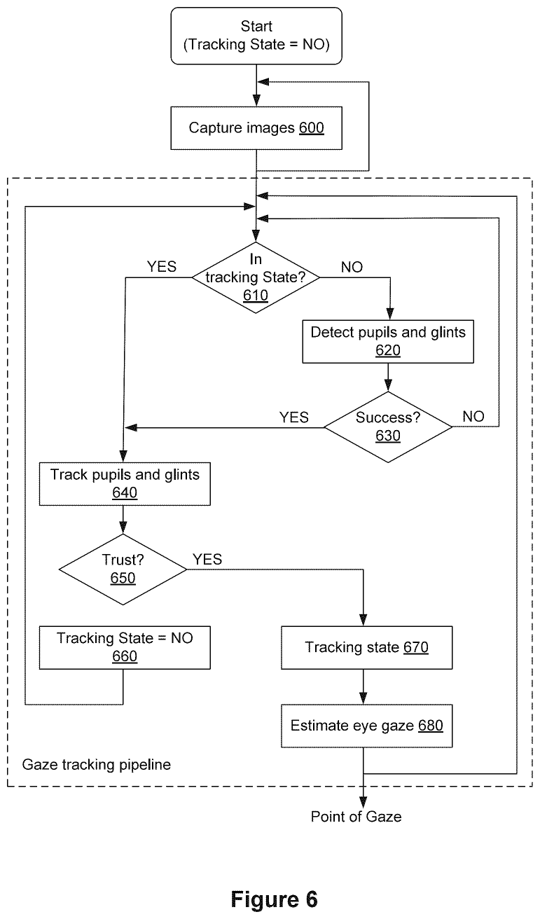

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real-world environment 602 are used to provide a XR experience to the user, for example, a mixed reality environment in which one or more virtual objects are superimposed over representations of real-world environment 602.

Thus, the description herein describes some embodiments of three-dimensional environments (e.g., XR environments) that include representations of real-world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two or more fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as a portable multifunction device or a head-mounted device, in communication with a display generation component, and one or more input devices.

FIGS. 7A-7M, 8A-8M, 9A-9Y, 10A-10J include illustrations of three-dimensional environments that are visible via a display generation component (e.g., a display generation component 7100a, or a display generation component 120) of a computer system (e.g., computer system 101) and interactions that occur in the three-dimensional environments caused by user inputs directed to the three-dimensional environments and/or inputs received from other computer systems and/or sensors. In some embodiments, an input is directed to a virtual object within a three-dimensional environment by a user's gaze detected in the region occupied by the virtual object, or by a hand gesture performed at a location in the physical environment that corresponds to the region of the virtual object. In some embodiments, an input is directed to a virtual object within a three-dimensional environment by a hand gesture that is performed (e.g., optionally, at a location in the physical environment that is independent of the region of the virtual object in the three-dimensional environment) while the virtual object has input focus (e.g., while the virtual object has been selected by a concurrently and/or previously detected gaze input, selected by a concurrently or previously detected pointer input, and/or selected by a concurrently and/or previously detected gesture input). In some embodiments, an input is directed to a virtual object within a three-dimensional environment by an input device that has positioned a focus selector object (e.g., a pointer object or selector object) at the position of the virtual object. In some embodiments, an input is directed to a virtual object within a three-dimensional environment via other means (e.g., voice and/or control button). In some embodiments, an input is directed to a representation of a physical object or a virtual object that corresponds to a physical object by the user's hand movement (e.g., whole hand movement, whole hand movement in a respective posture, movement of one portion of the user's hand relative to another portion of the hand, and/or relative movement between two hands) and/or manipulation with respect to the physical object (e.g., touching, swiping, tapping, opening, moving toward, and/or moving relative to). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from sensors (e.g., image sensors, temperature sensors, biometric sensors, motion sensors, and/or proximity sensors) and contextual conditions (e.g., location, time, and/or presence of others in the environment). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from other computers used by other users that are sharing the computer-generated environment with the user of the computer system (e.g., in a shared computer-generated experience, in a shared virtual environment, and/or in a shared virtual or augmented reality environment of a communication session). In some embodiments, the computer system displays some changes in the three-dimensional environment (e.g., displaying movement, deformation, and/or changes in visual characteristics of a user interface, a virtual surface, a user interface object, and/or virtual scenery) in accordance with inputs from sensors that detect movement of other persons and objects and movement of the user that may not qualify as a recognized gesture input for triggering an associated operation of the computer system.

In some embodiments, a three-dimensional environment that is visible via a display generation component described herein is a virtual three-dimensional environment that includes virtual objects and content at different virtual positions in the three-dimensional environment without a representation of the physical environment. In some embodiments, the three-dimensional environment is a mixed reality environment that displays virtual objects at different virtual positions in the three-dimensional environment that are constrained by one or more physical aspects of the physical environment (e.g., positions and orientations of walls, floors, surfaces, direction of gravity, time of day, and/or spatial relationships between physical objects). In some embodiments, the three-dimensional environment is an augmented reality environment that includes a representation of the physical environment. In some embodiments, the representation of the physical environment includes respective representations of physical objects and surfaces at different positions in the three-dimensional environment, such that the spatial relationships between the different physical objects and surfaces in the physical environment are reflected by the spatial relationships between the representations of the physical objects and surfaces in the three-dimensional environment. In some embodiments, when virtual objects are placed relative to the positions of the representations of physical objects and surfaces in the three-dimensional environment, they appear to have corresponding spatial relationships with the physical objects and surfaces in the physical environment. In some embodiments, the computer system transitions between displaying the different types of environments (e.g., transitions between presenting a computer-generated environment or experience with different levels of immersion, adjusting the relative prominence of audio/visual sensory inputs from the virtual content and from the representation of the physical environment) based on user inputs and/or contextual conditions.

In some embodiments, the display generation component includes a pass-through portion in which the representation of the physical environment is displayed or visible. In some embodiments, the pass-through portion of the display generation component is a transparent or semi-transparent (e.g., see-through) portion of the display generation component revealing at least a portion of a physical environment surrounding and within the field of view of a user (sometimes called “optical passthrough”). For example, the pass-through portion is a portion of a head-mounted display or heads-up display that is made semi-transparent (e.g., less than 50%, 40%, 30%, 20%, 15%, 10%, or 5% of opacity) or transparent, such that the user can see through it to view the real world surrounding the user without removing the head-mounted display or moving away from the heads-up display. In some embodiments, the pass-through portion gradually transitions from semi-transparent or transparent to fully opaque when displaying a virtual or mixed reality environment. In some embodiments, the pass-through portion of the display generation component displays a live feed of images or video of at least a portion of physical environment captured by one or more cameras (e.g., rear facing camera(s) of a mobile device or associated with a head-mounted display, or other cameras that feed image data to the computer system) (sometimes called “digital passthrough”). In some embodiments, the one or more cameras point at a portion of the physical environment that is directly in front of the user's eyes (e.g., behind the display generation component relative to the user of the display generation component). In some embodiments, the one or more cameras point at a portion of the physical environment that is not directly in front of the user's eyes (e.g., in a different physical environment, or to the side of or behind the user).

In some embodiments, when displaying virtual objects at positions that correspond to locations of one or more physical objects in the physical environment (e.g., at positions in a virtual reality environment, a mixed reality environment, or an augmented reality environment), at least some of the virtual objects are displayed in place of (e.g., replacing display of) a portion of the live view (e.g., a portion of the physical environment captured in the live view) of the cameras. In some embodiments, at least some of the virtual objects and content are projected onto physical surfaces or empty space in the physical environment and are visible through the pass-through portion of the display generation component (e.g., viewable as part of the camera view of the physical environment, or through the transparent or semi-transparent portion of the display generation component). In some embodiments, at least some of the virtual objects and virtual content are displayed to overlay a portion of the display and block the view of at least a portion of the physical environment visible through the transparent or semi-transparent portion of the display generation component.

In some embodiments, the display generation component displays different views of the three-dimensional environment in accordance with user inputs or movements that change the virtual position of the viewpoint of the currently displayed view of the three-dimensional environment relative to the three-dimensional environment. In some embodiments, when the three-dimensional environment is a virtual environment, the viewpoint moves in accordance with navigation or locomotion requests (e.g., in-air hand gestures, and/or gestures performed by movement of one portion of the hand relative to another portion of the hand) without requiring movement of the user's head, torso, and/or the display generation component in the physical environment. In some embodiments, movement of the user's head and/or torso, and/or the movement of the display generation component or other location sensing elements of the computer system (e.g., due to the user holding the display generation component or wearing the HMD), relative to the physical environment, cause corresponding movement of the viewpoint (e.g., with corresponding movement direction, movement distance, movement speed, and/or change in orientation) relative to the three-dimensional environment, resulting in corresponding change in the currently displayed view of the three-dimensional environment. In some embodiments, when a virtual object has a preset spatial relationship relative to the viewpoint (e.g., is anchored or fixed to the viewpoint), movement of the viewpoint relative to the three-dimensional environment would cause movement of the virtual object relative to the three-dimensional environment while the position of the virtual object in the field of view is maintained (e.g., the virtual object is said to be head locked). In some embodiments, a virtual object is body-locked to the user, and moves relative to the three-dimensional environment when the user moves as a whole in the physical environment (e.g., carrying or wearing the display generation component and/or other location sensing component of the computer system), but will not move in the three-dimensional environment in response to the user's head movement alone (e.g., the display generation component and/or other location sensing component of the computer system rotating around a fixed location of the user in the physical environment). In some embodiments, a virtual object is, optionally, locked to another portion of the user, such as a user's hand or a user's wrist, and moves in the three-dimensional environment in accordance with movement of the portion of the user in the physical environment, to maintain a preset spatial relationship between the position of the virtual object and the virtual position of the portion of the user in the three-dimensional environment. In some embodiments, a virtual object is locked to a preset portion of a field of view provided by the display generation component, and moves in the three-dimensional environment in accordance with the movement of the field of view, irrespective of movement of the user that does not cause a change of the field of view.

In some embodiments, the views of a three-dimensional environment sometimes do not include representation(s) of a user's hand(s), arm(s), and/or wrist(s). In some embodiments, as shown in FIGS. 7B-7M, 8A-8M, 9A-9Y, and 10A-10J, the representation(s) of a user's hand(s), arm(s), and/or wrist(s) are included in the views of a three-dimensional environment. In some embodiments, the representation(s) of a user's hand(s), arm(s), and/or wrist(s) are included in the views of a three-dimensional environment as part of the representation of the physical environment provided via the display generation component. In some embodiments, the representations are not part of the representation of the physical environment and are separately captured (e.g., by one or more cameras pointing toward the user's hand(s), arm(s), and wrist(s)) and displayed in the three-dimensional environment independent of the currently displayed view of the three-dimensional environment. In some embodiments, the representation(s) include camera images as captured by one or more cameras of the computer system(s), or stylized versions of the arm(s), wrist(s) and/or hand(s) based on information captured by various sensors). In some embodiments, the representation(s) replace display of, are overlaid on, or block the view of, a portion of the representation of the physical environment. In some embodiments, when the display generation component does not provide a view of a physical environment, and provides a completely virtual environment (e.g., no camera view and no transparent pass-through portion), real-time visual representations (e.g., stylized representations or segmented camera images) of one or both arms, wrists, and/or hands of the user are, optionally, still displayed in the virtual environment. In some embodiments, if a representation of the user's hand is not provided in the view of the three-dimensional environment, the position that corresponds to the user's hand is optionally indicated in the three-dimensional environment, e.g., by the changing appearance of the virtual content (e.g., through a change in translucency and/or simulated reflective index) at positions in the three-dimensional environment that correspond to the location of the user's hand in the physical environment. In some embodiments, the representation of the user's hand or wrist is outside of the currently displayed view of the three-dimensional environment while the virtual position in the three-dimensional environment that corresponds to the location of the user's hand or wrist is outside of the current field of view provided via the display generation component; and the representation of the user's hand or wrist is made visible in the view of the three-dimensional environment in response to the virtual position that corresponds to the location of the user's hand or wrist being moved within the current field of view due to movement of the display generation component, the user's hand or wrist, the user's head, and/or the user as a whole.

FIGS. 7A-7M illustrate examples of displaying a system user interface based on an air gesture. FIGS. 11A-11D are flow diagrams of an exemplary method 11000 for displaying a system user interface based on an air gesture. The user interfaces in FIGS. 7A-7M are used to illustrate the processes described below, including the processes in FIGS. 11A-11D.

FIG. 7A illustrates an example physical environment 7000 that includes a user 7002 interacting with a computer system 101. Computer system 101 is worn on user 7002's head and typically positioned in front of user 7002. In FIG. 7A, user 7002's left hand 7020 and right hand 7022 are free to interact with computer system 101. Physical environment 7000 includes a physical object 7014, physical walls 7004 and 7006, and a physical floor 7008. As shown in the examples in FIGS. 7B-7M, display generation component 7100a of computer system 101 is a head-mounted display (HMD) worn on user 7002's head (e.g., what is shown in FIGS. 7B-7M as being visible via display generation component 7100a of computer system 101 corresponds to user 7002's viewport into an environment when wearing a head-mounted display).

In some embodiments, the head mounted display (HMD) 7100a includes one or more displays that display a representation of a portion of the three-dimensional environment 7000′ that corresponds to the perspective of the user. While an HMD typically includes multiple displays including a display for a right eye and a separate display for a left eye that display slightly different images to generate user interfaces with stereoscopic depth, in FIGS. 7B-7M, a single image is shown that corresponds to the image for a single eye and depth information is indicated with other annotations or description of the figures. In some embodiments, HMD 7100a includes one or more sensors (e.g., one or more interior- and/or exterior-facing image sensors 314), such as sensor 7101a, sensor 7101b and/or sensor 7101c (FIG. 7B) for detecting a state of the user, including facial and/or eye tracking of the user (e.g., using one or more inward-facing sensors 7101a and/or 7101b) and/or tracking hand, torso, or other movements of the user (e.g., using one or more outward-facing sensors 7101c). In some embodiments, HMD 7100a includes one or more input devices that are optionally located on a housing of HMD 7100a, such as one or more buttons, trackpads, touchscreens, scroll wheels, digital crowns that are rotatable and depressible or other input devices. In some embodiments, input elements are mechanical input elements; in some embodiments, input elements are solid state input elements that respond to press inputs based on detected pressure or intensity. For example, in FIGS. 7B-7M, HMD 7100a includes one or more of button 701, button 702 and digital crown 703 for providing inputs to HMD 7100a. It will be understood that additional and/or alternative input devices may be included in HMD 7100a.

In some embodiments, the display generation component of computer system 101 is a touchscreen held by user 7002. In some embodiments, the display generation component is a standalone display, a projector, or another type of display. In some embodiments, the computer system is in communication with one or more input devices, including cameras or other sensors and input devices that detect movement of the user's hand(s), movement of the user's body as whole, and/or movement of the user's head in the physical environment. In some embodiments, the one or more input devices detect the movement and the current postures, orientations, and positions of the user's hand(s), face, and/or body as a whole. For example, in some embodiments, while the user's hand 7020 (e.g., a left hand) is within the field of view of the one or more sensors of HMD 7100a (e.g., within the viewport of the user), a representation of the user's hand 7020′ is displayed in the user interface displayed (e.g., as a passthrough representation and/or as a virtual representation of the user's hand 7020) on the display of HMD 7100a. In some embodiments, while the user's hand 7022 (e.g., a right hand) is within the field of view of the one or more sensors of HMD 7100a (e.g., within the viewport of the user), a representation of the user's hand 7022′ is displayed in the user interface displayed (e.g., as a passthrough representation and/or as a virtual representation of the user's hand 7022) on the display of HMD 7100a. In some embodiments, the user's hand 7020 and/or the user's hand 7022 are used to perform one or more gestures (e.g., one or more air gestures), optionally in combination with a gaze input. In some embodiments, the one or more gestures performed with the user's hand(s) 7020 and/or 7022 include a direct air gesture input that is based on a position of the representation of the user's hand(s) 7020′ and/or 7022′ displayed within the user interface on the display of HMD 7100a. In some embodiments, the one or more gestures performed with the user's hand(s) 7020 and/or 7022 are detected using one or more sensors of HMD 7100a that allow spatial positions of the user's hand(s) 7020 and/or 7022 to be tracked as a function of time. In some embodiments, the one or more gestures performed with the user's hand(s) 7020 and/or 7022 are detected using one or more controllers associated with HMD 7100a (e.g., the user's hand(s) 7020 and/or 7022 grasping, contacting and/or maneuvering the one or more controllers). For example, a direct air gesture input is determined as being directed to a user interface object displayed at a position that intersects with the displayed position of the representation of the user's hand(s) 7020′ and/or 7022′ in the user interface. In some embodiments, the one or more gestures performed with the user's hand(s) 7020 and/or 7022 include an indirect air gesture input that is based on a virtual object displayed at a position that corresponds to a position at which the user's attention is currently detected (e.g., and/or is optionally not based on a position of the representation of the user's hand(s) 7020′ and/or 7022′ displayed within the user interface). For example, an indirect air gesture is performed with respect to a user interface object while detecting the user's attention (e.g., based on gaze or other indication of user attention) on the user interface object, such as a gaze and pinch (e.g., or other gesture performed with the user's hand). In some embodiments, one or more of the air pinch inputs are replaced with controller detected inputs such as button presses, squeezes or tap inputs. In some embodiments, where hand inputs are being detected using a controller an air pinch gesture is replaced with a button press (or squeeze input, or tap) on the controller, a double air pinch gesture is replaced with a double button press (or double squeeze input, or double tap) on the controller, and/or a long air pinch gesture is replaced with a long button press (or long squeeze input, or long press) on the controller, while hand movement inputs are detected based on movement of the controller.

In some embodiments, user inputs are detected via a touch-sensitive surface or touchscreen. In some embodiments, the one or more input devices include an eye tracking component that detects location and movement of the user's gaze. In some embodiments, the display generation component, and optionally, the one or more input devices and the computer system, are parts of a head-mounted device that moves and rotates with the user's head in the physical environment, and changes the viewpoint of the user in the three-dimensional environment provided via the display generation component. In some embodiments, the display generation component is a heads-up display that does not move or rotate with the user's head or the user's body as a whole, but, optionally, changes the viewpoint of the user in the three-dimensional environment in accordance with the movement of the user's head or body relative to the display generation component. In some embodiments, the display generation component (e.g., a touchscreen) is optionally moved and rotated by the user's hand relative to the physical environment or relative to the user's head, and changes the viewpoint of the user in the three-dimensional environment in accordance with the movement of the display generation component relative to the user's head or face or relative to the physical environment.

In some embodiments, one or more portions of the view of physical environment 7000 that is visible to user 7002 via display generation component 7100a are digital passthrough portions that include representations of corresponding portions of physical environment 7000 captured via one or more image sensors of computer system 101. In some embodiments, one or more portions of the view of physical environment 7000 that is visible to user 7002 via display generation component 7100a are optical passthrough portions, in that user 7002 can see one or more portions of physical environment 7000 through one or more transparent or semi-transparent portions of display generation component 7100a.

FIG. 7B illustrates a view of a three-dimensional environment (e.g., corresponding at least partially to physical environment 7000 in FIG. 7A) that is visible to user 7002 via display generation component 7100a (also called herein “MD 7100a”) of computer system 101. The three-dimensional environment of FIG. 7B optionally includes representations of objects in a physical environment such as physical environment 7000 (e.g., as captured by one or more cameras of computer system 101). For example, in FIG. 7B, the three-dimensional environment includes representation 7014′ of physical object 7014, representations 7004′ and 7006′ of physical walls 7004 and 7006, respectively, and representation 7008′ of physical floor 7008. In addition, the three-dimensional environment includes one or more computer-generated objects, also called virtual objects, such as application user interface 7010 and application user interface 7012 (e.g., which are not representations of physical objects in physical environment 7000). In some embodiments, application user interface 7010 and application user interface 7012 correspond to respective user interfaces of software applications executing on computer system 101 (e.g., an email application, a web browser, a messaging application, a maps application, or other software application). FIG. 7B also illustrates application user interface 7010 as being more visually emphasized relative to application user interface 7012 (e.g., with a decreased degree of blurring, with an increased brightness, with an increased saturation, increased intensity, increased contrast, an increased opacity, and/or other emphasis) due to user 7002 interacting more recently with application user interface 7010 than with application user interface 7012.

FIG. 7B also shows representation 7022′ of user 7002's right hand 7022 performing air pinch gesture 7500. In some embodiments, representation 7022′ is visible in the three-dimensional environment via HMD 7100a. In some embodiments, computer system 101 is configured to detect the input provided by user 7002's right hand 7022 (or left hand 7020) without displaying representation 7022′ (or representation 7020′) in the three-dimensional environment via HMD 7100a. FIG. 7B illustrates a user input that includes hand 7022 (e.g., visible via HMD 7100a (e.g., within the viewport into the three-dimensional environment) as representation 7022′ of the user's hand 7022) performing air pinch gesture 7500 (e.g., including bringing two or more fingers into contact) while user 7002's attention is directed to (e.g., based on user 7002 gazing at) auxiliary user interface element 7015 associated with application user interface 7012. As illustrated in FIG. 7B, air pinch gesture 7500 is performed without movement (e.g., after the two or more fingers are brought into contact, hand 7022 of user 7002 moves by less than a threshold movement amount).

FIG. 7C illustrates an example transition from FIG. 7B. Based on user 7002's gaze location when air pinch gesture 7500 by hand 7022 is detected, and optionally because air pinch gesture 7500 is detected without movement that is above a threshold movement amount (e.g., an air pinch-and-release gesture), application user interface 7012 is selected. In response to detecting air pinch gesture 7500 performed by hand 7022, application user interface 7012 is visually emphasized relative to application user interface 7010, as illustrated in FIG. 7C. In some embodiments, instead of selecting an application user interface, air pinch gesture 7500 may also be used to select content items (e.g., media files such as image files, video files, or audio clips, or documents) based on user 7002's gaze location. FIG. 7C further illustrates a user input that includes hand 7022 performing air gesture 7501 that includes movement (e.g., after the two or more fingers are brought into contact) in depth, away from a viewpoint of user 7002 (e.g., air gesture 7501 is optionally movement in depth that is a continuation of air pinch gesture 7500 in FIG. 7B (e.g., part of the same input), or a distinct, subsequent input that includes as an initial portion another air pinch gesture followed by the movement in depth (e.g., sometimes called an air pinch-and-push gesture)) while user 7002's attention is directed to (e.g., continues to be directed to) auxiliary user interface element 7015 associated with application user interface 7012.

FIG. 7D illustrates an example transition from FIG. 7C. Based on detecting the movement in depth away from the viewpoint of user 7002 of air gesture 7501 while user 7002's gaze location is directed toward application user interface 7012, application user interface 7012 is pushed in depth away from the viewpoint of user 7002. Dashed line frame 7016 in FIG. 7D indicates the previous position of application user interface 7012 in the environment illustrated in FIG. 7C.

In some embodiments, rather than moving application user interface 7012 in depth away from the viewpoint of user 7002 in accordance with the movement in depth away from the viewpoint of user 7002 in air gesture 7501 as in FIGS. 7C-7D, if the movement of air gesture 7501 were in a direction that is different from movement in depth relative to the viewpoint of user 7002 (e.g., laterally left or right, or vertically up or down), computer system 101 would move application user interface 7012 in a different direction (e.g., laterally left or right, or vertically up or down, respectively), or computer system 101 would optionally scroll content in application user interface 7012 (e.g., if user 7002's gaze were directed toward a location elsewhere in application user interface 7012 (e.g., within a main application content region rather than to an auxiliary user interface element such as auxiliary user interface element 7015)).

FIG. 7D also illustrates an air pinch gesture 7502 similar to (e.g., identical to) that described in FIG. 7C (e.g., hand 7022 performing another air pinch gesture (or more specifically, another air pinch-and-push gesture) (e.g., by first breaking contact between the two or more fingers that provided air gesture 7501 illustrated in FIG. 7C)), but in FIG. 7D user 7002's attention is directed to a location in the three-dimensional environment that is not associated with any selectable content or application user interface. As illustrated in FIG. 7D, user 7002's attention is directed to a bottom portion of representation 7006′ of physical wall 7006.

FIG. 7E illustrates an example transition from FIG. 7D. Based on the movement in depth away from the viewpoint of user 7002 of air pinch gesture 7502 while user 7002's gaze location is directed to a location in the three-dimensional environment that is not associated with any selectable content or application user interface, a system user interface is displayed. In some embodiments, the system user interface is a multitasking user interface that displays one or more representations of applications that were recently open on computer system 101. The recently open applications in computer system 101 include application user interfaces that are within the viewport into the three-dimensional environment, such as application user interface 7010 and application user interface 7012, and application user interfaces that are outside the viewport of the three-dimensional environment, such as application user interface 7024 and application user interface 7026, and optionally applications that are open or were recently open on computer system 101 yet are not displayed (e.g., are minimized or hidden) in the three-dimensional environment. In some embodiments, the representations of application user interfaces move from spatially distributed locations in the three-dimensional environment to a predetermined arrangement in the multitasking user interface.

In the example transition illustrated in FIG. 7E, representations of application user interfaces not within (e.g., outside) the viewport of the three-dimensional environment move into region 7019, optionally displayed as a temporary placeholder platter, as illustrated in FIG. 7E by dashed lines, from peripheral regions of the viewport, or representing an intermediate appearance of (e.g., the background portion of) multitasking user interface 7018 (FIG. 7F), or optionally not displayed. Optionally, application user interface 7012 moves toward being displayed at a location (e.g., top leftmost corner) in region 7019 because user 7002 has most recently interacted with application user interface 7012 (e.g., as illustrated in FIG. 7D) without regard to the relative spatial arrangement of application user interface 7012 and application user interface 7010 in the three-dimensional environment (e.g., even though application user interface 7010 was displayed to the left of application user interface 7012 in the three-dimensional environment when the user input illustrated in FIG. 7D was detected, during the example transition illustrated in FIG. 7E, application user interface 7010 has moved to the right of application user interface 7012).

FIG. 7F illustrates an example transition from FIG. 7E. Based on detecting a continuation of air pinch gesture 7502 performed by hand 7022 (e.g., sustained contact between fingers of hand 7022, and/or optionally with continued movement in depth away from the viewpoint of user 7002), multitasking user interface 7018 is displayed in the viewport. Optionally, multitasking user interface 7018 is displayed at the same location as region 7019 with a higher opacity and/or higher intensity than the display characteristics associated with region 7019. Representations of application user interfaces 7010, 7012, 7024, and 7026 are displayed in multitasking user interface 7018. In some embodiments, passthrough portion 7028 of the three-dimensional environment is deemphasized (e.g., by increasing a degree of blurring, reducing a brightness, reducing a saturation, reducing intensity, reducing a contrast, reducing an opacity, and/or other deemphasis) while multitasking user interface 7018 is displayed in the viewport.

FIG. 7G illustrates an alternative example transition from FIG. 7E, in which a release of air pinch gesture 7502 is detected after (e.g., immediately after) the animated transition illustrated in FIG. 7E begins to be displayed in the viewport. For example, FIG. 7G illustrates a user input that includes release 7504 of air pinch gesture 7502 such that the contact between fingers is broken after the user input illustrated in FIG. 7E is detected. In response to detecting release 7504 of air pinch gesture 7502, computer system 101 ceases display of the animated transition illustrated in FIG. 7E and reverts to displaying application user interface 7010 and application user interface 7012 in the viewport, as illustrated in FIG. 7G, which corresponds to the viewport prior (e.g., immediately prior) to detecting the user input illustrated in FIG. 7D. The earlier release 7504 of air pinch gesture 7502 (e.g., prior to a threshold amount of movement and/or threshold duration of the air pinch gesture, in contrast to FIG. 7F) allows user 7002 to cancel display of a system user interface, such as multitasking user interface 7018, before the system user interface is fully displayed. Such visual feedback allows user 7002 to undo an inadvertently provided user input by releasing air pinch gesture 7502 without having to wait until the system user interface is fully displayed to provide a separate cancellation user input.

FIGS. 7H and 7I illustrate performing an operation associated with multitasking user interface 7018 using air pinch gesture 7506 (e.g., FIG. 7H illustrates an example transition from FIG. 7F). Based on user 7002's gaze location (e.g., directed to application user interface 7010) when air pinch gesture 7506 by hand 7022 is detected, the representation of application user interface 7010 is selected. Optionally, the representation of application user interface 7010 is visually emphasized in appearance (e.g., highlighted, displayed with a selection outline and/or other visual emphasis associated with application user interface targeting) to indicate that application user interface 7010 is a currently selected application user interface. In response to detecting movement (e.g., upward, vertical, leftward, or rightward swipe movement) of air pinch gesture 7506 performed by hand 7022, prior to contact between the two or more fingers in air pinch gesture 7506 being broken, and while user 7002's gaze is directed toward the representation of application user interface 7010, computer system 101 ceases display of the representation of application user interface 7010 in multitasking user interface 7018, as illustrated in FIG. 7I, and closes the application corresponding to application user interface 7010 (e.g., accordingly, in response to an input dismissing multitasking user interface 7018 (e.g., an air pinch-and-pull gesture, a palm-up air pinch, or other gesture), application user interface 7010 is not displayed due to having been closed, whereas other application windows, such as application user interface 7012, corresponding to open applications are redisplayed in the three-dimensional environment (e.g., displayed at their prior locations within the viewport into the three-dimensional environment and associated with the same prior locations outside of the viewport, or given default positions different from their prior locations in the three-dimensional environment) in combination with multitasking user interface 7018 ceasing to be displayed). The detected movement of air pinch gesture 7506 performed by hand 7022 is different from movement in depth relative to a viewpoint of the user. For example, as illustrated in FIG. 7H, the movement is an upward swipe movement made while air pinch gesture 7506 is maintained. Optionally, the representation of application user interface 7010 is animated to move off multitasking user interface 7018, in response to the movement of air pinch gesture 7506, prior to being dismissed from the viewport. For example, the representation of application user interface 7010 may visually track the movement of air pinch gesture 7506 (e.g., lifted from the grid arrangement in multitasking user interface 7018). Optionally, other representations of application user interfaces are reordered in response to the movement and/or removal of the representation of application user interface 7010 (e.g., application representations 7024 and 7026 in FIG. 7I are shifted relative to in FIG. 7H to fill the vacated position previously occupied by the representation of application user interface 7010 in FIG. 7H). In some embodiments, in response to the movement of air pinch gesture 7506 in a direction that is different from movement in depth relative to the viewpoint of user 7002 (e.g., and optionally in accordance with a determination that selection criteria for a specific application representation is not met (e.g., user 7002's attention is not directed to the representation of application user interface 7010 and/or air pinch gesture 7506 does not start after the air pinch gesture has been maintained for at least a threshold duration prior to the movement), the computer system scrolls the representations of application user interfaces in multitasking user interface 7018 to display a different set of representations of application user interfaces, including by ceasing to display one or more of the representations of application user interface 7012, application user interface 7010, application user interface 7024, and application user interface 7026 in conjunction with displaying one or more additional representations of application user interfaces not previously displayed.

While FIGS. 7E-7F illustrate a first example transition from FIG. 7D involving display of a first system user interface, multitasking user interface 7018, in accordance with a determination that the input initiated in FIG. 7D by hand 7022 meets first criteria, FIGS. 7J-7K illustrate an alternative transition from FIG. 7D involving display of a second system user interface, home menu user interface 7030, in accordance with a determination that the input initiated in FIG. 7D by hand 7022 (e.g., including movement detected while air pinch gesture 7502 is maintained by hand 7022) does not meet the first criteria. In some embodiments, the first criteria are not met when the movement in depth away from the viewpoint of user 7002 is above a threshold velocity vₜₕ and/or above a threshold distance dₜₕ. Conversely, the first criteria are met when the movement of air pinch gesture 7502 in depth away from the viewpoint of user 7002 is below the threshold velocity vₜₕ, below the threshold distance dₜₕ, and/or includes a pause in the movement.

Based on the movement of air pinch gesture 7502 not meeting the first criteria, home menu user interface 7030 is displayed, as illustrated in FIG. 7K. In some embodiments, an animated transition involving representations of applications (e.g., icons of applications) precedes display of home menu user interface 7030. For example, as illustrated in FIG. 7J, a collection of representations of applications (e.g., icons of applications) is presented in a first spatial region of user 7002's viewport into the three-dimensional environment. In some embodiments, as shown in FIG. 7J, the first spatial region is a peripheral region of user 7002's viewport into the three-dimensional environment. For example, representations 7112, 7114, 7116, 7120, 7122, 7126, 7128, and 7130 appear in a peripheral region of the viewport into the three-dimensional environment. In some embodiments, the representations of applications shown in FIG. 7J coalesce inwards and are arranged in home menu user interface 7030 as shown in FIG. 7K. Affordances 7232, 7234, and 7236 allow other collections of representations to be displayed in home menu user interface 7030. Alternatively or additionally, representations of applications in home menu user interface 7030 fade in during the animated transition. As with the multitasking user interface 7018 in FIG. 7F, which is another type of system user interface, passthrough portion 7028 of the three-dimensional environment is visually deemphasized while home menu user interface 7030 is displayed in the viewport. Similar to the scenario illustrated in FIG. 7G (e.g., as an alternate transition from FIG. 7E), a release (e.g., like release 7504 of FIG. 7G) of air pinch gesture 7502 while the animated transition illustrated in FIG. 7J is displayed in progress in the viewport would cancel the display of home menu user interface 7030, and computer system 101 would revert to displaying application user interface 7010 and application user interface 7012 as illustrated in FIG. 7D (and similarly FIG. 7G).

Returning to FIGS. 7E and 7F, in some embodiments, the first criteria are met when the movement in depth away from the viewpoint of user 7002 is below a threshold velocity vₜₕ, below a threshold distance dₜₕ, and/or includes a pause during (e.g., the movement continues after the pause) or after the movement. For example, the first criteria are met after initial movement in depth is detected while air pinch gesture 7502 is maintained, followed by a pause that optionally spans a threshold amount of time Tₜₕ (also called herein a “first threshold amount of time”) while the air pinch gesture is maintained. In response to detecting an air pinch gesture that includes movement in depth and that meets the first criteria, computer system 101 displays multitasking user interface 7018. In some circumstances, release 7504 of air pinch gesture 7502 is detected after air pinch gesture 7502 is determined to have met the first criteria (e.g., such that multitasking user interface 7018 is to be displayed instead of another system user interface such as home menu user interface 7030) but before air pinch gesture 7502 has met completion criteria (e.g., a completion threshold distance associated with the movement of air pinch gesture 7502, which is different from and larger than the threshold distance dₜₕ) for multitasking user interface 7018 to be fully displayed, and as a result, display of multitasking user interface 7018 is cancelled (e.g., as described herein with reference to FIG. 7G).

FIG. 7K further illustrates air pinch gesture 7508 that is followed by a movement in depth toward user 7002's viewpoint while air pinch gesture 7508 is maintained (e.g., sometimes called an air pinch-and-pull gesture). In response to detecting the movement in depth toward user 7002's viewpoint, computer system 101 ceases display of home menu user interface 7030 shown in FIG. 7K, and redisplays the viewport shown in FIG. 7D. Similarly, if air pinch gesture 7508 were performed while displaying multitasking user interface 7018 (e.g., as illustrated in FIG. 7F), in response, computer system 101 would cease to display multitasking user interface 7018 shown in FIG. 7F, and redisplay the viewport shown in FIG. 7D.

Contrasting with FIGS. 7E and 7F, in which multitasking user interface 7018 is displayed in response to movement of an air pinch gesture away from a viewpoint of user 7002 (and optionally in accordance with a determination that the movement, while the air pinch gesture is maintained by hand 7022, meets first criteria), FIGS. 7L and 7M illustrate an alternative transition in response to detecting air pinch gesture 7502 under different circumstances. In some embodiments, in response to movement (e.g., that optionally meets the first criteria) detected while air pinch gesture 7502 is maintained by hand 7022, in accordance with a determination that no application was recently in use on computer system 101 (e.g., no currently open applications, no applications operating in a foreground, and/or no dormant applications operating in a background), home menu user interface 7030 is displayed, as illustrated in FIG. 7M (e.g., even if movement while air pinch gesture 7502 is maintained by hand 7022 meets first criteria). More generally, FIGS. 7E-7F in combination with FIGS. 7L-7M illustrate embodiments in which, in response to detecting an input by hand 7022 (e.g., that includes movement of an air pinch gesture away from the viewpoint of user 7002), computer system 101 determines whether to display multitasking user interface 7018 (or home menu user interface 7030) based on whether there were any recently open applications on computer system 101 (or not).

FIG. 7M further illustrates an air pinch gesture that is followed by a movement in depth away from user 7002's viewpoint while the air pinch gesture is maintained (e.g., a subsequent input to the input in FIG. 7L, or a continuation of the input in FIG. 7L after home menu user interface 7030 has been displayed). In response to detecting a first portion of the movement input in depth away user 7002's viewpoint, and while home menu user interface 7030 is displayed, representations 7112, 7114, 7116, 7118, 7120, 7122, 7124, 7126, 7128, and 7130 move away from the viewpoint of user 7002, in the same direction as the first portion of the movement input. Optionally, representations 7112, 7114, 7116, 7118, 7120, 7122, 7124, 7126, 7128, and 7130 are visually deemphasized (e.g., by increasing a degree of blurring, reducing a brightness, reducing a saturation, reducing intensity, reducing a contrast, reducing an opacity, appearing further from the viewpoint of user 7002, and/or other deemphasis), as denoted by the dashed line representations. In response to detecting a termination or conclusion of the movement input, visual deemphasis of representations 7112, 7114, 7116, 7118, 7120, 7122, 7124, 7126, 7128, and 7130 is at least partially reversed.

Additional descriptions regarding FIGS. 7A-7M are provided below in reference to method 11000 described with respect to FIGS. 11A-11D.

FIGS. 8A-8M illustrate examples of navigating content of different hierarchy levels in an application. FIGS. 12A-12B are flow diagrams of an exemplary method 12000 for navigating content of different hierarchy levels in an application. The user interfaces in FIGS. 8A-8M are used to illustrate the processes described below, including the processes in FIGS. 12A-12B.

FIG. 8A illustrates a view of a three-dimensional environment (e.g., corresponding at least partially to physical environment 7000 in FIG. 7A) that is visible to user 7002 via HMD 7100a of computer system 101. The three-dimensional environment includes application user interface 8002 and application user interface 8004 corresponding to respective user interfaces of software applications executing on computer system 101 (e.g., a photo display application, a drawing application, a web browser, a messaging application, a maps application, or other software application). FIG. 8A also illustrates application user interface 8002 as being more visually emphasized relative to application user interface 8004 (e.g., by decreasing a degree of blurring, increasing a brightness, increasing a saturation, increasing intensity, increasing a contrast, increasing an opacity, and/or other visual emphasis) due to user 7002's gaze (or attention) being directed to application user interface 8002 and/or user 7002 interacting more recently with application user interface 8002 than with application user interface 8004.

The application associated with application user interface 8002 organizes media content (e.g., photos, music, videos, web pages, news articles, ebooks, and/or other media content) hierarchically. For example, as illustrated in FIG. 8A, a higher level of hierarchy includes first category 8006 that arranges media content based on media types (e.g., videos, live photos, animated, or RAW), second category 8008 that arranges and displays shared media content, third category 8010 that arranges and displays media content sorted by albums. Optionally, indicator 8022, as illustrated in FIG. 8A, shows a location within the hierarchical arrangement of media content currently displayed in portion 8024 of application user interface 8002.

FIG. 8A illustrates a user input that includes hand 7022 performing air pinch gesture 8500 (e.g., including bringing two or more fingers into contact) while user 7002's attention is directed to (e.g., based on user 7002 gazing at) album B (hereinafter also sometimes referred to as album 8014) within third category 8010 of media content. As illustrated in FIG. 8A, air pinch gesture 8500 is performed without movement of the air pinch (e.g., after the two or more fingers are brought into contact, and while this contact is maintained, hand 7022 of user 7002 moves by less than a threshold movement amount).

FIG. 8B illustrates an example transition from FIG. 8A (e.g., in response to release of air pinch gesture 8500 of FIG. 8A). Based on user 7002's gaze location when air pinch gesture 8500 by hand 7022 is detected, and because air pinch gesture 8500 is detected without movement above a threshold movement amount, album B is selected, as illustrated in FIG. 8B. In response to detecting air pinch gesture 8500 performed by hand 7022, application user interface 8002 is updated to display previews (e.g., thumbnails or other representations) of media content items IMG-1, IMG-2, IMG-3, IMG-4, IMG-5, IMG-6, IMG-7, IMG-8, and IMG-9 in album B in portion 8024 of application user interface 8002. FIG. 8B also illustrates a subsequent user input that includes hand 7022 performing air pinch gesture 8501 (e.g., after contact between fingers is broken in air pinch gesture 8500 illustrated in FIG. 8A) while user 7002's attention is directed to (e.g., based on user 7002 gazing at) IMG-4 within album B. Similar to air pinch gesture 8500 illustrated in FIG. 8A, air pinch gesture 8501 in FIG. 8B is also performed without movement (e.g., after the two or more fingers are brought into contact, hand 7022 of user 7002 moves by less than a threshold movement amount).

FIG. 8C illustrates an example transition from FIG. 8B (e.g., in response to the release of air pinch gesture 8501 of FIG. 8B, which is analogous to release 7504 of air pinch gesture 7502 of FIG. 7G). Based on user 7002's gaze location when air pinch gesture 8501 by hand 7022 is detected, and because air pinch gesture 8501 is detected without movement that is above a threshold movement amount, media content item IMG-4 is selected. In response to detecting air pinch gesture 8501 performed by hand 7022, application user interface 8002 is updated to display media content item IMG-4 in portion 8024 of application user interface 8002. FIG. 8C illustrates a subsequent user input that includes hand 7022 performing air pinch gesture 8504-1 (e.g., after contact between fingers is broken in the air pinch gesture 8501 illustrated in FIG. 8B) while user 7002's attention is directed to (e.g., based on user 7002 gazing at) application user interface 8002. The subsequent user input includes (e.g., is followed by) a movement in depth of air pinch gesture 8504-1 toward user 7002's viewpoint (e.g., air pinch gesture 8504-1 of FIG. 8C is an air pinch-and-pull gesture analogous to air pinch-and-pull gesture 7508 of FIG. 7K). In response to detecting the movement in depth toward user 7002's viewpoint, computer system 101 begins to cease display of content item IMG-4, and begins to redisplay previews of media content items IMG-1, IMG-2, IMG-3, IMG-4, IMG-5, IMG-6, IMG-7, IMG-8, and IMG-9 in portion 8024 of application user interface 8002, as illustrated in FIG. 8D. For example, computer system 101 begins to visually deemphasize (e.g., decrease in size, make more translucent (e.g., reduce an opacity), fade out, increase a degree of blurring, reduce a brightness, reduce a saturation, reduce intensity, reduce a contrast, and/or other deemphasis of) IMG-4 while visually emphasizing (e.g., increasing in size, increasing brightness, fading in, decreasing a degree of blurring, increasing opacity, increasing contrast, increasing saturation, increasing intensity, increasing contrast, highlighting, displaying a selection outline, and/or other emphasis of) the previews of media content items. Optionally, the visual deemphasis of the currently displayed content (e.g., content displayed in FIG. 8C such as content item IMG-4) and/or the visual emphasis of previously displayed content (e.g., content displayed in FIG. 8B) are displayed as an animated transition. Thus, air pinch gesture 8504-1 (FIG. 8C) that is followed by movement toward user 7002's viewpoint allows user 7002 to navigate backward (e.g., ceasing to display first content currently displayed on application user interface and redisplaying content displayed prior to (e.g., immediately prior to) the first content) in application user interface 8002, as illustrated in FIG. 8E. Accordingly, FIG. 8E illustrates a transition from FIG. 8D that occurs in accordance with a determination that the movement input begun in FIG. 8C meets completion criteria (e.g., in that the release of air pinch gesture 8504-1, as illustrated by hand 7022′ in FIG. 8D, is detected after the movement input has moved by at least a movement magnitude threshold and/or a speed threshold). In some embodiments, navigating backward includes redisplaying content of a higher hierarchy level than the content of the currently displayed hierarchy level, which ceases to be displayed when the higher hierarchy level content is displayed. For example, content item IMG-4 is at a lower level of hierarchy compared to a hierarchy level associated with album B. In some embodiments, album B is displayed (e.g., or redisplayed) (FIG. 8E) in response to the input by hand 7022′ in FIG. 8C (e.g., an air pinch-and-pull gesture) because album B is at a higher hierarchy level compared to the hierarchy level associated with content item IMG-4.

FIG. 8F illustrates an alternative transition from FIG. 8D, in which the release of the air pinch gesture 8504-1 (e.g., as illustrated by hand 7022′ in FIG. 8D) is detected during the animated transition illustrated in FIG. 8D, but before the movement input begun in FIG. 8C meets the completion criteria (e.g., a movement input that exceeds a movement magnitude threshold, and/or a movement input that exceeds a speed threshold) (e.g., which would otherwise complete the transition to FIG. 8E). In response to detecting the release of air pinch gesture 8504-1, computer system 101 ceases display of the animated transition illustrated in FIG. 8D and displays content item IMG-4 in portion 8024 of application user interface 8002 in the viewport, as illustrated in FIG. 8F, which corresponds to the viewport displayed prior (e.g., immediately prior) to detecting the user input illustrated in FIG. 8C (e.g., content item IMG-4 is redisplayed as it appeared in FIG. 8C). User 7002 is thus enabled to cancel backward navigation for displaying previously displayed content within application user interface 8002 (e.g., before the previously displayed content is fully displayed), by releasing air pinch gesture 8504-1 before an input threshold for fully displaying the previously displayed content is reached. Moreover, the visual feedback provided during the movement input (e.g., while air pinch gesture 8504-1 is maintained), as shown in FIG. 8D, allows user 7002 to undo an inadvertently provided user input by releasing air pinch gesture 8504-1, and without having to wait until content item IMG-4 ceases to be displayed to provide a separate user input to redisplay content item IMG-4.

Referring again to FIG. 8E, FIG. 8E illustrates an example navigation gesture different from that illustrated in FIG. 8A. FIG. 8E illustrates a subsequent user input that includes hand 7022 performing air pinch gesture 8505-1 (e.g., after contact between fingers is broken in the air pinch gesture 8504-1 illustrated in FIG. 8C (e.g., after the release of air pinch gesture 8504-1 in FIG. 8D)) while user 7002's attention is directed to (e.g., based on user 7002 gazing at) application user interface 8002, that is followed by a movement in depth of air pinch gesture 8505-1 away from user 7002's viewpoint. In response to detecting the movement in depth away from user 7002's viewpoint, computer system 101 displays content item IMG-4, as illustrated in FIG. 8F, even though user 7002's attention is not specifically directed to content item IMG-4 while the user input 8505-1 illustrated in FIG. 8E is detected. Content item IMG-4 is at a lower level of hierarchy compared to a hierarchy level associated with album B. In some embodiments, content item IMG-4 is displayed (e.g., or redisplayed) (FIG. 8F) in response to the input by hand 7022′ in FIG. 8E (e.g., an air pinch-and-push gesture) because content item IMG-4 is at a lower level of hierarchy compared to the hierarchy level associated with album B.

FIG. 8F illustrates another user input that includes hand 7022 performing air pinch gesture 8505-2 (e.g., after contact between fingers is broken in air pinch gesture 8505-1 illustrated in FIG. 8E), that is followed by a movement in depth of air pinch gesture 8505-2 away from user 7002's viewpoint. In response to detecting the movement in depth away from user 7002's viewpoint, computer system 101 displays modal user interface object 8030 that requires user 7002's input and/or attention in order to be dismissed from the viewport into the three-dimensional environment, as illustrated in FIG. 8G. For example, modal user interface object 8030 requests user 7002 to indicate whether content item IMG-4 is to be deleted.

Modal user interface object 8030 is within a hierarchy of content displayed via application user interface 8002. For example, modal user interface object 8030 is at a lower level of hierarchy compared to a hierarchy level associated with content item IMG-4, which is in turn, at a lower hierarchy level than album B. In some embodiments, modal user interface object 8030 is displayed (FIG. 8G) in response to the input 8505-2 by hand 7022 in FIG. 8F (e.g., an air pinch-and-push gesture) because modal user interface object 8030 is at a lower level of hierarchy compared to a hierarchy level associated with content item IMG-4. Similarly, in some embodiments, content item IMG-4 is displayed (e.g., or redisplayed) (FIG. 8F) in response to the input 8505-1 by hand 7022 in FIG. 8E (e.g., an air pinch-and-push gesture) because content item IMG-4 is at a lower level of hierarchy compared to a hierarchy associated with album B. In contrast, in some embodiments, album B is displayed (e.g., or redisplayed) (FIG. 8E) in response to the input 8504-1 by hand 7022′ in FIG. 8C (e.g., an air pinch-and-pull gesture) because album B is at a higher level of hierarchy compared to the hierarchy level associated with content item IMG-4.

FIG. 8G illustrates a subsequent user input that includes hand 7022 performing an air pinch gesture 8504-2 that is followed by a movement in depth of the air pinch gesture toward user 7002's viewpoint (e.g., a repetition or another instance of air pinch-and-pull gesture 8504). In response to detecting the movement in depth toward user 7002's viewpoint, computer system 101 ceases display of (e.g., dismisses, optionally without activating any option within) modal user interface object 8030, as illustrated in FIG. 8H (e.g., because modal user interface object 8030 is at a lower level of hierarchy compared to a hierarchy level associated with content item IMG-4, and the air pinch-and-pull gesture allows user 7002 to navigate backward from modal user interface object 8030 to a higher level of hierarchy, by displaying (e.g., or redisplaying) content item IMG-4 displayed (FIG. 8H) in response to the input 8504-2 by hand 7022 in FIG. 8G (e.g., an air pinch-and-pull gesture)).

FIGS. 8H and 8I illustrate that performing an operation using an air pinch gesture that includes movement of the air pinch gesture in depth toward user 7002's viewpoint is based on where user 7002's attention is directed. In FIGS. 8H and 8I, based on user 7002's gaze location when air pinch gesture 8504-3 by hand 7022 is detected, application user interface 8004 is selected. Optionally, application user interface 8004 is visually emphasized in appearance (e.g., highlighted and/or other visual emphasis associated with application user interface targeting) to indicate that application user interface 8004 is a current application user interface target (e.g., and has focus for user interaction). In response to detecting movement of air pinch gesture 8504-3 in depth toward user 7002's viewpoint, prior to contact between the two or more fingers in air pinch gesture 8504-3 being broken, and while user 7002's gaze is directed toward the application user interface 8004, computer system 101 ceases to display the most recently added user content in application user interface 8004, as illustrated in FIG. 8I (e.g., in contrast to performing a hierarchical navigation operation in application user interface 8002 in response to an air pinch-and-pull gesture 8504 or air pinch-and-push gesture 8505, as described herein with reference to FIGS. 8C-8G). For example, application user interface 8004 is an application user interface associated with a drawing application. The most recently added user content in application user interface 8004 is curved line 8034. As illustrated in FIG. 8I, computer system 101 ceases to display curved line 8034 in response to detecting the release of air pinch gesture 8504-3 (or in response to detecting at least a threshold amount of movement of air pinch gesture 8504-3 even without detecting release of air pinch gesture 8504-3). Undoing the most recently added user content in application user interface 8004 is an example of navigating backward in application user interface 8004. Other examples include navigating backwards to a previously accessed webpage (e.g., within a browser application), video (e.g., within a media playing application), audio clip (e.g., within a media playing application), messages (e.g., within a messaging application), or document (e.g., within a document processing or displaying application).

FIGS. 8J and 8K illustrate performing an operation using an air pinch gesture that includes movement of the air pinch gesture in a different direction than described above. FIG. 8J illustrates a user input that includes hand 7022 performing air pinch gesture 8506 that is followed by a vertical movement of air pinch gesture 8506 (e.g., no substantial changes, or without more than a threshold amount of change, in depth from user 7002's viewpoint). Optionally, the movement following air pinch gesture 8506 is a horizontal (e.g., left or right) movement that does not substantially change in depth relative to user 7002's viewpoint. In response to detecting the vertical movement and while user 7002's gaze remains directed to application user interface 8002 (e.g., in some circumstances while user 7002's gaze is directed to a location in application user interface 8002 as shown in FIG. 8J, or while user 7002's gaze is directed to a location among the media content items in portion 8024, such as to media content item IMG-4 as shown in FIG. 8B), computer system 101 scrolls the content items displayed in portion 8024 of application user interface 8002, as illustrated in FIG. 8K. For example, in response to detecting the vertical movement, the content items displayed in portion 8024 are scrolled upwards to reveal additional previews of content items beyond IMG-9, such as IMG-10, IMG-11, IMG-12, IMG-13, IMG-14, and IMG-15, that are at the same hierarchy level as the previews of content items IMG-1 to IMG-9.

FIGS. 8L and 8M illustrate performing an operation with respect to a system user interface. In addition to using an air pinch gesture 8504 and a subsequent movement in depth toward a user 7002's viewpoint to navigate backward in an application user interface, a similar sequence (e.g., the same sequence) of gestures can be used with respect to system user interfaces. FIG. 8L illustrates multitasking user interface 7018 in a viewport into the three-dimensional environment. Multitasking user interface 7018 may be invoked as described with reference to FIGS. 7D-7F. For example, multitasking user interface 7018 is invoked (e.g., while user 7002's gaze is directed at a region of the three-dimensional environment that is not associated with selectable content, and air pinch gesture followed by movement of the air pinch gesture in depth away from user 7002's viewpoint is detected (analogous to air pinch-and-push gesture 7502 of FIGS. 7D-7E)) while application user interface 8002 and application user interface 8004 are displayed in the viewport (e.g., optionally deemphasized).

As illustrated in FIG. 8L, while multitasking user interface 7018 is displayed in the viewport, a user input that includes hand 7022 performing air pinch gesture 8504-4 that is followed by a movement in depth of air pinch gesture 8504-4 toward user 7002's viewpoint is detected. In response to detecting the movement in depth toward user 7002's viewpoint, computer system 101 ceases display of multitasking user interface 7018, as illustrated in FIG. 8M, while maintaining display of application user interface 8002 and application user interface 8004 in the viewport (e.g., optionally without deemphasis). Thus, air pinch gesture 8504-4 and subsequent movement in depth toward user 7002's viewpoint may be considered to be navigating backward or reversing the user input that triggered the display of multitasking user interface 7018 shown in FIG. 8L.

As shown in the examples in FIGS. 8A-8M, display generation component 7100a of computer system 101 is a head-mounted display worn on user 7002's head (e.g., what is shown in FIGS. 8A-8M as being visible via display generation component 7100a of computer system 101 corresponds to user 7002's viewport into the environment when wearing the head-mounted display). In some embodiments, content that is visible via a display generation component of computer system 101 is displayed on a touch screen held by user 7002.

Additional descriptions regarding FIGS. 8A-8M are provided below in reference to method 12000 described with respect to FIGS. 12A-12B.

FIGS. 9A-9Y illustrate examples of performing different operations based on an orientation of a palm of a user's hand. FIGS. 13A-13D are flow diagrams of an exemplary method 13000 for performing different operations based on an orientation of a palm of a user's hand. The user interfaces in FIGS. 9A-9Y are used to illustrate the processes described below, including the processes in FIGS. 13A-13D.

FIG. 9A illustrates a view of a three-dimensional environment (e.g., corresponding at least partially to physical environment 7000 in FIG. 7A) that is visible to user 7002 via HMD 7100a of computer system 101. Similar to the viewport illustrated in FIG. 8A, the three-dimensional environment includes application user interface 8002 and application user interface 8004 corresponding to respective user interfaces of software applications executing on computer system 101 (e.g., a photo display application, a drawing application, a web browser, a messaging application, a maps application, or other software application).

FIG. 9A illustrates a user input that includes hand 7022 performing air pinch gesture 9500-1 (e.g., including bringing two or more fingers into contact) while hand 7022 of user 7002 is oriented with a palm of hand 7022 facing toward a viewpoint of user 7002 (e.g., sometimes called a palm up air pinch gesture). For example, the palm is detected as facing toward a viewpoint of user 7002 in accordance with a determination that at least a threshold area or portion of the palm (e.g., at least 20%, at least 30%, at least 40%, at least 50%, more than 50%, more than 60%, more than 70%, more than 80%, or more than 90%) is detected by one or more input devices (e.g., in sensor system 6-102) as being visible from (e.g., facing toward) the viewpoint of user 7002.

FIG. 9B illustrates an example transition from FIG. 9A. Based on user 7002's palm being oriented toward the viewpoint of user 7002 when air pinch gesture 9500-1 by hand 7022 is detected, home menu user interface 7030 is displayed. FIG. 9B illustrates a second user input that includes air pinch gesture 9500-2 (e.g., including bringing two or more fingers into contact after contact between fingers is broken in air pinch gesture 9500-1 illustrated in FIG. 9A) performed while the palm of hand 7022 faces toward the viewpoint of user 7002 (e.g., air pinch gesture 9500-2 of FIG. 9B is optionally a repetition of air pinch gesture 9500-1 of FIG. 9A).

FIG. 9C illustrates an example transition from FIG. 9B. Based on user 7002's palm being oriented toward the viewpoint of user 7002 when air pinch gesture 9500-2 by hand 7022 is detected in FIG. 9B, and because home menu user interface 7030 is displayed when the air pinch gesture is detected, computer system 101 ceases display (e.g., hides) of home menu user interface 7030 in the viewport into the three-dimensional environment, as illustrated in FIG. 9C (e.g., analogously, home menu user interface 7030 is displayed in FIG. 9B because home menu user interface 7030 was not displayed when palm up air pinch gesture 9500-1 of FIG. 9A was detected). FIG. 9C also illustrates air pinch gesture 9500-3 detected while hand 7022 of user 7002 is oriented with the palm of hand 7022 facing toward the viewpoint of user 7002.

FIG. 9D illustrates an example transition from FIG. 9C (e.g., or an alternative transition from FIG. 9A, as FIG. 9A and FIG. 9C are analogous). Based on user 7002's palm being oriented toward the viewpoint of user 7002 when the air pinch gesture 9500-3 by hand 7022 in FIG. 9C is detected, multitasking user interface 7018 is displayed as shown in FIG. 9D. In some embodiments, as shown in FIG. 9D, application windows and application content that were displayed in the viewport prior to multitasking user interface 7018 being invoked continue to be displayed (e.g., visually deemphasized and in the background) while multitasking user interface 7018 is displayed, whereas in some embodiments, application windows and application content that were displayed in the viewport prior to multitasking user interface 7018 being invoked cease to be displayed (e.g., by animating to become part of multitasking user interface 7018) while multitasking user interface 7018 is displayed (e.g., as shown in FIGS. 7E-7F). In the example of FIG. 9D, computer system 101 displays multitasking user interface 7018 in accordance with a determination that multitasking user interface 7018 was not displayed when palm up air pinch gesture 9500-3 of FIG. 9C was detected. Accordingly, FIG. 9D illustrates computer system 101 configured with a different input model so that computer system 101 displays multitasking user interface 7018 in response to detecting a palm up air pinch gesture 9500, instead of displaying (or toggling display of) home menu user interface 7030 as illustrated in FIGS. 9A-9C. In some embodiments, whether home menu user interface 7030 or multitasking user interface 7018 is displayed or dismissed in response to detecting an air pinch gesture while hand 7022 of user 7002 is oriented with the palm of hand 7022 facing toward the viewpoint of user 7002 depends on the input model programmed for computer system 101. FIG. 9D also illustrates air pinch gesture 9500-4 detected while hand 7022 of user 7002 is oriented with the palm of hand 7022 facing toward the viewpoint of user 7002 and while multitasking user interface 7018 is displayed.

FIG. 9E illustrates an example transition from FIG. 9D. Based on user 7002's palm being oriented toward the viewpoint of user 7002 when air pinch gesture 9500-4 by hand 7022 is detected in FIG. 9D, and because multitasking user interface 7018 is displayed when the air pinch gesture is detected, computer system 101 ceases display (e.g., hides) of multitasking user interface 7018, as illustrated in FIG. 9E.

FIGS. 9E and 9F illustrate performing an operation using air pinch gesture 9501 while hand 7022 of user 7002 is oriented with a palm of hand 7022 facing away from a viewpoint of user 7002 (e.g., sometimes called a palm down air pinch gesture). For example, the palm is detected as facing away from the viewpoint of user 7002 in accordance with a determination that less than a threshold area or portion of the palm (e.g., less than 20%, less than 30%, less than 40%, less than 50%, less than 50%, or less than 60%), and/or in accordance with a determination that more than a threshold area or portion of the back of hand 7022 (e.g., at least 20%, at least 30%, at least 40%, at least 50%, more than 50%, more than 60%, more than 70%, more than 80%, or more than 90%) is detected by one or more input devices (e.g., in sensor system 6-102) as being visible from the viewpoint of user 7002.

FIG. 9E illustrates application user interface 8002 displaying previews (e.g., thumbnails or other representations) of media content items IMG-1, IMG-2, IMG-3, IMG-4, IMG-5, IMG-6, IMG-7, IMG-8, and IMG-9 in portion 8024. FIG. 9E also illustrates a user input that includes hand 7022 performing air pinch gesture 9501 while user 7002's attention is directed to (e.g., based on user 7002 gazing at) IMG-2 within album B. Unlike air pinch gesture 9500-1, 9500-2, 9500-3, and 9500-4 illustrated in FIGS. 9A-9D, air pinch gesture 9501 in FIG. 9E is detected while the palm of hand 7022 faces away from the viewpoint of user 7002 (e.g., a palm down air pinch gesture).

FIG. 9F illustrates an example transition from FIG. 9E. Based on user 7002's gaze location when air pinch gesture 9501 by hand 7022 is detected, and because air pinch gesture 9501 is detected with the palm facing away from the viewpoint of user 7002, content item IMG-2 is selected and application user interface 8002 is updated to display, in portion 8024, media content item IMG-2, as illustrated in FIG. 9F. FIG. 9F also illustrates a subsequent user input that includes hand 7022 performing long air pinch gesture 9502 (e.g., optionally after contact between fingers is broken in air pinch gesture 9501 illustrated in FIG. 9E) while the palm is facing toward the viewpoint of user 7002 (e.g., sometimes called a palm up long air pinch gesture).

FIG. 9G illustrates an example transition from FIG. 9F. Based on long air pinch gesture 9502 by hand 7022 being detected while the palm is facing toward the viewpoint of user 7002, application switching user interface 9002 is displayed. Graphical representations 9004, 9006, 9008, 9010, 9012 of respective applications that were recently open on computer system 101, and home affordance 9014 are displayed in application switching user interface 9002. Optionally, application switching user interface 9002 persists in the viewport, as illustrated in FIGS. 9H-9I, even when long air pinch gesture 9502 is no longer maintained, in accordance with a determination that long air pinch gesture 9502 meets respective criteria (e.g., long air pinch gesture meeting a time threshold). Further details about application switching user interface 9002 are provided herein with reference to FIGS. 10A-10J. FIG. 9G illustrates another user input that includes hand 7022 performing a double air pinch gesture 7510, denoted by two solid dots above hand 7022 (e.g., the two solid dots are optionally not displayed in the viewport), while the palm is facing away from the viewpoint of user 7002. In some embodiments, double air pinch gesture 7510 is detected based on an acceleration (e.g., of finger movement magnitude relative to the amount of movement of hand 7022).

FIG. 9H illustrates an example transition from FIG. 9G. Based on user 7002's gaze location when double air pinch gesture 7510 by hand 7022 is detected (e.g., on content item IMG-2), and that double air pinch gesture 7510 is detected while the palm is facing away from the viewpoint of user 7002, a zoom level for displaying content item IMG-2 is changed. For example, in response to detecting double air pinch gesture 7510 performed by hand 7022, application user interface 8002 is updated to display a zoomed in (e.g., 200% zoom, and/or a zoom level greater than a current zoom level such as greater than 100%) representation of media content item IMG-2 in portion 8024 of application user interface 8002, as illustrated in FIG. 9H. FIG. 9H illustrates a subsequent user input that includes hand 7022 performing air pinch gesture 9506 that is followed by a vertical movement of the air pinch gesture 9506 (e.g., no substantial changes in depth from user 7002's viewpoint) (e.g., sometimes called an air pinch-and-drag gesture). Optionally, the movement following the air pinch gesture is a horizontal movement that does not substantially change in depth from user 7002's viewpoint.

FIG. 9I illustrates an example transition from FIG. 9H. Based on user 7002's gaze location when the vertical movement of air pinch gesture 9506 by hand 7022 is detected, and because air pinch gesture 9506 is detected while the palm is facing away from the viewpoint of user 7002, a portion of media content item IMG-2 is moved (e.g., by dragging or panning) relative to the three-dimensional environment (e.g., to allow a different portion of the content element to be displayed). For example, a top portion of the zoomed in representation of media content item IMG-2 is displayed in portion 8024 of application user interface 8002 in FIG. 9I, instead of a middle portion of the zoomed in representation of media content item IMG-2 that is displayed in FIG. 9H. In some embodiments, instead of air pinch gesture 9506 that is followed by movement (as illustrated in FIG. 9H), a long air pinch gesture (e.g., a pinch gesture that is held stationary for a threshold period of time prior to movement of the pinch gesture while contact between fingers is maintained) that is followed by the movement is detected instead. In some embodiments, a long air pinch gesture that is followed by movement (sometimes called a long air pinch-and-drag gesture) is used to drag and drop user interface content within the viewport into the three-dimensional environment, instead of panning or scrolling application content as illustrated in FIG. 9I.

FIGS. 9J and 9K illustrate performing an operation with air pinch gesture 9508 that is detected while the palm is facing away from user 7002 and that is followed by movement without substantial changes in depth. FIG. 9J is analogous to FIG. 9E, except that instead of air pinch gesture 9501 used to select media content item IMG-2 in FIG. 9E, FIG. 9J illustrates a user input that includes hand 7022 performing air pinch gesture 9508 that is followed by a vertical movement of air pinch gesture 9508 (e.g., no substantial changes in depth from user 7002's viewpoint) while the palm is facing away from the viewpoint of user 7002.

FIG. 9K illustrates a transition from FIG. 9J in response to detecting air pinch gesture 9508 that is followed by a vertical movement of air pinch gesture 9508. Based on user 7002's gaze location when the vertical movement of air pinch gesture 9508 by hand 7022 is detected, and because air pinch gesture 9508 is detected while the palm is facing away from the viewpoint of user 7002, computer system 101 scrolls the content items displayed in portion 8024 of application user interface 8002. For example, in response to detecting the vertical movement, while user 7002's gaze remains directed to application user interface 8002 and while the sustained contact in air pinch gesture 9508 is maintained, the content items displayed in portion 8024 are scrolled upwards to reveal additional previews of content items beyond IMG-9, such as IMG-10, IMG-11, IMG-12, IMG-13, IMG-14, and IMG-15, that are in the same album as the previews of content items IMG-1 to IMG-9 (e.g., analogous to the transition from FIG. 8J to FIG. 8K). In some embodiments, instead of air pinch gesture 9508 that is followed by movement, a long air pinch gesture (e.g., a pinch gesture that is held stationary for a threshold period of time prior to movement of the pinch gesture while contact between fingers is maintained) that is followed by movement is detected instead. In some embodiments, as illustrated in FIGS. 9K-9M, long air pinch gesture 7512 (FIG. 9K) that is followed by movement (e.g., toward an upper right portion of the environment) while the palm is facing away from the viewpoint of user 7002 and while user 7002's attention is directed to (e.g., based on user 7002 gazing at) IMG-7 within album B, is used to drag and drop user interface content (e.g., IMG-7) within the viewport, instead of scrolling application content.

FIG. 9L illustrates an example transition from FIG. 9K. Based on user 7002's gaze location when long air pinch gesture 7512 by hand 7022 in FIG. 9K is detected, and because long air pinch gesture 7512 is followed by movement toward the upper right portion of the environment, IMG-7 is lifted from its prior position within the arrangement of content items in application user interface 8002. In FIG. 9L, long air pinch gesture 7512 continues to move toward a lower left portion of the environment, without breaking contact between the fingers of hand 7022, optionally while user 7002's gaze remains on IMG-7. Optionally, movement of IMG-7 is animated based on movement of long air pinch gesture 7512.

FIG. 9M illustrates an example transition from FIG. 9L. Based on (e.g., in response to) detecting a release of long air pinch gesture 7512 such that the contact between fingers is broken between the user input illustrated in FIGS. 9K and 9L, computer system 101 displays content item IMG-7 at a location in portion 8024 of application user interface 8002 that corresponds to (e.g., is closest to) the last position of content item IMG-7 along the movement trajectory of long air pinch gesture 7512. For example, content item IMG-7 is repositioned between IMG-10 and IMG-15 in portion 8024 of application user interface 8002 due to the movement of long air pinch gesture 7512 toward the lower right portion of the three-dimensional environment.

FIGS. 9N and 9O illustrate performing an operation using air pinch gesture 9504 that is detected while the palm is facing toward user 7002 and that is followed by movement without substantial changes in depth. The viewport illustrated in FIG. 9N is analogous to the viewport illustrated in FIG. 9G, except that instead of double air pinch gesture 7510 used to change a zoom level of media content item IMG-2 in FIG. 9G, FIG. 9N illustrates a user input that includes hand 7022 performing long air pinch gesture 9504 that is followed by a horizontal movement of long pinch gesture 9504 that optionally includes changes in depth from user 7002's viewpoint while the palm faces toward the viewpoint of user 7002. At the time long air pinch gesture 9504 is detected, prior to detecting any movement of long air pinch gesture 9504, application user interface 8002 is the most recently active application, and application switching user interface 9002 visually emphasizes representation 9004 that is associated with application user interface 8002 (e.g., by highlighting or bolding an outline of representation 9004).

FIG. 9O illustrates an example transition from FIG. 9N. Based on detecting the substantially horizontal movement of long air pinch gesture 9504 while the palm is facing toward the viewpoint of user 7002 and in accordance with a determination that the horizontal movement of long air pinch gesture 9504 results in a first input element (e.g., a hand or a controller) being directed toward a second location on application switching user interface 9002 associated with representation 9008, computer system 101 visually emphasizes representation 9008 associated with an immersive application in application switching user interface 9002 while displaying translucent representation 9050 of the immersive application in the viewport. Translucent representation 9050 is displayed in conjunction with a visually deemphasized version of the viewport displayed prior to detecting the horizontal movement of long air pinch gesture 9504. Optionally, computer system 101 displays one or more intermediate states prior to displaying translucent representation 9050 (e.g., because long air pinch gesture 9504 results in a first input element (e.g., a hand or a controller) traversing representations of other applications (e.g., representation 9006 of a drawing application) before the first input element is directed at representation 9008). For example, a preview of the application associated with representation 9006 is displayed in the viewport as an intermediate state prior to displaying translucent representation 9050.

FIGS. 9P-9Q illustrate performing an operation using double air pinch gesture 9510-1 that is detected while the palm is facing toward user 7002 without movement that is above a threshold movement amount.

FIG. 9Q illustrates a transition from FIG. 9P. Based on detecting double air pinch gesture 9510-1 while the palm is facing toward the viewpoint of user 7002 (FIG. 9P), computer system 101 displays control center user interface 8052 (e.g., a system function menu) (FIG. 9Q).

FIG. 9R illustrates an alternative transition from FIG. 9P. Based on detecting double air pinch gesture 9510-1 while the palm is facing toward the viewpoint of user 7002, computer system 101 displays home menu user interface 7030. FIG. 9R illustrates a subsequent user input that includes hand 7022 performing another double air pinch gesture 9510-2 while the palm is facing toward the viewpoint of user 7002.

FIG. 9S illustrates an example transition from FIG. 9R. Based on detecting the double air pinch gesture while the palm is facing toward the viewpoint of user 7002, and in accordance with a determination that home menu user interface 7030 is currently displayed in the viewport, computer system 101 ceases display of home menu user interface 7030. Analogously, in some embodiments, in response to detecting a palm up double air pinch gesture 9510 (e.g., analogous to palm up double air pinch gesture 9510-2 of FIG. 9R) while control center user interface 8052 (FIG. 9Q) is displayed in the viewport, computer system 101 ceases display of control center user interface 8052.

FIGS. 9T-9U illustrate performing an operation using double air pinch gesture 9512-1 that is detected while the palm is facing away from user 7002 without movement that is above a threshold movement amount (sometimes called a palm down double air pinch gesture). The viewport illustrated in FIG. 9T is identical to the viewport illustrated in FIG. 9R, except that double air pinch gesture 9510-2 of FIG. 9R is detected while the palm is facing toward the viewpoint of user 7002, whereas in FIG. 9T, double air pinch gesture 9512-1 is detected while the palm faces away from the viewpoint of user 7002.

FIG. 9U illustrates a transition from FIG. 9T. Based on user 7002's gaze location being directed at representation 7120 when double air pinch gesture 9512-1 is detected while the palm is facing away from the viewpoint of user 7002, a user interface 7121 of an application corresponding to representation 7120 is displayed, as illustrated in FIG. 9U.

FIGS. 9V-9Y illustrate performing operations using double air pinch gesture 9512-2 that is detected while the palm is facing away from user 7002 without movement that is above a threshold movement amount. The viewport illustrated in FIG. 9V is similar to the viewport illustrated in FIG. 9P, except for text block 8056 being additionally displayed in application user interface 8004. Instead of detecting a palm up double air pinch gesture 9510 while the palm is facing toward the viewpoint of user 7002, as illustrated in FIG. 9P, in FIG. 9V a palm down double air pinch gesture 9512-2 is detected while the palm faces away from the viewpoint of user 7002.

FIG. 9W illustrates a transition from FIG. 9V. Based on user 7002's gaze location being directed at text block 8056 (e.g., at an end portion of text block 8056) when the double air pinch gesture is detected while the palm faces away from the viewpoint of user 7002, cursor 8058 is placed within (e.g., at the end portion of) text block 8056.

FIG. 9X illustrates an alternative transition from, or alternative scenario to, FIGS. 9V-9W. Based on user 7002's gaze location being directed at curved line portion 8032 when a double air pinch gesture 9512 is detected while the palm is facing away from the viewpoint of user 7002, cursor 8059 is placed in proximity to curved line portion 8032.

FIG. 9Y illustrates an alternative transition from, or alternative scenario to, FIGS. 9V-9W. Based on user 7002's gaze location being directed at curved line portion 8034 when a double air pinch gesture 9512 is detected while the palm is facing away from the viewpoint of user 7002, cursor 8059 is placed in proximity to curved line 8034.

Table 1 below shows two different input models for computer system 101 that exhibit the different alternative behaviors illustrated in FIGS. 9A-9Y. For example, input model A is illustrated by FIGS. 9A-9C (e.g., in which a palm up single air pinch gesture 9500 is used to display or hide home menu user interface 7030), whereas input model B is illustrated by FIGS. 9P and 9R-9S, (e.g., in which a palm up double air pinch gesture 9510 is used, rather than a palm up single air pinch gesture 9500, to display or hide home menu user interface 7030). In some embodiments, as represented in Table 1, the same gesture is used in both input models A and B to invoke application switching user interface 9002; accordingly, both input models A and B are illustrated by FIGS. 9F-9G and 9N-9O (e.g., in which a palm up single long air pinch gesture 9502 or 9504 is used to display application switching user interface 9002).

TABLE 1
EXAMPLE INPUT MODELS

| Palm Up | Model A | Model B |
|---|---|---|
| Single air pinch | Show/hide home | — |
| Single air pinch and hold | Application switcher | Application switcher |
| Double air pinch | — | Show/hide home |

In input model B, the palm up (e.g., palm facing toward a viewpoint of the user) single air pinch gesture (also called a single pinch gesture or single air tap gesture) is not mapped to any operation, for example to reduce false positives (e.g., of displaying home menu user interface in response to a single air pinch gesture instead of a double air pinch gesture). Alternatively, the single air pinch gesture is optionally mapped in input model B to displaying or dismissing a multitasking user interface 7018, as illustrated in FIGS. 9C-9E. Similarly, for input model A, the double air pinch gesture (also called a double pinch gesture or double air tap gesture) may be mapped to displaying control user interface 8052, as illustrated in FIG. 9P and FIG. 9Q, if false positives and/or other disambiguation issues with the single air pinch gesture are not significant (e.g., not so significant as to preclude mapping the single air pinch gesture to showing/hiding the home menu user interface). In some embodiments, the double air pinch gesture is not mapped to any operations in input model A.

As shown in the examples in FIGS. 9A-9Y, display generation component 7100a of computer system 101 is a head-mounted display worn on user 7002's head (e.g., what is shown in FIGS. 9A-9Y as being visible via display generation component 7100a of computer system 101 corresponds to user 7002's viewport into the environment when wearing the head-mounted display). In some embodiments, content that is visible via a display generation component of computer system 101 is displayed on a touch screen held by user 7002.

Additional descriptions regarding FIGS. 9A-9Y are provided below in reference to method 13000 described with respect to FIGS. 13A-13D.

FIGS. 10A-10J illustrate examples of interacting with an application switching user interface. FIGS. 14A-14D are flow diagrams of an exemplary method 14000 for interacting with an application switching user interface. The user interfaces in FIGS. 10A-10J are used to illustrate the processes described below, including the processes in FIGS. 14A-14D.

FIG. 10A illustrates a view of a three-dimensional environment (e.g., corresponding at least partially to physical environment 7000 in FIG. 7A) that is visible to user 7002 via HMD 7100a of computer system 101. The three-dimensional environment includes application user interface 10002, application user interface 10004, and application user interface 10006 corresponding to respective user interfaces of software applications executing on computer system 101 (e.g., a photo display application, a drawing application, a web browser, a messaging application, a maps application, or other software application).

FIG. 10A illustrates a user input that includes hand 7022 performing long air pinch gesture 10502 (e.g., including bringing two or more fingers into contact for a first threshold amount of time) while hand 7022 of user 7002 is oriented with a palm of hand 7022 facing toward a viewpoint of user 7002. Application user interface 10002 in the viewport is visually emphasized because it is the application that user 7002 mostly recently interacted with prior (e.g., immediately prior) to the user input being detected.

FIG. 10B illustrates an example transition from FIG. 10A. Based on user 7002's palm being oriented toward the viewpoint of user 7002 when long air pinch gesture 10502 by hand 7022 is detected, application switching user interface 9002 is displayed. Graphical representations 9004, 9006, 9008, 9010, and 9012 of respective applications that were recently open on computer system 101 are displayed in application switching user interface 9002.

In some embodiments, representations 9004, 9006, 9008, 9010, 9012 of respective applications are arranged in application switching user interface 9002 based on recency of use. For example, representation 9004 of application user interface 10002 is arranged at the leftmost position in the application switching user interface 9002 because application user interface 10002 is the application user 7002 mostly recently interacted with prior (e.g., immediately prior) to the user input being detected. Computer system 101 visually emphasizes representation 9004 in application switching user interface 9002 while also visually emphasizing (e.g., by highlighting, outlining, increased opacity, increased brightness, and/or other visual emphasis to indicate that the application user interface is active) application user interface 10002 in the viewport because long air pinch gesture 9502 (e.g., illustrated in FIG. 10A) is performed with a first input element such as a hand or a controller and the first input element is directed toward a first location on the application switching user interface 9002 that is associated with representation 9004 of application user interface 10002. In some embodiments, there are more representations of applications displayed on the application switching user interface 9002 than the number of application user interfaces displayed in the viewport. For example, some of the representations of applications correspond to applications that are positioned outside the viewport, and/or some of the representations of applications correspond to immersive applications (e.g., immersive applications that are hidden when not in focus).

Home affordance 9014 is also displayed in application switching user interface 9002. For example, in response to detecting a user input directed toward a location associated with home affordance 9014 on the application switching user interface 9002, computer system 101 displays home menu user interface 7030 in the viewport (e.g., as described in reference to FIGS. 7K, 7M, 9B, 9R, and 9T). In some embodiments, the user input directed toward home affordance 9014 is performed with a first input element such as a hand or a controller, and the user input optionally includes an air pinch gesture that includes a contact (or in some embodiments, a contact sustained for at least a threshold amount of time) between portions of a user's hand, and optionally movement of the first input element so as to be directed toward home affordance 9014.

FIG. 10B also illustrates a user input 10504 that includes hand 7022 performing an air pinch gesture followed by substantially rightward horizontal movement of the air pinch gesture while hand 7022 of user 7002 is oriented with a palm of hand 7022 facing toward the viewpoint of user 7002. In some embodiments, input 10504 is a continuation of input 10502 of FIG. 10A (e.g., the long air pinch gesture of input 10502 is a first (e.g., initial) portion of the input, and the rightward movement of the maintained air pinch gesture of input 10504 is a second (e.g., subsequent) portion of the same input). In some embodiments, input 10504 is a separate input from input 10502 of FIG. 10A (e.g., input 10504 is initiated with a subsequent air pinch gesture (or in some embodiments long air pinch gesture) after the long air pinch gesture of input 10502 is released).

FIG. 10C illustrates an example transition from FIG. 10B. Based on the substantially rightward horizontal movement of input 10504 by hand 7022 being detected while the palm faces toward the viewpoint of user 7002, and in accordance with a determination that the substantially rightward horizontal movement of input 10504 results in the first input element being directed toward a second location on the application switching user interface 9002 associated with representation 9006 of application user interface 10004, computer system 101 visually emphasizes representation 9006 in application switching user interface 9002 while also visually emphasizing (e.g., by highlighting, outlining, increased opacity, increased brightness, and/or other visual emphasis to indicate that the application user interface is active) application user interface 10004 in the viewport. For example, application user interface 10004 is visually emphasized in place (e.g., without changing the location of application user interface 10004) within the viewport. Application user interface 10002 is visually deemphasized (e.g., defocused, displayed with a lower intensity, and/or displayed with a higher translucency) relative to application user interface 10004 in FIG. 10C. In some embodiments, application user interfaces other than the one or more application user interfaces corresponding to an application currently in focus (e.g., other application user interfaces except application user interface 10004 in FIG. 10C, or all other application user interfaces) are visually deemphasized (e.g., defocused, or re more translucent). Application user interfaces 10002, 10004, and 10006 in the viewport illustrated in FIGS. 10A-10D are examples of applications having a respective user interface container (e.g., a window or application in which application and/or system content is displayed) that does not individually occupy substantially all (e.g., more than 90%, more than 95%, or more than 98%) of the viewport (hereinafter also sometimes referred to as “windowed applications”). In some embodiments, windowed applications are displayed at a higher translucency level (e.g., lower opacity) in accordance with a determination that the substantially horizontal movement of input 10504 results in the first input element not being directed toward a location on the application switching user interface 9002 that is associated with the windowed applications. In some embodiments, a windowed application is displayed at a lower translucency level (e.g., higher opacity) in accordance with a determination that the substantially horizontal movement of input 10504 results in the first input element being directed toward a location on the application switching user interface 9002 that is associated with that windowed application.

In some embodiments, in accordance with a determination that the substantially horizontal movement of input 10504 results in the first input element not being directed toward a location on the application switching user interface 9002 that is associated with a recently open immersive application, the recently open immersive application is not displayed (e.g., hidden) in the viewport.

In some embodiments, a direction of movement of input 10504 and/or a magnitude of movement of input 10504 determines which representation on the application switching user interface 9002 toward which the first input element is directed. For example, the rightward horizontal movement of the user input illustrated in FIG. 10B results in application user interface 10004 being visually emphasized (e.g., in accordance with a determination that the movement of input 10504 results in the first input element being directed toward a location corresponding to representation 9006 on the application switching user interface 9002) due to representation 9006 associated with application user interface 10004 being positioned to the right of representation 9004. FIG. 10C also illustrates input 10506 that includes a substantially leftward horizontal movement of a pinch gesture (or in some embodiments of a long air pinch gesture) while hand 7022 of user 7002 is oriented with a palm of hand 7022 facing toward the viewpoint of user 7002. In some embodiments, input 10506 is a continuation of input 10504 of FIG. 10B (e.g., based on the first input element moving during input 10506 in a direction that is different from (e.g., opposite) the direction of movement of the first input element during input 10504). In some embodiments, input 10506 is a separate input from input 10504 of FIG. 10B (e.g., input 10506 is initiated with a subsequent air pinch gesture (or in some embodiments long air pinch gesture) after the air pinch or long air pinch gesture of input 10504 is released).

FIG. 10D illustrates an example transition from FIG. 10C. Based on the substantially leftward horizontal movement of input 10506 by hand 7022 being detected while the palm is facing toward the viewpoint of user 7002, and in accordance with a determination that the substantially leftward horizontal movement of input 10506 results in the first input element being directed toward a location on the application switching user interface 9002 associated with representation 9004, computer system 101 visually emphasizes representation 9004 in application switching user interface 9002 while also visually emphasizing (e.g., by highlighting, outlining, increased opacity, increased brightness, and/or other visual emphasis to indicate that the application user interface is active) the corresponding application user interface 10002 in the viewport (e.g., in place). A magnitude of the leftward movement of input 10506 in FIG. 10C may be the same as a magnitude of the rightward movement of input 10504 in FIG. 10B (e.g., causing the selection of a representation that is offset by one representation in the application switching user interface 9002). In some embodiments, the magnitude of the leftward movement in FIG. 10C may be greater than the magnitude of the rightward movement in FIG. 10B, but computer system 101 stops the visually emphasized focus at the leftmost representation in application switching user interface 9002. Similarly, for a rightward movement having a magnitude that results in the first input element being directed to a location that would be beyond application switching user interface 9002 to the right, computer system 101 stops the visually emphasized focus at the rightmost representation in application switching user interface 9002. Optionally, application switching user interface 9002 persists in the viewport into the three-dimensional environment in accordance with a determination that respective criteria (e.g., one or more time thresholds and/or other criteria) are met. For example, as illustrated in FIG. 10D, application switching user interface 9002 persists in the viewport even after the release of input 10506 in accordance with a determination that input 10502 of FIG. 10A meets respective criteria (e.g., is maintained for at least a first threshold amount of time), and/or in accordance with a determination that a most recent input interacting with application switching user interface 9002 (e.g., input 10506 of FIG. 10C) was detected less than a second threshold amount of time ago (e.g., the first threshold amount of time is optionally the same or different from the second threshold amount of time).

FIG. 10E illustrates another user input 10508 that includes hand 7022 performing a long air pinch gesture while the palm is facing toward the viewpoint of user 7002, and while application switching user interface 9002 is persistently displayed.

FIG. 10F illustrates an example transition from FIG. 10E. Based on the substantially rightward horizontal movement of input 10508 (e.g., a long air pinch and drag gesture analogous to input 10502 of FIG. 10A in combination with input 10504 of FIG. 10B) by hand 7022 being detected while the palm is facing toward the viewpoint of user 7002, and in accordance with a determination that the substantially rightward horizontal movement of input 10508 results in the first input element being directed toward a location on the application switching user interface 9002 associated with representation 9008 of an immersive application, computer system 101 visually emphasizes representation 9008 in application switching user interface 9002 while displaying translucent representation 9050 of the immersive application in the viewport. Translucent representation 9050 is displayed in conjunction with the viewport displayed prior to detecting the horizontal movement of input 10508. Optionally, computer system 101 displays one or more intermediate states prior to displaying translucent representation 9050. For example, visual emphasis of application user interface 10004 associated with representation 9006 is displayed in the viewport as an intermediate state (e.g., analogous to the viewport illustrated in FIG. 10C) prior to displaying translucent representation 8050 because long air pinch gesture 9504 results in the first input element traversing representations of other applications (e.g., representation 9006 of a drawing application) before the first input element is directed at representation 9008. In some embodiments, while moving input 10508 across representations displayed in application switching user interface 9002, applications recently open on computer system 101 are sequentially navigated through (e.g., according to the arrangement of representations in application switching user interface 9002), such that when long air pinch gesture input 10508 results in the first input element being directed toward a location on the application switching user interface 9002 associated with a respective representation, computer system 101 visually emphasizes the application corresponding to the respective representation (hereinafter also sometimes referred to as an application being “in focus”). A magnitude and/or a direction of the movement of input 10508 determines which application user interface is in focus. For example, a magnitude of rightward movement in input 10508 in FIG. 10E is larger than a magnitude of rightward movement in input 10504 in FIG. 10B. As a result, representation 9008, which is positioned further away from representation 9004 in application switching user interface 9002, is selected as illustrated in FIG. 10F, instead of representation 9006, which is positioned closer to representation 9004 in application switching user interface 9002. Similarly, a leftward movement as illustrated in FIG. 10C moves the focus to representation 9004, which is to the left of representation 9006, as illustrated in FIG. 10D.

FIG. 10F illustrates a user input that includes hand 7022 releasing the long air pinch gesture of input 10508 while the first input element is directed toward a location of representation 9008 in the application switching user interface 9002 such that representation 9008 corresponds to a currently selected application, optionally visually emphasized in application switching user interface 9002. FIG. 10G illustrates an example transition from FIG. 10F. Based on (e.g., in response to) the release of input 10508 being detected, while the palm is facing toward the viewpoint of user 7002, computer system 101 displays application user interface 10050 (corresponding to representation 9008) associated with the immersive application as the active application user interface. In some embodiments, an immersive application user interface is an application that is configured so that content from applications distinct from the immersive application user interface ceases to be displayed in the viewport when the immersive application is the active application user interface in the computer system 101. In some embodiments, computer system 101 permits an immersive application to render application content anywhere in the viewport into the three-dimensional environment even though the immersive application may not fill all of the viewport. Such an immersive application may differ from an application that renders application content only within boundaries (e.g., visible boundaries or non-demarcated boundaries) of an application user interface container (e.g., a windowed application user interface).

FIG. 10H illustrates an example transition from FIG. 10G. While application user interface 10050 is displayed, and in response to detecting input 10510 including a long air pinch gesture by hand 7022 while user 7002's palm is oriented toward the viewpoint of user 7002 (e.g., input 10510 being analogous to input 10508 of FIG. 10E), application switching user interface 9002 is displayed. In some embodiments, as illustrated in FIG. 10G, while displaying an immersive application in the viewport, representation 7022′ of hand is not visible, via HMD 7100a, in the three-dimensional environment. In some embodiments, representation 7022′ of hand 7022, or another virtual representation of hand 7022 such as an avatar or other virtual object, is visible in the viewport while computer system 101 displays the immersive application in the viewport. Due to application user interface 10050 of the immersive application being the most recently used application, representation 9008 of the immersive application is displayed in the leftmost portion of application switching user interface 9002, on the left of representation 9004. Representation 9008 is also optionally visually emphasized in application switching user interface 9002. Translucent representation 9050 of the immersive application is displayed in the viewport because the first input element is directed toward a location of representation 9008 in the application switching user interface 9002 (e.g., the immersive application is now in in focus). Translucent representation 9050 is displayed in conjunction with a visually deemphasized version of the viewport displayed prior to the immersive application being selected as the active application user interface (e.g., optionally, the appearance of the viewport in FIG. 10H is the same as the appearance of the viewport in FIG. 10F, in which translucent representation 9050 of the immersive application is displayed over the viewport illustrated in FIG. 10E). Optionally, while the immersive application is the active application user interface in computer system 101, application switching user interface 9002 is not displayed in the viewport even when invoked.

Top view 10101 also shows that in addition to the three application user interfaces 10002, 10004, and 10006 in the viewport, application user interface 10010 is located outside the viewport of user 7002, the extent of the viewport being demarcated by lines 10102. FIG. 10H also illustrates that input 10510 includes a subsequent rightward movement of the long air pinch gesture.

FIG. 10I illustrates an example transition from FIG. 10H. Based on a determination that the substantially rightward horizontal movement of input 10510 results in the first input element (e.g., hand 7022) being directed toward a location on the application switching user interface 9002 associated with representation 9010 of application user interface 10010, and in accordance with a determination that application user interface 10010 associated with representation 9010 is displayed outside the viewport, computer system 101 visually emphasizes representation 9010 in application switching user interface 9002 while also displaying preview 10011 of application user interface 10010 at a default location within the viewport (e.g., a default application launching location, a default application launching location relative to a location where a system user interface (e.g., home menu user interface 7030) would be displayed if invoked in the current viewport). In some embodiments, preview 10011 of application user interface 10010 (FIG. 10I) is visually deemphasized relative to application user interface 10010 when the latter is displayed upon the release of input 10510 (FIG. 10J). In some embodiments, preview 10011 is or includes application user interface 10010 itself (or a visually deemphasized version of application user interface 10010). Top view 10104 shows that application user interface 10010 is positioned within the viewport of user 7002 (e.g., instead of outside the viewport as in FIG. 10H).

FIG. 10J illustrates an example transition from FIG. 10I. FIG. 10J illustrates an end of input 10510 (e.g., based on hand 7022 releasing the long air pinch gesture of input 10510 while application switching user interface 9002 is displayed). Based on the release of input 10510 being detected, while the palm is facing toward the viewpoint of user 7002 and while the first input element is directed toward the location on the application switching user interface 9002 associated with representation 9010 of application user interface 10010, computer system 101 displays application user interface 10010 (e.g., at the default location indicated by preview 10011) as the active application user interface.

As shown in the examples in FIGS. 10A-10J, display generation component 7100a of computer system 101 is a head-mounted display worn on user 7002's head (e.g., what is shown in FIGS. 10A-10J as being visible via display generation component 7100a of computer system 101 corresponds to user 7002's viewport into the environment when wearing the head-mounted display). In some embodiments, content that is visible via a display generation component of computer system 101 is displayed on a touch screen held by user 7002.

Additional descriptions regarding FIGS. 10A-10J are provided below in reference to method 14000 described with respect to FIGS. 14A-14D.

FIGS. 11A-11D are flow diagrams of an exemplary method 11000 for displaying a system user interface based on an air gesture, in accordance with some embodiments. In some embodiments, method 11000 is performed at a computer system (e.g., computer system 101 in FIG. 1A) that is in communication with a display generation component (e.g., display generation component 120 in FIGS. 1A, 3A, and 4, a head-mounted device (HMD), a display, a projector, and/or a touch-screen) and one or more input devices. In some embodiments, the method 11000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 11000 are, optionally, combined and/or the order of some operations is, optionally, changed.

While a view of an environment is visible via the display generation component (e.g., in some circumstances, the first user input further includes movement along a height dimension and/or a width dimension), in response to detecting the first user input (11004) (e.g., air pinch gesture 7500, air gesture 7501, air pinch gesture 7502, or air pinch gesture 7508 by hand 7022, as described herein with reference to FIGS. 7B-7E and 7J-7M): in accordance with a determination that the first user input includes movement (e.g., of an input element such as a hand or controller) in depth relative to a viewpoint of the user and that the first user input is directed to a user interface element that is moveable in depth in the view of the environment (11006), the computer system displays the user interface element at an updated location within the environment that corresponds to the first user input (e.g., the updated location within the environment is selected based on a direction and/or magnitude of the first user input, displaying the user interface element at the updated location includes moving the user interface element based on the movement in depth, where a first amount of movement of first user input in depth moves the user interface element by a first amount in the environment, a second amount of movement of first user input in depth moves the user interface element by a second amount in the environment; the user interface element moves by an amount that is based on an amount (e.g., magnitude) of the amount of movement of the first user input in depth, where a larger amount of movement of the first user input causes a larger amount of change in the movement of the user interface element in the environment and a smaller amount of movement of the first user input causes a smaller amount of movement of the user interface element). For example, as described herein with reference to FIGS. 7C-7D, the air gesture 7501 includes movement in depth, away from a viewpoint of the user, and is directed to auxiliary user interface element 7015 associated with application user interface 7012, and in response the computer system displays application user interface 7012 at a position that is pushed in depth away from the viewpoint of the user.

In response to detecting the first user input (11004), in accordance with a determination that the first user input includes movement (e.g., of an input element such as a hand or controller) in depth relative to the viewpoint of the user that meets first criteria (11008), where the first criteria include a requirement that the first user input is not directed to a user interface element that is moveable in depth in the view of the environment in order for the first criteria to be met, the computer system displays a system user interface in the view of the environment (e.g., without displaying the user interface element at an updated location within the environment that corresponds to the first user input) (e.g., if no system user interface is displayed and an air drag gesture toward a viewpoint of the user is detected, display a system user interface; if a system user interface is displayed and an air drag gesture away from the viewpoint of the user is detected, cease display of the system user interface). For example, as described herein with reference to FIGS. 7D-7F and 7J-7M, air pinch gesture 7502 by hand 7022 includes movement in depth, away from a viewpoint of the user, and is directed to a location in the three-dimensional environment that is not associated with any selectable content or application user interface, and in response the computer system displays multitasking user interface 7018 (FIG. 7F) or home menu user interface 7030 (FIGS. 7K and 7M).

Displaying a system user interface responsive to a first user input that includes movement in depth relative to the viewport of the user and in accordance with a determination that the first input is not directed to a user interface element that is moveable in depth increases the range of inputs supported and thus enables operations to be performed more quickly and intuitively on the computer system and without displaying additional controls.

In some embodiments, the user interface element includes (11010) an application user interface of a first application and an object movement user interface element (e.g., an auxiliary user interface element that is optionally distinct from the application user interface), and determining that the first user input is directed to a user interface element that is moveable in depth includes determining that the first user input selects the object movement user interface element. For example, as described herein with reference to FIGS. 7B-7D, air pinch gesture 7500 and air gesture 7501 by hand 7022 directed to auxiliary user interface element 7015 associated with application user interface 7012 selects application user interface 7012. Selecting an object movement user interface element to move a user interface element allows the movement of the user interface element to be performed more quickly and intuitively on the computer system and provides improved visual feedback regarding the effect of the first user input.

In some embodiments, the movement of the first user input in depth relative to the viewpoint of the user includes (11012) movement (e.g., of an input element such as a hand or controller) in a first depth direction. In some embodiments, while displaying the system user interface, the computer system detects a second user input that includes movement (e.g., of an input element such as a hand or controller) in depth relative to a viewpoint of the user in a second depth direction different from the first depth direction (e.g., opposite the first depth direction); and in response to detecting the second user input, the computer system ceases display of the system user interface (e.g., closing or hiding the system user interface) (e.g., home or a multitasking user interface). In some embodiments, ceasing display of the system user interface in response to detecting the second user input is performed in accordance with a determination that the second user input is not directed to a user interface element that is moveable in depth in the view of the environment, whereas, if the second user input is directed to a respective user interface element that is moveable in depth, the computer system moves the respective user interface element in the environment in depth in response to detecting the second user input (e.g., instead of dismissing the system user interface). For example, as described herein with reference to FIG. 7K, air pinch gesture 7508 includes movement in depth, toward a viewpoint of the user, and is detected while home menu user interface 7030 is displayed in the viewport, and in response the computer system ceases display of home menu user interface 7030. Ceasing display of a system user interface in response to one or more air gestures, and in particular ceasing display of a system user interface responsive to an air pinch gesture that is followed by movement in depth toward a viewpoint of a user increases the range of inputs supported and thus enables operations to be performed more quickly and intuitively on the computer system and without displaying additional controls.

In some embodiments, the computer system detects (11014) a third user input that includes movement (e.g., of an input element such as a hand or controller) in depth away from the viewpoint of the user, and while detecting the third user input, the computer system changes one or more visual characteristics of the system user interface in a first direction (e.g., increasing or decreasing one or more visual characteristics). In some embodiments, the computer system detects an end of the third user input, and in response to detecting the end of the third user input, the computer system changes the one or more visual characteristics of the system user interface in a second direction that is different from the first direction (e.g., increasing or decreasing one or more visual characteristics, and/or at least partially reversing the changing of the one or more visual characteristics of the system user interface). For example, as described herein with reference to FIG. 7M, air pinch gesture 7502 includes movement in depth, away from a viewpoint of the user and is detected while home menu user interface 7030 is displayed in the viewport, and in response the computer system reversibly repositions representations 7112, 7114, 7116, 7118, 7120, 7122, 7124, 7126, 7128 on home menu user interface 7030 in depth, based on air pinch gesture 7502. Providing a visual effect that simulates resistance while an air gesture is detected provides visual feedback to a user that further movement is needed to complete the air gesture, thereby making the user-device interaction more efficient by reducing unintended inputs and the number of inputs needed to complete an operation on the computer system.

In some embodiments, the movement (e.g., of an input element such as a hand or controller) in depth relative to the viewpoint of the user includes (11016) movement away from the viewpoint of the user. In some embodiments, in response to detecting the first user input, the system user interface is displayed in the view of the environment in accordance with a determination that the first user input is not directed to a user interface element that is moveable in depth in the view of the environment and that the movement in depth relative to the viewpoint of the user includes movement away from the viewpoint of the user (e.g., the system user interface is not displayed if the movement in depth relative to the viewpoint of the user does not include movement away from the viewpoint of the user and/or includes movement in another direction relative to the viewpoint of the user). For example, as described herein with reference to FIGS. 7D-7F and 7J-7M, air pinch gesture 7502 includes movement in depth, away from a viewpoint of the user, and is directed to a location in the three-dimensional environment that is not associated with any selectable content or application user interface, in response the computer system displays multitasking user interface 7018 (FIG. 7F) or home menu user interface 7030 (FIGS. 7K and 7M). Detecting movement in depth away from the viewpoint of the user increases the range of inputs supported and thus enables operations to be performed more quickly and intuitively on the computer system and without displaying additional controls.

In some embodiments, the system user interface in the view of the environment includes an arrangement of icons in a home menu user interface (11018). For example, as described herein with reference to FIGS. 7J-7M, air pinch gesture 7502 includes movement in depth, away from a viewpoint of the user, and is directed to a location in the three-dimensional environment that is not associated with any selectable content or application user interface, and in response the computer system displays home menu user interface 7030. Displaying a system user interface that includes an arrangement of icons in a home menu user interface enables a user to perform more operations (e.g., launching an application from an icon within the arrangement of icons) more quickly and intuitively on the computer system.

In some embodiments, the system user interface in the view of the environment includes (11020) a multitasking user interface displaying one or more representations of applications that were recently open on the computer system. For example, as described herein with reference to FIGS. 7D-7F, air pinch gesture 7502 includes movement in depth, away from a viewpoint of the user, and is directed to a location in the three-dimensional environment that is not associated with any selectable content or application user interface, and in response the computer system displays multitasking user interface 7018. Displaying a system user interface that includes a multitasking user interface enables a user to more quickly access other applications that are recently opened on the computer system more quickly and intuitively on the computer system.

In some embodiments, while displaying the multitasking user interface, the computer system detects (11022) a fourth user input. In some embodiments, in response to detecting the fourth user input: in accordance with a determination that the fourth user input is directed to a respective representation of the one or more representations of applications that were recently open on the computer system, and that the fourth user input includes movement (e.g., of an input element such as a hand or controller) in a direction distinct from movement in depth relative to the viewpoint of the user (e.g., second user input includes a hand gesture in which portions of the hand (e.g., index finger and thumb, and/or thumb and another finger) are in contact, and the movement is detected after the portions of the hand are in contact), the computer system terminates an application corresponding to the respective representation. For example, as described herein with reference to FIGS. 7H-7I, air pinch gesture 7506 includes movement in a direction that is different from movement in depth relative to a viewpoint of the user, and air pinch gesture 7506 is directed to a representation of application user interface 7010 in the multitasking user interface 7018; in response, the computer system closes application user interface 7010. Closing an application user interface in response to one or more air gestures, and in particular ceasing display of an application user responsive to an air pinch gesture that is followed by movement at a particular depth increases the range of inputs supported and thus enables operations to be performed more quickly and intuitively on the computer system and without displaying additional controls.

In some embodiments, displaying the multitasking user interface includes (11024) moving (e.g., redisplaying by fading out the representation at an original location and fading in the representation in the multitasking application user interface, and/or animated trajectory of the movement of the representation) the one or more representation of applications from respective locations (e.g., spatially distributed locations) in the environment to respective locations within an arrangement of representations in the multitasking user interface. For example, as described herein with reference to FIGS. 7E-7F, the representations of application user interfaces (e.g., including application user interfaces 7010, 7012, 7024, and 7026) move from spatially distributed locations in the three-dimensional environment, including from peripheral regions of the viewport, toward region 7019 and into an arrangement of representations in multitasking user interface 7018. In another system user interface example, as described herein with reference to FIGS. 7J-7K, the computer system displays representations 7112, 7114, 7116, 7120, 7122, 7126, 7128, and 7130 in a peripheral region of the user's viewpoint prior to displaying the representations 7112, 7114, 7116, 7120, 7122, 7126, 7128, and 7130 on a home menu user interface 7030 in a central portion of the user's viewpoint. Moving applications from spatially distributed locations to a predetermined arrangement provides improved visual feedback to the user (e.g., improved visual feedback regarding the applications that are recently opened on the computer system and that they are being displayed on the multitasking user interface) and thus enables operations to be performed more quickly and intuitively on the computer system.

In some embodiments, moving the one or more representations of applications includes (11026) displaying an animation of a first representation of a first application moving from a first location in the environment to a first location within the arrangement of representations in the multitasking user interface (e.g., in some embodiments, a second representation of a second application moves from a second location in the environment to a second location within the arrangement of representations in the multitasking user interface, and the first application is different from the second application). For example, as described herein with reference to FIGS. 7E-7F, the computer system displays an animation of the representations of application user interfaces (e.g., including application user interfaces 7010, 7012, 7024, and 7026) moving into locations within the arrangement of representations in multitasking user interface 7018. In another system user interface example, as described herein with reference to FIGS. 7J-7K, the computer system displays representations 7112, 7114, 7116, 7120, 7122, 7126, 7128, and 7130 as an animated transition moving from a peripheral region of the user's viewport to representations 7112, 7114, 7116, 7120, 7122, 7126, 7128, and 7130 on home menu user interface 7030 displayed in a central portion of the user's viewpoint. Displaying an animation of one or more representations of applications moving provides improved visual feedback to the user (e.g., improved visual feedback that a multitasking user interface is being displayed, and improved visual feedback regarding the applications that are recently opened on the computer system) and thus enables operations to be performed more quickly and intuitively on the computer system.

In some embodiments, displaying the system user interface in the view of the environment includes (11028): in accordance with a determination that the movement (e.g., of an input element such as a hand or controller) in depth relative to the viewpoint of the user meets first criteria (e.g., a speed threshold and/or a distance threshold), displaying a home menu user interface; and in accordance with a determination that the movement (e.g., of an input element such as a hand or controller) in depth relative to the viewpoint of the user does not meet the first criteria (e.g., sustained contact between the thumb and a different portion of the hand is maintained but without further movement in depth, and/or a pause after the air drag gesture away from the viewpoint of the user), displaying a multitasking user interface. For example, as described herein with reference to FIGS. 7J-7K, air pinch gesture 7502 includes movement in depth away from the viewpoint of the user that is above a threshold velocity vₜₕ and/or above a threshold distance dₜₕ, and/or does not include a pause in the movement, and in response computer system displays home menu user interface 7030. For example, as described herein with reference to FIGS. 7D-7F, air pinch gesture 7502 includes movement in depth away from the viewpoint of the user that is below a threshold velocity vₜₕ and/or below a threshold distance dₜₕ, and/or includes a pause in the movement, and in response the computer system displays multitasking user interface 7018. Disambiguating between displaying a home menu user interface and a multitasking user interface based on characteristics of an air gesture reduces the amount of time needed to perform operations on the computer system, and without displaying additional controls.

In some embodiments, the first input was detected while at least one application is open (11030). In some embodiments, the computer system detects a fifth input that includes movement in depth relative to the viewpoint of the user. In some embodiments, in response to detecting the fifth input: in accordance with a determination that second criteria are met (e.g., second criteria are met when no applications were recently open on the computer system, second criteria are met when there are no currently open applications, no applications operating in a foreground, and/or no open but dormant applications on the computer system, and the second criteria are not met when any application is recently open, and in accordance with a determination that the movement in depth relative to the viewpoint of the user does not meet the first criteria), the computer system displays the home menu user interface. For example, as described herein with reference to FIGS. 7L-7M, air pinch gesture 7502 includes movement in depth away from the viewpoint of the user that is below a threshold velocity vₜₕ, below a threshold distance dₜₕ, and/or includes a pause in the movement, and there was no application recently in use on computer system when the air pinch gesture 7502 is detected; in response, computer system displays home menu user interface 7030. Displaying the home menu user interface in accordance with a determination that second criteria are met reduces the amount of time needed to perform operations on the computer system, and without displaying additional controls.

In some embodiments, while displaying the system user interface, the computer system visually deemphasizes (e.g., by increasing a degree of blurring, reducing a brightness, reducing a saturation, reducing an opacity, and/or reducing a contrast) (11032) a passthrough portion of the environment visible in the view of the environment. For example, as described herein with reference to FIGS. 7F, 7H-7K, and 7M, passthrough portion 7028 of the three-dimensional environment is visually deemphasized while home menu user interface 7030 or multitasking user interface 7018 is displayed in the viewport. Visually deemphasizing a passthrough portion of the environment while displaying a system user interface provides improved visual feedback to the user to direct the user's attention to the system user interface and minimizes distractions from the environment while helping to reduce user mistakes and the amount of time needed to perform operations on the computer system, and without displaying additional controls.

In some embodiments, displaying the system user interface in the view of the environment includes (11034): displaying a first portion of the system user interface at a first time; and displaying a second portion of the system user interface concurrently with displaying the first portion of the system user interface at a second time later than the first time (e.g., the first portion of the system user interface occupies a first portion of the view of the environment, and a second portion of the system user interface occupies a second portion of the view of the environment distinct from the first portion of the view of the environment, and the first portion of the system user interface and the second portion of the system user interface jointly cover a larger portion of the system user interface compared to the first portion of the system user interface so that the system user interface is gradually displayed in response to the first input). In some embodiments, the computer system, in accordance with the determination that the first user input includes movement in depth relative to the viewpoint of the user and that the first user input is not directed to a user interface element that is moveable in depth in the view of the environment, progresses through display of one or more intermediate states prior to displaying the system user interface. In some embodiments, displaying the first portion of the system user interface corresponds to displaying a first intermediate state, and displaying the second portion of the system user interface concurrently with displaying the first portion of the system user interface corresponds to displaying a second intermediate state that corresponds to further progress toward display of the system user interface. For example, as described herein with reference to FIGS. 7D-7F and FIGS. 7J-7K, air pinch gesture 7502 includes movement in depth, away from a viewpoint of the user, and in response the computer system gradually displays multitasking user interface 7018 (FIG. 7F) or home menu user interface 7030 (FIG. 7K). Gradually displaying a system user interface in response to the first user input provides improved visual feedback to the user regarding the effect of the first user input and helps to reduce user mistakes and the amount of time needed to perform operations on the computer system, and without displaying additional controls.

In some embodiments, the first criteria include (11036) a requirement that the first user input includes more than a threshold amount of movement in depth relative to the viewpoint of the user in order for the first criteria to be met. In some embodiments, in response to detecting the first user input: in accordance with a determination that the first user input includes movement (e.g., of an input element such as a hand or controller) in depth relative to the viewpoint of the user and that the first user input is not directed to a user interface element that is moveable in depth in the view of the environment, the computer system: displays a portion of a system user interface (e.g., the same system user interface as the one displayed in response to the first user input, a different system user interface as the one displayed in response to the first user input); while displaying the portion of the system user interface, detects a termination of the first user input before the first criteria are met; and, in response to detecting the termination of the first user input, ceases to display the portion of the system user interface (e.g., without displaying any additional portions of the system user interface). For example, as described herein with reference to FIGS. 7G and 7J, if air pinch gesture 7502 is released during an animated transition of displaying multitasking user interface 7018 (FIG. 7E) or home menu user interface 7030 (FIG. 7J), in response the computer system ceases display of the animated transition. Allowing a user to cancel by terminating an air gesture before a system user interface is fully displayed by ending the air gesture before getting to a threshold helps to reduce user mistakes and the amount of time needed to perform operations on the computer system, and without displaying additional controls.

In some embodiments, in response to detecting the first user input: in accordance with a determination that the first user input includes movement (e.g., of an input element such as a hand or controller) in a direction other than movement in depth relative to the viewpoint of the user (e.g., first user input does not include movement in depth relative to the viewpoint of the user, the first user input includes movement in depth that is not more than 10% from an initial depth at the start of the first user input) and the first user input is directed to a content element in the view of the environment (11038), the computer system scrolls (e.g., pans) the content element based on the first user input (e.g., horizontally and/or vertically). For example, as described herein with reference to FIGS. 7C-7D, in some circumstances in which air pinch gesture 7501 includes movement other than movement in depth relative to the viewpoint of user 7002, the computer system scrolls content in application user interface 7012 instead of moving application user interface 7012 in depth relative to the viewpoint of user 7002. In another example, as described herein with reference to FIGS. 7H-7I, in some circumstances in which air pinch gesture 7506 includes upward movement, the computer system scrolls the representations of application user interfaces in multitasking user interface 7018 to display a different set of representations of application user interfaces than the representations of application user interface 7012, application user interface 7010, application user interface 7024, and application user interface 7026 in response. Scrolling through content responsive to a first user input that includes movement other than movement in depth relative to a viewpoint of the user increases the range of inputs supported and thus enables operations to be performed more quickly and intuitively on the computer system and without displaying additional controls.

In some embodiments, in response to detecting the first user input: in accordance with a determination that the first user input does not include movement (e.g., of an input element such as a hand or controller) (e.g., no movement after portions of the hand are in contact, not more than a threshold amount of movement in depth, not more than 10% from an initial position at the start of the first user input) (11040), the computer system selects the user interface element. For example, as described herein with reference to FIGS. 7B-7C, air pinch gesture 7500 is performed without movement, and is directed to application user interface 7012, and in response the computer system selects application user interface 7012. Disambiguating between selecting a user interface element or displaying a system user interface based on whether the first user input includes movement increases the range of inputs supported and thus enables operations to be performed more quickly and intuitively on the computer system and without displaying additional controls.

In some embodiments, aspects/operations of methods 12000, 13000, and/or 14000 may be interchanged, substituted, and/or added between these methods. For example, the method of displaying a multitasking user interface within a three-dimensional environment as described with reference method 11000 is optionally used to display a multitasking user interface while an application user interface is displaying application at different hierarchy levels in method 12000, or optionally a multitasking user interface may be invoked using gestures described in method 13000. For brevity, these details are not repeated here.

FIGS. 12A-12B are flow diagrams of an exemplary method 12000 navigating content of different hierarchy levels in an application, in accordance with some embodiments. In some embodiments, method 12000 is performed at a computer system (e.g., computer system 101 in FIG. 1A) that is in communication with a display generation component (e.g., display generation component 120 in FIGS. 1A, 3A, and 4) (e.g., a head-mounted device (HMD), a display, a projector, and/or a touch-screen) and one or more input devices. In some embodiments, the method 12000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 12000 are, optionally, combined and/or the order of some operations is, optionally, changed.

While a view of an environment (e.g., a two-dimensional user interface or a three-dimensional environment) is visible via the display generation component, the computer system displays (12002) an application user interface that includes content associated with a first hierarchy level of a plurality of hierarchy levels in the application (e.g., application user interface 8002 organizes media content hierarchically, including a lower level of hierarchy that arranges and displays media content within an album (FIGS. 8A-8C)). In some embodiments, different hierarchy levels correspond to different groups of elements (e.g., in a music application, a higher hierarchy level includes a listing of different artists, a next (e.g., lower) hierarchy level includes a listing of albums associated with each of the different artists or with one or more respective artists selected from the different artists, and a subsequent (e.g., lower than the listing of albums) hierarchy level includes a listing of songs for each album of the listing of albums or for one or more respective albums). In some embodiments, different hierarchy levels correspond to different levels of details; for example, the highest hierarchy level includes a listing of different sections of a news site, a next (e.g., lower) hierarchy level includes a listing of headlines associated with one or more sections, and a subsequent (e.g., lower than the listing of headlines) hierarchy level includes the article(s) associated with one or more respective headlines) (e.g., in a web browser, news application, or other application).

While displaying the application user interface, the computer system detects (12004) a first user input (e.g., a touch gesture or an air gesture) (e.g., air pinch gesture 8501, and air pinch gesture 8504-1, as described herein with reference to FIGS. 8B-8D). In response to detecting the first user input (12006), and in accordance with a determination that the first user input includes movement in depth relative to a viewpoint of a user that meets a first set of one or more criteria, the computer system displays content associated with a respective hierarchy level that was displayed prior to displaying the content associated with the first hierarchy level (e.g., the content of the second hierarchy level includes content previously displayed in the application user interface). In some embodiments, the first hierarchy level includes a user interface element activatable to display content associated with a third hierarchy level that is different from the first hierarchy level and from the second hierarchy level (e.g., lower than the first and second hierarchy levels), where the third level of content provides more details associated with the user interface element). In some embodiments, the content associated with the third hierarchy level has not yet been displayed in the application user interface. For example, as described herein with reference to FIGS. 8C and 8E, computer system displays (e.g., or redisplays) album B (FIG. 8E) in response to detecting air pinch gesture 8504-1 in FIG. 8C (e.g., an air pinch-and-pull gesture). Album B is at a higher hierarchy level compared to the hierarchy level associated with content item IMG-4, and representations of various content items within album B were displayed (FIG. 8B) prior to content item IMG-4 being displayed (FIG. 8C).

Displaying content associated with a respective hierarchy level that was displayed prior to displaying the content associated with the first hierarchy level responsive to an air pinch gesture that is followed by movement in depth relative to a viewpoint of a user increases the range of inputs supported and thus enables operations to be performed more quickly and intuitively on the computer system and without displaying additional controls.

In some embodiments, the content associated with the respective hierarchy level (e.g., that was displayed prior to displaying the content associated with the first hierarchy level) is displayed (12008) in accordance with a determination that the first user input includes movement in depth toward the viewpoint of the user (e.g., in addition to the determination that the first user input includes movement in depth). For example, air pinch gesture 8504-1 in FIG. 8C includes movement in depth, toward a viewpoint of the user (e.g., an air pinch-and-pull gesture), and in response the computer system displays album B (FIG. 8E), which is at a higher hierarchy level compared to the hierarchy level associated with content item IMG-4. Displaying content associated the respective hierarchy level responsive to an air pinch gesture that is followed by movement in depth toward the viewpoint of a user increases the range of inputs supported and thus enables operations to be performed more quickly and intuitively on the computer system and without displaying additional controls.

In some embodiments, in response to detecting the first user input: in accordance with a determination that the first user input includes movement in depth away from the viewpoint of the user (e.g., the first user input is directed to a user interface element associated with the first hierarchy level that is activatable to display content associated with a third hierarchy level different from the first and second hierarchy levels) (12010), the computer system displays content associated with a third hierarchy level that is different from the first hierarchy level and the respective hierarchy level that was displayed prior to displaying the content associated with the first hierarchy level. In some embodiments, the content associated with the third hierarchy level includes content that was not displayed in the application user interface prior to detecting the first user input and is displayed in response to detection of the first user input directed at the user interface element. In some embodiments, the content associated with the third hierarchy level that is displayed is content that is to be displayed by default in response to an input (e.g., the first user input with movement in depth away from the viewpoint of the user) corresponding to a request to navigate from the first hierarchy level to a next (e.g., lower) hierarchy level. In some embodiments, the content associated with the third hierarchy level that is displayed is the only content associated with the third hierarchy level that is reachable when navigating to a next or lower hierarchy level from the displayed content associated with the first hierarchy level (e.g., if the displayed content associated with the first hierarchy level includes a single album, the resulting displayed content associated with the third hierarchy level includes the song(s) included in the single album). For example, air pinch gesture 8505-1 in FIG. 8E includes movement in depth, away from a viewpoint of the user (e.g., an air pinch-and-push gesture), and in response the computer system displays content item IMG-4 (FIG. 8F), which is at a lower hierarchy level compared to the hierarchy level associated with album B (FIG. 8E), and which was previously displayed (FIG. 8C). Displaying content associated with a third hierarchy level that is different from the first hierarchy level and the respective hierarchy level that was displayed prior to displaying the content associated with the first hierarchy level responsive to an air pinch gesture that is followed by movement in depth away from a viewpoint of a user increases the range of inputs supported and thus enables operations to be performed more quickly and intuitively on the computer system and without displaying additional controls.

In some embodiments, in response to detecting the first user input: in accordance with a determination that the first user input includes movement (e.g., of an input element such as a hand or controller) along a direction distinct from movement in depth (e.g., a vertical or horizontal direction) (12012), the computer system sequentially displays (e.g., scrolls) a plurality of content items associated with the first hierarchy level (e.g., scrolling through a listing of artists, albums, songs, sections of a newspapers, headlines of a particular section, articles of respective headlines, thumbnails of images, or other media files) based on the movement (e.g., of an input element such as a hand or controller) of the first user input (e.g., scrolling through the plurality of content items). For example, as described herein with reference to FIGS. 8J-8K, air pinch gesture 8506 includes upward movement, and in response the computer system scrolls representations of content items in album B to reveal additional content items IMG-10 to IMG-15. Scrolling through content in a particular level of the hierarchy based on the movement of the first user input increases the range of inputs supported and thus enables operations to be performed more quickly and intuitively on the computer system and without displaying additional controls.

In some embodiments, displaying content associated with the respective hierarchy level that was displayed prior to displaying the content associated with the first hierarchy level includes (12014): while the first user input is being detected: displaying a first portion of the content associated with the respective hierarchy level at a first time; and additionally displaying a second portion of the content associated with the respective hierarchy concurrently with the first portion at a second time later than the first time. For example, as described herein with reference to FIGS. 8C-8E, air pinch gesture 8504-1 includes movement in depth, towards a viewpoint of the user, and in response the computer system gradually displays (e.g., by transitioning through the intermediate state in FIG. 8D) content items within album B, which correspond to content associated with a higher hierarchy level. Displaying a gradual transition while movement of an air gesture is detected provides improved visual feedback regarding the effect of the air gesture, helps to reduce user mistakes and the amount of time needed to perform operations on the computer system, and without displaying additional controls.

In some embodiments, the first set of one or more criteria include (12016) a requirement that the first user input includes more than a threshold amount of movement in depth relative to the viewpoint of the user in order for the first set of one or more criteria to be met. In some embodiments, in response to detecting the first user input: in accordance with a determination that the first user input includes movement (e.g., of an input element such as a hand or controller) in depth relative to the viewpoint of the user, and while the first user input is being detected: while displaying a portion of the content associated with the respective hierarchy level (e.g., displaying a portion of respective content includes displaying an indication of respective content), the computer system detects a termination of the first user input (e.g., while displaying the portion of the respective content associated with the respective hierarchy level) before the first set of one or more criteria are met; and in response to detecting the termination of the first user input: the computer system ceases to display the portion of the content associated with the respective hierarchy level, and displays the application user interface that includes the content associated with the first hierarchy level. In some embodiments, displaying the content associated with the respective hierarchy level that was displayed prior to displaying the content associated with the first hierarchy level, in response to detecting the first user input and in accordance with the determination that the first user input includes movement in depth relative to the viewpoint of the user, is performed in accordance with a determination that the first user input meets the first set of one or more criteria (e.g., termination of the first user input is detected while the first set of one or more criteria are met). For example, as described herein with reference to FIGS. 8C and 8D, if the air pinch gesture 8504-1 is released during an animated transition of displaying content items in album B, the computer system ceases display of the animated transition and redisplays content item IMG-4 in response. Providing an option to a user to cancel by ending the air gesture before getting to a threshold helps to reduce user mistakes and the amount of time needed to perform operations on the computer system, and without displaying additional controls.

In some embodiments, displaying the content associated with a respective hierarchy level that was displayed prior to displaying the content associated with the first hierarchy level includes (12018): in accordance with a determination that the user's attention is directed toward a first application displaying content associated with a first hierarchy level of the first application, displaying content of the first application associated with a respective hierarchy level that was displayed prior to displaying the content associated with the first hierarchy level of the first application; and in accordance with a determination that the user's attention is directed toward a second application displaying content associated with a first hierarchy level of the second application, displaying content of the second application associated with a respective hierarchy level that was displayed prior to displaying the content associated with the first hierarchy level of the second application. For example, as described herein with reference to FIGS. 8H-8I, air pinch gesture 8504-3 includes movement in depth, toward a viewpoint of the user, and is directed to application user interface 8004 instead of application user interface 8002 (as was the case in FIGS. 8C-8E and 8G), in response the computer system undoes the most recently added user content in application user interface 8004. Navigating backward in a respective application user interface based on where a user's attention is directed toward and in response to one or more air gestures and in particular navigating backward in a respective application user interface based on where a user's attention is directed to and responsive to an air pinch gesture that is followed by movement in depth toward a viewpoint of a user increases the range of inputs supported and thus enables operations to be performed more quickly and intuitively on the computer system and without displaying additional controls.

In some embodiments, displaying the content associated with the first hierarchy level includes (12020) displaying a user interface object (e.g., a modal user interface object) that requires the user's input and/or attention in order to be dismissed from the environment (e.g., a separate and/or windowed application user interface from the application user interface) in the view of the environment (e.g., the additional application user interface displays a prompt for requesting user input or confirmation). For example, as described herein with reference to FIGS. 8F-8H, air pinch gesture 8505-2 includes movement in depth, away from a viewpoint of the user, and is detected while content item IMG-4 is displayed in the viewport. In response, the computer system displays modal user interface object 8030, which is at a lower hierarchy level than the content item IMG-4. A subsequent air pinch gesture 8504-2 includes movement in depth, towards a viewpoint of the user, and is detected while modal user interface object 8030 is displayed in the viewport. In response, the computer system ceases display of modal user interface object 8030. Displaying a modal user interface object that is responsive to a user's air gesture provides improved visual feedback to the user (e.g., improved visual feedback that the modal user interface object is being displayed, and improved visual feedback regarding content associated with the first hierarchy level and the modal user interface object) and increases the range of inputs supported and thus enables operations to be performed more quickly and intuitively on the computer system.

In some embodiments, while displaying a multitasking user interface in the view of the environment that includes displaying one or more representations of applications that were recently open (e.g., open within a threshold amount of time or open in the same use session, or the most recently open applications of applications used) on the computer system, the computer system detects (12022) a second user input (e.g., a touch gesture or an air gesture); and in response to detecting the second user input, and in accordance with a determination that the first user input includes movement in depth toward the viewpoint of the user, the computer system ceases display of the multitasking user interface. For example, as described herein with reference to FIGS. 8L and 8M, air pinch gesture 8504-4 includes movement in depth, toward a viewpoint of the user, and is detected while multitasking user interface 7018 is displayed in the viewport. In response, the computer system ceases display of multitasking user interface 7018. Ceasing display of a multitasking user interface in response to one or more air gestures, and in particular ceasing display of a multitasking user interface responsive to an air pinch gesture that is followed by movement in depth toward a viewpoint of a user increases the range of inputs supported and thus enables operations to be performed more quickly and intuitively on the computer system and without displaying additional controls.

In some embodiments, aspects/operations of methods 11000, 13000, and/or 14000 may be interchanged, substituted, and/or added between these methods. For example, the method of navigating between hierarchy levels of an application user interface within a three-dimensional environment, including dismissing a modal user interface object as described with reference method 12000 is optionally used to dismiss a system user interface in method 11000, or optionally a system user interface may be dismissed using gestures described in method 13000. For brevity, these details are not repeated here.

FIGS. 13A-13D are flow diagrams of an exemplary method 13000 performing a system operation based on the detection of a gesture, in accordance with some embodiments. In some embodiments, method 13000 is performed at a computer system (e.g., computer system 101 in FIG. 1A) that is in communication with a display generation component (e.g., display generation component 120 in FIGS. 1A, 3A, and 4) (e.g., a head-mounted device (HMD), a display, a projector, and/or a touch-screen) and one or more input devices. In some embodiments, the method 13000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 13000 are, optionally, combined and/or the order of some operations is, optionally, changed.

While a view of an environment (e.g., a two-dimensional user interface or a three-dimensional environment) is visible via the display generation component, the computer system detects (13002) a first user input (e.g., a touch gesture or an air gesture) (e.g., air pinch gesture 9500 or air pinch gesture 9501, as described herein with reference to FIGS. 9A-9E).

In response to detecting the first user input (13004): in accordance with a determination that the first user input is performed while a hand of a user is oriented with a palm of the hand facing toward a viewpoint of the user (13006), the computer system performs a system operation that includes displaying, in the environment, multiple representations of applications (e.g., the multiple representations include affordances, or icons, associated with launching respective applications, the multiple representations includes a representation of recent content from one or more applications currently opened on the computer system in a multitasking UI) (e.g., independently of where the user's attention is directed, such as by performing the same system operation whether the user's attention is directed toward a first location or to a different, second location in the environment). In some embodiments, more generally, the system operation including displaying multiple representations of applications is performed in accordance with a determination that the hand of the user is oriented in a first direction (e.g., toward a viewpoint of the user, away from a viewpoint of the user to the left, to the right, or other direction). In some embodiments, the hand is determined to be facing toward a viewpoint of the user when at least a threshold area or portion of the palm is detected by the one or more input devices as facing toward a viewpoint of the user. In some embodiments, the first user input is performed using the hand of the user. In some embodiments, the first user input is performed using another portion of the user's body or input device, in addition to the hand of the user. For example, as described herein with reference to FIG. 9A, air pinch gesture 9500-1 is performed while hand 7022 of the user is oriented with a palm of hand 7022 facing toward a viewpoint of the user 7002. In response, in accordance with a determination that no home menu user interface 7030 is displayed in the viewport (FIG. 9A), the computer system displays home menu user interface 7030 (FIG. 9B). In another example, as described herein with reference to FIG. 9C, air pinch gesture 9500-3 is performed while hand 7022 of the user is oriented with a palm of hand 7022 facing toward a viewpoint of the user 7002. In response, in accordance with a determination that no multitasking user interface 7018 is displayed in the viewport (FIG. 9C), the computer system displays multitasking user interface 7018 (FIG. 9D).

In response to detecting the first user input (13004): in accordance with a determination that the first user input is performed while the hand of the user is oriented with the palm of the hand facing away from the viewpoint of the user (e.g., the hand is determined to be facing away from the viewpoint of the user when less than a threshold area or portion of the palm is detected by the one or more input devices and/or at least a threshold area or portion of the back of the user's hand is detected as facing toward from the viewpoint of the user) (13008), the computer system performs an operation associated with a location in the environment toward which the user's attention is directed (e.g., when the first user input is detected, activating a user interface element, a link or an application associated with the user interface element at the location in the environment toward which the user's attention is directed). In some embodiments, more generally, the operation associated with the location toward which the user's attention is directed is performed in accordance with a determination that the hand of the user is oriented in a second direction different from the first direction, and optionally opposite the first direction (e.g., downwards when the first direction is upwards). For example, as described herein with reference to FIGS. 9E-9F, air pinch gesture 9501 is performed while hand 7022 of the user is oriented with a palm of hand 7022 facing away from a viewpoint of the user 7002. In response, the computer system selects a user interface object, IMG-2, to which the user's attention is directed.

Disambiguating between displaying a system user interface or performing an operation associated with attention of the user based on an orientation of the user's palm increases the range of inputs supported and thus enables operations to be performed more quickly and intuitively on the computer system and without displaying additional controls.

In some embodiments, performing a system operation that includes displaying, in the environment, multiple representations of applications (e.g., in accordance with the determination that the first user input is performed while the hand of the user is oriented with the palm of the hand facing toward the viewpoint of the user) includes (13010): in accordance with a determination that the first user input includes an air pinch gesture while a hand of a user is oriented with a palm of the hand facing toward a viewpoint of the user (e.g., with two or more fingers making contact, such as a thumb finger of the user making contact with a different portion of the hand, including release of the pinch gesture) and that a home menu user interface is not currently displayed in the view of the environment, displaying the home menu user interface; and in accordance with a determination that the first user input includes an air pinch gesture while a hand of a user is oriented with a palm of the hand facing toward a viewpoint of the user and that the home menu user interface is currently displayed in the view of the environment, ceasing display of the home menu user interface. For example, as described herein with reference to FIGS. 9A-9C, air pinch gesture 9500-1 is performed while hand 7022 of the user is oriented with a palm of hand 7022 facing toward a viewpoint of the user 7002. In response, in accordance with a determination that no home menu user interface 7030 is displayed in the viewport (FIG. 9A), the computer system displays home menu user interface 7030 (FIG. 9B). Air pinch gesture 9500-2 in FIG. 9B is performed while hand 7022 of the user is oriented with a palm of hand 7022 facing toward a viewpoint of the user 7002. In response, in accordance with a determination that the home menu user interface 7030 is displayed in the viewport (FIG. 9B), the computer system ceases display of home menu user interface 7030 (FIG. 9C). Allowing a single air gesture to trigger display of a home menu user interface allows a user to quickly access and navigate a collection of applications or content regardless of whatever operation (e.g., while a first application is running) is in progress, without displaying additional controls, minimizing the number of inputs required to select a desired operation, improving performance and operational efficiency of the computer system. Allowing the same air gesture to cease display of the home menu user interface allows a user to quickly resume interacting with a desired application or content in the computer system, without displaying additional controls, minimizing the number of inputs required to select a desired operation, improving performance and operational efficiency of the computer system.

In some embodiments, performing an operation associated with a location in the environment toward which the user's attention is directed (e.g., in accordance with the determination that the first user input is performed while the hand of the user is oriented with the palm of the hand facing away from the viewpoint of the user) includes (13012): in accordance with a determination that the first user input includes an air pinch gesture while a hand of a user is oriented with a palm of the hand facing away from a viewpoint of the user, selecting content associated with the location in the environment toward which the user's attention is directed. For example, as described herein with reference to FIGS. 9E-9F, air pinch gesture 9501 is performed while hand 7022 of the user is oriented with a palm of hand 7022 facing away from a viewpoint of the user 7002, and in response the computer system selects a user interface object, IMG-2, to which air pinch gesture 9501 is directed (e.g., based on where user 7002's gaze is directed). Disambiguating between displaying a system user interface or performing an operation associated with attention of the user based on an orientation of the user's palm increases the range of inputs supported and thus enables operations to be performed more quickly and intuitively on the computer system and without displaying additional controls.

In some embodiments, performing a system operation that includes displaying, in the environment, multiple representations of applications includes (13014): in accordance with a determination that the first user input includes a long air pinch gesture while a hand of a user is oriented with a palm of the hand facing toward a viewpoint of the user, displaying an application switching user interface that includes representations of respective applications that were recently open (e.g., open within a threshold amount of time or open in the same use session, or the most recently open applications of applications used, currently open, operating in a foreground, operating in the background, or including open but dormant applications) on the computer system. For example, as described herein with reference to FIGS. 9F-9G, long air pinch gesture 9502 is performed while hand 7022 of the user is oriented with a palm of hand 7022 facing toward a viewpoint of the user 7002, and in response the computer system displays an application switching user interface 9002, as also described in method 14000. Displaying an application switching user interface in response to a long air pinch gesture and based on an orientation of the user's palm increases the range of inputs supported and thus enables operations to be performed more quickly and intuitively on the computer system and without displaying additional controls.

In some embodiments, performing the operation associated with the location in the environment toward which the user's attention is directed includes (13016): in accordance with a determination that the first user input includes a long air pinch gesture while a hand of a user is oriented with a palm of the hand facing away from a viewpoint of the user, starting to move (e.g., the first user input includes movement while the sustained contact is maintained) at least a portion of a content element (e.g., an image, and/or a map) positioned at the location in the environment (e.g., dragging or panning) relative to the environment (e.g., to allow a different portion of the content element to be displayed at the location in the environment). For example, as described herein with reference to FIGS. 9H-9I, air pinch gesture 9506 is performed while hand 7022 of the user is oriented with a palm of hand 7022 facing away from a viewpoint of the user 7002, and includes vertical movement of air pinch gesture 9506. In response, the computer system moves a portion of media content item IMG-2 (e.g., by dragging or panning) relative to the three-dimensional environment (e.g., to allow a different portion of the content element to be displayed). Starting to move at least a portion of a content element positioned at a location in the environment toward which the user's attention is directed in response to a long air pinch gesture and based on an orientation of the user's palm increases the range of inputs supported and thus enables operations to be performed more quickly and intuitively on the computer system and without displaying additional controls.

In some embodiments, performing the operation associated with the location in the environment toward which the user's attention is directed includes (13018): in accordance with a determination that the first user input includes an air pinch and drag gesture while a hand of a user is oriented with a palm of the hand facing away from a viewpoint of the user, scrolling one or more content elements (e.g., a web page, a document, and/or a collection of media items such as photos, videos, or music) positioned at the location in the environment. For example, as described herein with reference to FIGS. 9J-9K, air pinch gesture 9508 is performed while hand 7022 of the user is oriented with a palm of hand 7022 facing away from a viewpoint of the user 7002, and includes vertical movement of air pinch gesture 9508. In response, the computer system scrolls the content items displayed in portion 8024 of application user interface 8002 to reveal additional previews of content items beyond IMG-9, such as IMG-10, IMG-11, IMG-12, IMG-13, IMG-14, and IMG-15, that are in the same album as the previews of content items IMG-1 to IMG-9. Scrolling one or more content elements positioned at a location in the environment toward which the user's attention is directed in response to a pinch and drag gesture and based on an orientation of the user's palm increases the range of inputs supported and thus enables operations to be performed more quickly and intuitively on the computer system and without displaying additional controls.

In some embodiments, performing the operation associated with the location in the environment toward which the user's attention is directed includes (13020): in accordance with a determination that the first user input includes an air pinch and drag gesture (or in some embodiments, a long air pinch and drag) while a hand of a user is oriented with a palm of the hand facing away from a viewpoint of the user, repositioning a user interface element (e.g., a content element, and/or a windowed application) corresponding to the location in the environment toward which the user's attention is directed from a first element location in the environment to a second element location (e.g., different from the first element location) in the environment (e.g., by dragging the user interface element from the location and dropping the user interface element at the updated location upon terminating the sustained contact) based on movement of the first user input. For example, as described herein with reference to FIGS. 9L-9M, long air pinch gesture 7512 is performed while hand 7022 of the user is oriented with a palm of hand 7022 facing away from a viewpoint of the user 7002, and includes movement of long air pinch gesture 7512. In response, the computer system displays IMG-7 as being lifted from its prior position within the arrangement of content items in application user interface 8002 (FIG. 9L) that is subsequently dropped to an updated position within the arrangement of content items (FIG. 9M). Repositioning a user interface element corresponding to the location in the environment toward which the user's attention is directed in response to a pinch and drag gesture and based on an orientation of the user's palm increases the range of inputs supported and thus enables operations to be performed more quickly and intuitively on the computer system and without displaying additional controls.

In some embodiments, the first user input is performed (13022) while the hand of the user is oriented with the palm of the hand facing toward the viewpoint of the user (e.g., performed with a first input element such as a hand or controller, the first user input is an air pinch gesture that includes a sustained contact between portions of a user's hand) and while a user interface of a first application is displayed (e.g., and has focus for user input). In some embodiments, in response to detecting the first user input, the computer system displays an application switching user interface (e.g., concurrently with the application user interface); and while displaying the application switching user interface, the computer system detects a second input that includes movement of a first input element (e.g., movement of a hand of a user performing the first user input) for selecting an active application user interface from the application switching user interface. In some embodiments, in response to detecting the second input: in accordance with a determination that the first input element is directed toward a first location (e.g., when the second input is detected), the computer system displays a first application user interface corresponding to the first location as the active application user interface (e.g., the first location having an associated representation of a first application that corresponds to the first application user interface); and in accordance with a determination that the first input element is directed toward a second location (e.g., has been moved to a location corresponding to the second location or has been moved by an amount and/or in a direction that has moved focus to the second location) (e.g., when the second input is detected) on the application switching user interface, the computer system displays a second application user interface corresponding to the second location as the active application user interface. The second location is different from the first location (e.g., the first input includes movement that terminates at a location corresponding to the second location on the application switching user interface). The second application user interface is different from the first application user interface (e.g., the second location having an associated representation of a second application that corresponds to the second application user interface). For example, as described herein with reference to FIGS. 9N and 9O, while application switching user interface 9002 is displayed, in response to detecting long air pinch gesture 9504 performed while hand 7022 of the user is oriented with a palm of hand 7022 facing toward a viewpoint of the user 7002 and that includes movement of long air pinch gesture 9504, which results in a first input element (e.g., a hand or a controller) being directed toward a location on application switching user interface 9002 associated with representation 9008, computer system 101 visually emphasizes representation 9008 associated with an immersive application in application switching user interface 9002 while displaying translucent representation 9050 of the immersive application in the viewport. Displaying a respective application user interface as the selected active application user interface in accordance with a determination that a first input element is directed toward a location in an application switching user interface that corresponds to the respective application user interface increases the range of inputs supported and thus enables operations to be performed more quickly and intuitively on the computer system and without displaying additional controls.

In some embodiments, performing a system operation that includes displaying, in the environment, multiple representations of applications includes (13024): in accordance with a determination that the first input includes a double air pinch gesture comprising two (e.g., or more) pinch inputs (e.g., performed by the same hand) while a hand of a user is oriented with a palm of the hand facing toward a viewpoint of the user, where the double air pinch gesture includes a first air pinch input (e.g., a pinch input or a long air pinch input), a release of the first air pinch input (e.g., breaks contact between the two or more fingers), and a second air pinch input within a threshold time period (e.g., 0.05, 0.1, 0.2, 0.5, 1, or 2 seconds) after releasing the first air pinch input, displaying, in the environment, a control center user interface (e.g., a system function menu). For example, as described herein with reference to FIGS. 9P and 9Q, double air pinch gesture 9510-1 is performed while hand 7022 of the user is oriented with a palm of hand 7022 facing toward a viewpoint of the user 7002. In response, the computer system displays control center user interface 8052 (FIG. 9Q). Displaying a control center user interface in response to a double air pinch gesture and based on an orientation of the user's palm increases the range of inputs supported and thus enables operations to be performed more quickly and intuitively on the computer system and without displaying additional controls.

In some embodiments, performing a system operation that includes displaying, in the environment, multiple representations of applications includes (13026): in accordance with a determination that the first user input includes a double air pinch gesture comprising two (e.g., or more) air pinch inputs (e.g., performed by the same hand) while a hand of a user is oriented with a palm of the hand facing toward a viewpoint of the user, where the double air pinch gesture includes a first air pinch input (e.g., a pinch input or a long air pinch input), a release of the first air pinch input (e.g., breaks contact between the two or more fingers), and a second air pinch input within a threshold time period (e.g., 0.05, 0.1, 0.2, 0.5, 1, or 2 seconds) after releasing the first air pinch input and that a home menu user interface is not currently displayed in the environment, displaying the home menu user interface; and in accordance with a determination that the first user input includes a double air pinch gesture comprising two (e.g., or more) air pinch inputs (e.g., performed by the same hand) while a hand of a user is oriented with a palm of the hand facing toward a viewpoint of the user, and that the home menu user interface is currently displayed in the environment, ceasing display of the home menu user interface. For example, as described herein with reference to FIGS. 9P, 9R, and 9S, double air pinch gesture 9510 is performed while hand 7022 of the user is oriented with a palm of hand 7022 facing toward a viewpoint of the user 7002. In accordance with a determination that no home menu user interface 7030 is displayed in the viewport (FIG. 9P), the computer system displays home menu user interface 7030 (FIG. 9R), whereas in accordance with a determination that the home menu user interface 7030 is displayed in the viewport (FIG. 9R), the computer system ceases display of home menu user interface 7030 (FIG. 9S). Displaying or ceasing to display a home menu user interface in response to a double air pinch gesture and based on an orientation of the user's palm increases the range of inputs supported and thus enables operations to be performed more quickly and intuitively on the computer system and without displaying additional controls.

In some embodiments, performing the operation associated with the location in the environment toward which the user's attention is directed includes (13028): in accordance with a determination that the first user input includes a double air pinch gesture comprising two (e.g., or more) pinch inputs (e.g., performed by the same hand) while a hand of a user is oriented with a palm of the hand facing away from a viewpoint of the user, where the double air pinch gesture includes a first air pinch input (e.g., a pinch input or a long air pinch input), a release of the first air pinch input (e.g., breaks contact between the two or more fingers), and a second air pinch input within a threshold time period (e.g., 0.05, 0.1, 0.2, 0.5, 1, or 2 seconds) after releasing the first air pinch input, selecting content associated with the location in the environment toward which the user's attention is directed. For example, as described herein with reference to FIGS. 9T-9U, double air pinch gesture 9512-1 is performed while hand 7022 of the user is oriented with a palm of hand 7022 facing away from a viewpoint of the user 7002, and in response the computer system selects user interface 7121 corresponding to representation 7120 to which the double air pinch gesture 9512-1 is directed. Selecting content associated with a location toward which the user's attention is directed in response to a double air pinch gesture and based on an orientation of the user's palm increases the range of inputs supported and thus enables operations to be performed more quickly and intuitively on the computer system and without displaying additional controls.

In some embodiments, performing the operation associated with the location in the environment toward which the user's attention is directed includes (13030): in accordance with a determination that the first user input includes a double air pinch gesture comprising two (e.g., or more) air pinch inputs (e.g., performed by the same hand) while a hand of a user is oriented with a palm of the hand facing away from a viewpoint of the user, where the double air pinch gesture includes a first air pinch input (e.g., a pinch input or a long air pinch input), a release of the first air pinch input (e.g., breaks contact between the two or more fingers), and a second air pinch input within a threshold time period (e.g., 0.05, 0.1, 0.2, 0.5, 1, or 2 seconds) after releasing the first air pinch input, displaying a cursor at the location in the environment toward which the user's attention is directed. For example, as described herein with reference to FIGS. 9V-9Y, double air pinch gesture 9512-2 is performed while hand 7022 of the user is oriented with a palm of hand 7022 facing away from a viewpoint of the user 7002, and in response the computer system places a cursor 8058 or 8059 at a portion of the application user interface to which the double air pinch gesture 9512-2 is directed (e.g., based on where user 7002's gaze is directed). Displaying a cursor at a location toward which the user's attention is directed in response to a double air pinch gesture and based on an orientation of the user's palm increases the range of inputs supported and thus enables operations to be performed more quickly and intuitively on the computer system and without displaying additional controls.

In some embodiments, performing the operation associated with the location in the environment toward which the user's attention is directed includes (13032): In accordance with a determination that the first user input includes a double air pinch gesture comprising two (e.g., or more) air pinch inputs (e.g., performed by the same hand) while a hand of a user is oriented with a palm of the hand facing away from a viewpoint of the user, where the double air pinch gesture includes a first air pinch input (e.g., a pinch input or a long air pinch input), a release of the first air pinch input (e.g., breaks contact between the two or more fingers), and a second air pinch input within a threshold time period (e.g., 0.05, 0.1, 0.2, 0.5, 1, or 2 seconds) after releasing the first air pinch input, changing a zoom level (e.g., to 100% zoom or +50% zoom) of content displayed at the location in the environment toward which the user's attention is directed. For example, as described herein with reference to FIGS. 9G-9H, double air pinch gesture 7510 is performed while hand 7022 of the user is oriented with a palm of hand 7022 facing away from a viewpoint of the user 7002, and in response the computer system changes a zoom level of media content item IMG-2 in FIG. 9G. Changing a zoom level of content displayed at a location toward which the user's attention is directed in response to a double air pinch gesture and based on an orientation of the user's palm increases the range of inputs supported and thus enables operations to be performed more quickly and intuitively on the computer system and without displaying additional controls.

In some embodiments, the first air pinch input, the release of the first air pinch input, and the second air pinch input are (13034) detected based on a characteristic acceleration of the hand of the user (e.g., the double air pinch is detected based on a characteristic acceleration in a first direction followed by acceleration in a second direction within a time threshold, and/or a second air pinch input is detected within a time threshold after the release of the first air pinch input, and/or the first air pinch input and the second air pinch input are detected based on a characteristic acceleration in a first direction, and the release of the first air pinch input is detected based on a characteristic acceleration in a second direction). For example, as described herein with reference to FIG. 9G, double air pinch gesture 7510 is detected based on an acceleration (e.g., of finger movement magnitude relative to the amount of movement of hand 7022). Detecting the double air pinch gesture based on acceleration helps to provide a more accurate detection of the double air pinch gesture, enables operations to be performed more quickly and intuitively, and reduces the amount of time needed to perform operations on the computer system.

In some embodiments, aspects/operations of methods 11000, 12000, and/or 14000 may be interchanged, substituted, and/or added between these methods. For example, the system user interfaces of method 13000 may be invoked using the criteria described with reference to method 14000, and may optionally be dismissed using gestures described in method 11000 and method 12000. For brevity, these details are not repeated here.

FIGS. 14A-14B are flow diagrams of an exemplary method 14000 of displaying an application switching user interface in response to the detection of a select and hold air gesture, in accordance with some embodiments. In some embodiments, method 14000 is performed at a computer system (e.g., computer system 101 in FIG. 1A) that is in communication with a display generation component (e.g., display generation component 120 in FIGS. 1A, 3A, and 4) (e.g., a head-mounted device (HMD), a display, a projector, and/or a touch-screen) and one or more input devices. In some embodiments, the method 14000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 14000 are, optionally, combined and/or the order of some operations is, optionally, changed.

While an environment (e.g., a two-dimensional user interface or a three-dimensional environment) is visible via the display generation component, the computer system detects (14002) a first air gesture (e.g., performed with a first input element such as a hand or controller) (e.g., the air gesture such as an air pinch gesture that includes a sustained contact between portions of a user's hand) (e.g., long air pinch gesture 10502, as described herein with reference to FIG. 10A). In some embodiments, an application user interface is displayed in the environment visible via the display generation component (e.g., a fully immersive application, where only content from the application user interface is present in the viewport of the user, or a windowed user interface displayed in a subset of the viewport, while other portions of the environment and/or other application user interfaces are concurrently visible). In some embodiments, the application user interface is displayed with an indication that the application user interface is active (e.g., highlighting, outlining, increased opacity, increased brightness, and/or other visual emphasis to indicate that the application user interface is active).

In response to detecting the first air gesture, the computer system displays (14004) an application switching user interface (e.g., concurrently with the application user interface) (e.g., application switching user interface 9002, as described herein with reference to FIGS. 10B-10D). While displaying the application switching user interface, the computer system detects (14006) a first input that includes movement of a first input element (e.g., movement of a hand of a user performing the first air gesture) followed by an event (e.g., a pause in the first input, an end of the first input or a separate selection input such as another air gesture or other input) corresponding to a request to select an active application user interface (e.g., via the application switching user interface) (e.g., the first air gesture continues into the first input, or there is a pause between the first air gesture and the first input). For example, as described herein with reference to FIGS. 10E-10G, while application switching user interface 9002 is displayed, an input 10508 that includes hand 7022 performing an air pinch gesture followed by substantially rightward horizontal movement of the air pinch gesture is detected. The release of user input 10508 while a first input element is directed toward a location on the application switching user interface 9002 is an event corresponding to a request to select an active application user interface. In response, the computer system selects application user interface 10050 associated with representation 9008 (FIG. 10F) of an immersive application as the active application user interface (FIG. 10G).

In response to detecting the first input (14008): in accordance with a determination that the event corresponding to the request to select an active application user interface occurs while the first input element is directed toward a first location (e.g., has been moved to a location corresponding to the first location or has been moved by an amount and/or in a direction that has moved focus to the first location) on the application switching user interface (e.g., the first input includes movement that terminates at a location corresponding to the first location on the application switching user interface) (14010), the computer system displays a first application user interface corresponding to the first location as the active application user interface (e.g., the first location having an associated representation of a first application that corresponds to the first application user interface) (e.g., the computer optionally ceases to display at least a portion of the application user interface); and in accordance with a determination that the event corresponding to the request to select an active application user interface occurs while the first input element is directed toward a second location (e.g., has been moved to a location corresponding to the second location or has been moved by an amount and/or in a direction that has moved focus to the second location) on the application switching user interface (e.g., the first input includes movement that terminates at a location corresponding to the second location on the application switching user interface) (14012), the computer system displays a second application user interface corresponding to the second location as the active application user interface. The second location is different from the first location. The second application user interface is different from the first application user interface (e.g., the second location having an associated representation of a second application that corresponds to the second application user interface) (e.g., the computer optionally ceases to display at least a portion of the application user interface). For example, as described herein with reference to FIGS. 10F-10G, the release of user input 10508 (FIG. 10F) is detected while a first input element is directed toward a location on application switching user interface 9002 associated with representation 9008 of an immersive application. In response, the computer system displays application user interface 10050 as the active application user interface (FIG. 10G). For example, as described herein with reference to FIGS. 10I-10J, the release of user input 10510 (FIG. 10J) is detected while a first input element is directed toward a location on application switching user interface 9002 associated with representation 9010 of an application having application user interface 10010 (FIG. 10I). In response, the computer system displays application user interface 10010 as the active application user interface (FIG. 10J).

Displaying a respective application user interface as the selected active application user interface in response to detecting a first input that includes movement of a first input element followed by an event increases the range of inputs supported and thus enables operations to be performed more quickly and intuitively on the computer system and without displaying additional controls.

In some embodiments, the computer system detects (14014) a termination of the first air gesture after the first air gesture has been maintained for at least a threshold amount of time (e.g., the first air gesture is a pinch-and-hold, long press, or other sustained gesture); and in response to detecting the termination of the first air gesture (e.g., and in accordance with a determination that the first air gesture was maintained for at least the threshold amount of time), the computer system continues to display the application switching user interface (e.g., as a persistent application switching user interface). In some embodiments, detecting the first input while displaying the application switching user interface occurs while continuing to display the application switching user interface after the termination of the first air gesture. In some embodiments, the first input is performed or at least initiated at a location that is different from the location at which the first air gesture was terminated (e.g., the user moves the hand that performed the first air gesture in physical space prior to initiating the first input). For example, as described herein with reference to FIGS. 10B-10D, inputs 10504 and 10506 are performed while hand 7022 of the user is oriented with a palm of hand 7022 facing toward a viewpoint of the user 7002, and in response the computer system continues to display application switching user interface 9002 even after the release of the input 10506. While application switching user interface 9002 is displayed, in response to movement of the input 10504 that results in a first input element (e.g., a hand or a controller) being directed toward a location on application switching user interface 9002 associated with representation 9006, computer system 101 visually emphasizes application user interface 10004 displayed within the viewport compared to application user interface 10002. Displaying a persistent application switching user interface makes the user-device interaction more efficient by not requiring a user to maintain the air gesture, allowing the user a chance to multitask and/or perform a different task before resuming selecting the active application user interface, reducing the number of inputs needs to complete an operation on the computer system.

In some embodiments, while detecting the movement of the first input element (14016) (e.g., as a subsequent portion or continuation of the first air gesture, or subsequent input to the first air gesture while the application switching user interface continues to be displayed after termination of the first air gesture is detected, and prior to detecting the event corresponding to the request to select an active application user interface): in accordance with a determination that the first input element is directed toward the first location (e.g., has been moved to a location corresponding to the first location or has been moved by an amount and/or in a direction that has moved focus to the first location) on the application switching user interface, the computer system displays an indication of the first application user interface corresponding to the first location. In some embodiments, displaying the indication of the first application user interface is different from displaying the first application user interface as the active application user interface. In some embodiments, the indication of the first application user interface includes a representation of the first application user interface that is translucent and/or otherwise deemphasized relative to the first application user interface when the first application user interface is active (e.g., selected and given focus for inputs, in some embodiments, while the application switching user interface is not displayed). In some embodiments, while detecting the movement of the first input element, in accordance with a determination that the first input element is directed toward the second location (e.g., has been moved to a location corresponding to the second location or has been moved by an amount and/or in a direction that has moved focus to the second location) on the application switching user interface, the computer system displays an indication of the second application user interface corresponding to the second location. In some embodiments, the indication of the second application user interface is different from the indication of the first application user interface. In some embodiments, displaying the indication of the second application user interface is different from displaying the second application user interface as the active application user interface. In some embodiments, the indication of the second application user interface includes a representation of the second application user interface that is translucent and/or otherwise deemphasized relative to the second application user interface when the second application user interface is active (e.g., selected and given focus for inputs, in some embodiments, while the application switching user interface is not displayed). In some embodiments, detecting occurrence of an event corresponding to a request to select an active application user interface includes detecting a termination of the first input (e.g., the first input includes an air pinch in which portions of the user's hand are in direct contact, or the first input includes an air pinch and hold, detecting a termination of the first input includes detecting un-pinching, or detecting moving the portions of the user's hand apart). More generally, as the first input element moves prior to termination of the first input (which selects and in some circumstances switches which application user interface is active), the computer system displays an indication of a respective application user interface that corresponds to a current location in the application switching user interface toward which the first input element is directed. For example, as the first input element moves to a third location on the application switching user interface that corresponds to a third application user interface (e.g., the third location corresponding to a third application and optionally to a representation of the third application displayed in the application switching user interface), an indication of the third application user interface is displayed instead of the indication of the first application user interface and the indication of the second application user interface, and so on for any number of application user interfaces that can be selected as active using the application switching user interface. For example, as described herein with reference to FIGS. 10E-10G, a user input 10508 that includes hand 7022 performing an air pinch gesture followed by substantially rightward horizontal movement of the air pinch gesture results in the first input element being redirected from a location on application switching user interface 9002 associated with representation 9004 toward a location on application switching user interface 9002 associated with representation 9008. The release of user input 10508 (FIG. 10F) is detected while the first input element is directed toward the location on application switching user interface 9002 associated with representation 9008 of an immersive application. In response, the computer system displays application user interface 10050 as the active application user interface (FIG. 10G). Selecting an active application user interface based on detecting a termination of the first input enables operations to be performed more quickly and intuitively on the computer system and without displaying additional controls.

In some embodiments, movement of the first input element in a first direction directs (14018) the first input element toward the first location corresponding to the first application user interface, and movement of the first input element in a second direction directs the first input element toward the second location corresponding to the second application user interface. The first direction is different from (e.g., opposite) the second direction. The active application user interface is selected based on a direction of movement. For example, as described herein with reference to FIGS. 10B-10D, a user input 10504 that includes hand 7022 performing an air pinch gesture followed by substantially rightward horizontal movement of the air pinch gesture results in the first input element being redirected from a location on application switching user interface 9002 associated with representation 9004 toward a location on application switching user interface 9002 associated with representation 9006. A user input 10506 that includes hand 7022 performing an air pinch gesture followed by substantially leftward horizontal movement of the air pinch gesture results in the first input element being redirected from a location on application switching user interface 9002 associated with representation 9006 toward a location on application switching user interface 9002 associated with representation 9004. Selecting an active application based on a direction of movement of the first input element enables a user to select an application from the application switching user interface more quickly and with better and more intuitive control.

In some embodiments, movement of the first input element by a first magnitude directs (14020) the first input element toward the first location corresponding to the first application user interface, and movement of the first input element by a second magnitude directs the first input element toward the second location corresponding to the second application user interface. The first magnitude is different from the second magnitude. The active application user interface is selected based on a magnitude of movement. The magnitude of movement may relate to an absolute distance between a location associated with the first portion of the user input and a location associated with the second portion of the user input, an angular rotational amount, and/or a speed of the movement of the first input element. For example, as described herein with reference to FIGS. 10B-10C, a user input 10504 that includes hand 7022 performing an air pinch gesture followed by substantially rightward horizontal movement of the air pinch gesture of a first magnitude results in the first input element being redirected from a location on application switching user interface 9002 associated with representation 9004 toward a location on application switching user interface 9002 associated with representation 9006. As described herein with reference to FIGS. 10E-10F, a user input 10508 that includes hand 7022 performing an air pinch gesture followed by substantially rightward horizontal movement of the air pinch gesture of a second magnitude results in the first input element being redirected from a location on application switching user interface 9002 associated with representation 9004 toward a location on application switching user interface 9002 associated with representation 9008. Selecting an active application based on a magnitude of movement of the first input element enables a user to select an application from the application switching user interface more quickly and with better and more intuitive control.

In some embodiments, displaying the application switching user interface includes (14022) displaying representations (e.g., graphical representations such as icons, or miniaturized snapshots of the open applications) of applications that were recently open (e.g., applications that were open within a threshold amount of time or open in the same use session, or the most recently open applications of applications used were open, are currently open, are operating in a foreground, are operating in the background, or are open but dormant applications) on the computer system (e.g., the representations of the applications are displayed in the application switching user interface, the representations of the applications are displayed in a distinct user interface element, e.g., a recency bar from the application switching user interface) in the application switching user interface. For example, as described herein with reference to FIGS. 10B-10F and 10H-10I, application switching user interface 9002 includes graphical representations 9004, 9006, 9008, 9010 and 9012 of respective applications that are currently open on the computer system. Displaying representations of applications that are recently open on the computer system provides improved visual feedback to the user (e.g., improved visual feedback regarding the applications that are recently open on the computer system) and thus enables operations to be performed more quickly and intuitively on the computer system.

In some embodiments, the representations of applications that were recently open on the computer systems are (14024) arranged within the application switching user interface based on respective times of recent (e.g., last) use of respective applications (e.g., chronologically or reverse chronologically). For example, as described herein with reference to FIGS. 10F-10H, representations of applications on application user interface 9002 are arranged based on respective times of recent use of respective applications. In FIG. 10H, representation 9008 is repositioned to the leftmost position on application switching user interface 9002 indicating the most recently used application (FIG. 10H) from its prior position (FIG. 10F) after the application user interface 10050, which is associated with representation 9008, is selected as the active application user interface (FIG. 10G). Arranging the representations of application based on respective times of recent use of respective applications makes the user-device interaction more efficient by reducing a magnitude of movement of the air gesture to navigate among the more recently used applications that a user is more likely to access, thus enabling operations to be performed more quickly and intuitively on the computer system, without displaying additional controls.

In some embodiments, displaying the application switching user interface includes (14026) displaying a selectable user interface object for displaying (e.g., that, when selected, causes the computer system to display) a home menu user interface (e.g., the home menu user interface includes multiple affordances for launching applications on the computer system, and/or the affordance for displaying the home menu user interface is displayed proximate to, or within a threshold distance from representations of applications that are in use). For example, as described herein with reference to FIGS. 10B-10F and 10H-10I, application switching user interface 9002 includes home affordance 9014. In response to detecting a first input element being directed toward a location on application switching user interface 9002 associated with home affordance 9014, computer system 101 displays home menu user interface 7030 in the viewport. Displaying an option for navigating to a home menu user interface allows a user to select an application different from those displayed in the application switching user interface more quickly, and without having to provide an additional input to trigger display of the home menu user interface affordance.

In some embodiments, while detecting the first input that includes movement of the first input element (14028), and prior to detecting the event corresponding to the request to select an active application user interface: in accordance with a determination that the first input element is directed toward the first location on the application switching user interface, the computer system visually deemphasizes (e.g., increases a degree of blurring, reduces a brightness, reduces a saturation, reduces an opacity, and/or reduces a contrast of) the second application user interface relative to the first application user interface (e.g., and visually deemphasizes application user interfaces other than the first application user interface and/or user interfaces corresponding to the first application); and in accordance with a determination that the first input element is directed toward the second location on the application switching user interface, the computer system visually deemphasizes (e.g., increases a degree of blurring, reduces a brightness, reduces a saturation, reduces an opacity, and/or reduces a contrast of) the first application user interface relative to the second application user interface (e.g., and visually deemphasizes application user interfaces other than the second application user interface and/or user interfaces corresponding to the second application). For example, as described herein with reference to FIGS. 10C-0D, while application switching user interface 9002 is displayed, in response to detecting movement of the user input 10506 which results in a first input element (e.g., a hand or a controller) being directed toward a location on application switching user interface 9002 that corresponds to representation 9004 and being directed away from a location on application switching user interface 9002 that corresponds to representation 9006, the computer system 101 visually deemphasizes, within the viewport, application user interface 10004 associated with representation 9006 compared to application user interface 10002 associated with representation 9004. Visually deemphasizing a second application user interface in accordance with a determination that the first input element is directed toward a location on the application switching user corresponding to a first application user interface provides improved visual feedback that the visually deemphasized second application user interface would not be activated when the air gesture is released at the current position and allows the user to focus on an application user interface that is displayed more prominently than the second application user interface, thus enabling operations to be performed more quickly and intuitively on the computer system, without displaying additional controls.

In some embodiments, while detecting (14030) the first input that includes movement of the first input element, and prior to detecting the event corresponding to the request to select an active application user interface: in accordance with a determination that the first input element is directed toward the first location on the application switching user interface, the computer system visually deemphasizes (e.g., increases a degree of blurring, reduces a brightness, reduces a saturation, reduces an opacity, and/or reduces a contrast of) application user interfaces other than the first application user interface (e.g., or user interfaces corresponding to the first application); and in accordance with a determination that the first input element is directed toward the second location on the application switching user interface, the computer system visually deemphasizes (e.g., increases a degree of blurring, reduces a brightness, reduces a saturation, reduces an opacity, and/or reduces a contrast of) application user interfaces other than the second application user interface (e.g., or user interfaces corresponding to the second application). For example, as described herein with reference to FIGS. 10C-10D, while application switching user interface 9002 is displayed, in response to detecting movement of user input 10506 resulting in a first input element (e.g., a hand or a controller) being directed toward a location on application switching user interface 9002 corresponding to representation 9004 associated with application user interface 10002, the computer system 101 visually deemphasizes other application user interfaces within the viewport, including application user interface 10004 and application user interface 10006, compared to application user interface 10002. Visually deemphasizing application user interfaces other than a respective application user interface in accordance with a determination that the first input element is directed toward a location on the application switching user corresponding to the respective application user interface provides improved visual feedback that the visually deemphasized application user interfaces would not be activated when the air gesture is released at the current position and allows the user to focus on an application user interface that is displayed more prominently, thus enabling operations to be performed more quickly and intuitively on the computer system, without displaying additional controls.

In some embodiments, visually deemphasizing a respective application user interface (e.g., visually deemphasizing the second application user interface relative to the first application user interface, or visually deemphasizing the first application user interface relative to the second application user interface) includes (14032), in accordance with a determination that the respective application user interface is an immersive application user interface (e.g., content from the immersive application user interface substantially fills a viewport when an immersive application is the active application user interface, only content from the immersive application user interface is displayed in a viewport when the immersive application is the active application user interface, and/or content from applications distinct from the immersive application user interface ceases to be displayed in a viewport when an immersive application is the active application user interface), forgoing displaying the respective application user interface. For example, as illustrated in FIG. 10E (e.g., in contrast to FIG. 10F), in response to detecting an air pinch gesture that results in a first input element being directed toward a location on application switching user interface 9002 that does not correspond to representation 9008 associated with an immersive application, the computer system 101 forgoes displaying translucent representation 9050 of the immersive application in the viewport. Forgoing displaying an immersive application user interface in accordance with a determination that the first input element is directed toward a location that is not associated with the immersive application user interface provides improved visual feedback that the immersive application user interface would not be activated when the air gesture is released at the current position and allows the user to focus on an application user interface that is displayed more prominently than the immersive application user interface, thus enabling operations to be performed more quickly and intuitively on the computer system, without displaying additional controls.

In some embodiments, while (e.g., in accordance with a determination that) the first input element is directed (14034) toward a location in the application switching user interface that is associated with an immersive application user interface configured so that content from applications distinct from the immersive application user interface ceases to be displayed in a viewport (e.g., content from the immersive application user interface substantially fills a viewport, only content from the immersive application user interface is displayed in a viewport), the computer system displays the immersive application user interface in the viewport at a respective translucency level (e.g., a first translucency level that causes the immersive application user interface to not be opaque, that is more translucent than when the immersive application user interface is displayed as the active application user interface, and/or at least some content from applications distinct from the immersive application user interface (e.g., windowed applications) is visible while the immersive application user interface is displayed in the viewport at a respective translucency level). For example, as described herein with reference to FIG. 10F, in response to detecting user input 10508 that results in a first input element being directed toward a location on application switching user interface 9002 corresponding to representation 9008, the computer system 101 displays translucent representation 9050 of the immersive application, associated with representation 9008, in the viewport (e.g., prior to release of user input 10508 selecting the immersive application as the active application). Displaying an immersive application user interface at a respective translucency level in accordance with a determination that the first input element is directed toward a location corresponding to the immersive application user interface provides improved visual feedback regarding which application user interface would be activated when the air gesture is released at the current position and thus enables operations to be performed more quickly and intuitively on the computer system, without displaying additional controls.

In some embodiments, the first application user interface is configured (14036) so that content distinct from the first application user interface is concurrently displayed with content from the first application user interface in a portion of a viewport. In some embodiments, in accordance with a determination that the first input element is directed toward a location that is not associated with the first application user interface (e.g., the second location, a location other than the first location and the second location), the computer system displays the first application user interface in the viewport with a first translucency level (e.g., a translucency level that is higher than a translucency level of the first application user interface in the viewport displayed in response to the first input element being directed toward the first location). For example, as described herein with reference to FIGS. 10C-10D, in response to detecting user input 10506 that results in a first input element being directed toward a location on application switching user interface 9002 corresponding to representation 9004, the computer system 101 displays application user interface 10004, corresponding to a different representation 9006, with higher translucency within the viewport compared to application user interface 10002, which is associated with representation 9004. Displaying a first application user interface in the viewport with a first translucency level in accordance with a determination that the first input element is directed toward a location that is not associated with the first application user interface provides improved visual feedback regarding which application user interface would not be activated when the air gesture is released at the current position and allows the user to focus on an application user interface that is displayed more prominently than the first application user interface, thus enabling operations to be performed more quickly and intuitively on the computer system, without displaying additional controls.

In some embodiments, in accordance with a determination that the first input element is directed (14038) toward the first location, the computer system displays the first application user interface in the viewport with a second translucency level that is lower than the first translucency level (e.g., a translucency level that is lower than a translucency level of the first application user interface in the viewport displayed in response to the first input element being directed toward the second location). For example, as described herein with reference to FIGS. 10B-10C, in response to detecting user input 10504 that results in a first input element being directed toward a location on application switching user interface 9002 corresponding to representation 9006, the computer system 101 displays application user interface 10004 (associated with representation 9006) within the viewport with less translucency than application user interface 10002 in FIG. 10C (e.g., and with less translucency than application user interface 10004 in FIG. 10D where the first input element is no longer directed toward a location on application switching user interface 9002 corresponding to representation 9006). Displaying a respective application user interface at a lower translucency level in accordance with a determination that the first input element is directed toward a location corresponding to the respective application user interface provides improved visual feedback regarding which application user information would be activated when the air pinch gesture is released at the current position and thus enables operations to be performed more quickly and intuitively on the computer system, without displaying additional controls.

In some embodiments, displaying the first application user interface corresponding to the first location as the active application user interface includes (14040), in accordance with a determination that the first input element is directed toward the first location on the application switching user interface and that the first application user interface is displayed at a first position within a viewport of the environment, visually emphasizing (e.g., decreasing a degree of blurring, increasing opacity, increasing brightness, increasing contrast, increasing saturation, increasing intensity, increasing contrast, highlighting, displaying a selection outline, and/or other emphasis) the first application user interface relative to the second application user interface (e.g., and visually emphasizing the first application user interface and/or user interfaces corresponding to the first application relative to application user interfaces other than for the first application). In some embodiments, displaying the second application user interface corresponding to the second location as the active application user interface includes, in accordance with a determination that the first input element is directed toward the second location on the application switching user interface and that the second application user interface is displayed at a second position within the viewport of the environment, visually emphasizing (e.g., decreasing a degree of blurring, increasing opacity, increasing brightness, increasing contrast, increasing saturation, increasing intensity, increasing contrast, highlighting, displaying a selection outline, and/or other emphasis) the second application user interface relative to the first application user interface (e.g., and visually emphasizing the second application user interface and/or user interfaces corresponding to the second application relative to application user interfaces other than for the second application). For example, as described herein with reference to FIGS. 10B-10C, in response to detecting user input 10504 that results in a first input element being directed toward a location on application switching user interface 9002 corresponding to representation 9006, computer system 101 visually emphasizes representation 9006 in application switching user interface 9002 while also visually emphasizing application user interface 10004 (associated with representation 9006) within the viewport. Visually emphasizing an application user interface within the viewport in response to detecting the first input element being directed toward a respective location reduces the amount of time needed to begin interacting with the application by providing improved visual feedback regarding a position of the application user interface within the viewport and thus enables operations to be performed more quickly and intuitively on the computer system.

In some embodiments, displaying a respective application (e.g., the first application or the second application) as an active application in response to detecting the first input includes (14042): in accordance with a determination that the first input element is directed toward the first location while the first application user interface is associated with a location (or, optionally located) at a position outside a viewport of the environment, displaying the first application user interface at a respective location at least partially within the viewport of the environment (e.g., an optionally default location, relative to a system user interface, the home menu user interface that would be launched if invoked within the current viewport); and in accordance with a determination that the first input element is directed toward the second location while the second application user interface is associated with a location (or, optionally located) at a position outside the viewport of the environment, displaying the second application user interface at the respective location at least partially within the viewport of the environment. In some embodiments, in accordance with a determination that the first input element is directed toward a respective location on the application switching user interface that corresponds to a respective application that is not displayed within a viewport of the environment (e.g., displayed at a position outside a viewport of the environment), the computer system displays the respective application user interface at the respective location least partially within the viewport of the environment. In some embodiments, displaying a respective application (e.g., the first application or the second application) as an active application in response to detecting the first input includes: in accordance with a determination that the first input element is directed toward the first location while the first application user interface is associated with a location (or, optionally located) at a first position within a viewport of the environment, displaying the first application user interface at the first position within the viewport of the environment (e.g., an optionally default location, relative to a system user interface, the home menu user interface that would be launched if invoked within the current viewport); and in accordance with a determination that the first input element is directed toward the second location while the second application user interface is associated with a location (or, optionally located) at a second position within the viewport of the environment (e.g., different from the first position in within the viewport of the environment), displaying the second application user interface at the second position within the viewport of the environment. For example, as described herein with reference to FIGS. 10H-10J, in response to detecting user input 10510 that results in a first input element being directed toward a location on application switching user interface 9002 corresponding to representation 9010 associated with application user interface 10010 that is associated with a location outside the viewport, computer system 101 visually emphasizes representation 9010 in application switching user interface 9002 while also displaying preview 10011 of application user interface 10010 at a default location within the viewport, and then, in response to release of user input 10510 selecting representation 9010, displays application user interface 10010 (e.g., at the default location) as the active application. Presenting the application user interface at a respective location within the viewport improves operational efficiency by reducing the amount of visual searching for the application user interface within the viewport, and reduces the amount of time before a user can begin to interact with application user interface, improving the operational efficiency of the computer system.

In some embodiments, aspects/operations of methods 11000, 12000, and 13000 may be interchanged, substituted, and/or added between these methods. For example, an application switching interface of method 14000 may also be invoked using the gestures described in method 13000. Optionally a multitasking user interface may be invoked using gestures described in method 11000 and method 12000. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method, comprising:
at a computer system that is in communication with a display generation component and one or more input devices:
while a view of an environment is visible via the display generation component, detecting a first user input; and
in response to detecting the first user input:
in accordance with a determination that the first user input is performed while a hand of a user is oriented with a palm of the hand facing toward a viewpoint of the user, performing a system operation that includes displaying, in the environment, multiple representations of applications; and
in accordance with a determination that the first user input is performed while the hand of the user is oriented with the palm of the hand facing away from the viewpoint of the user, performing an operation associated with a location in the environment toward which the user's attention is directed.

2. The method of claim 1, wherein performing a system operation that includes displaying, in the environment, multiple representations of applications includes:
in accordance with a determination that the first user input includes an air pinch gesture while a hand of a user is oriented with a palm of the hand facing toward a viewpoint of the user and that a home menu user interface is not currently displayed in the view of the environment, displaying the home menu user interface; and
in accordance with a determination that the first user input includes an air pinch gesture while a hand of a user is oriented with a palm of the hand facing toward a viewpoint of the user and that the home menu user interface is currently displayed in the view of the environment, ceasing display of the home menu user interface.

3. The method of claim 1, wherein performing an operation associated with a location in the environment toward which the user's attention is directed includes:
in accordance with a determination that the first user input includes an air pinch gesture while a hand of a user is oriented with a palm of the hand facing away from a viewpoint of the user, selecting content associated with the location in the environment toward which the user's attention is directed.

4. The method of claim 1, wherein performing a system operation that includes displaying, in the environment, multiple representations of applications includes:
in accordance with a determination that the first user input includes a long air pinch gesture while a hand of a user is oriented with a palm of the hand facing toward a viewpoint of the user, displaying an application switching user interface that includes representations of respective applications that were recently open on the computer system.

5. The method of claim 1, wherein performing the operation associated with the location in the environment toward which the user's attention is directed includes:
in accordance with a determination that the first user input includes a long air pinch gesture while a hand of a user is oriented with a palm of the hand facing away from a viewpoint of the user, starting to move at least a portion of a content element positioned at the location in the environment relative to the environment.

6. The method of claim 1, wherein performing the operation associated with the location in the environment toward which the user's attention is directed includes:
in accordance with a determination that the first user input includes an air pinch and drag gesture while a hand of a user is oriented with a palm of the hand facing away from a viewpoint of the user, scrolling one or more content elements positioned at the location in the environment.

7. The method of claim 1, wherein performing the operation associated with the location in the environment toward which the user's attention is directed includes:
in accordance with a determination that the first user input includes an air pinch and drag gesture while a hand of a user is oriented with a palm of the hand facing away from a viewpoint of the user, repositioning a user interface element corresponding to the location in the environment toward which the user's attention is directed from a first element location in the environment to a second element location in the environment based on movement of the first user input.

8. The method of claim 1, wherein the first user input is performed while the hand of the user is oriented with the palm of the hand facing toward the viewpoint of the user and while a user interface of a first application is displayed; and the method includes:
in response to detecting the first user input, displaying an application switching user interface; and
while displaying the application switching user interface, detecting a second input that includes movement of a first input element for selecting an active application user interface from the application switching user interface; and
in response to detecting the second input:
in accordance with a determination that the first input element is directed toward a first location, displaying a first application user interface corresponding to the first location as the active application user interface; and
in accordance with a determination that the first input element is directed toward a second location on the application switching user interface, wherein the second location is different from the first location displaying a second application user interface corresponding to the second location as the active application user interface, wherein the second application user interface is different from the first application user interface.

9. The method of claim 1, wherein performing a system operation that includes displaying, in the environment, multiple representations of applications includes:
in accordance with a determination that the first user input includes a double air pinch gesture comprising two pinch inputs while a hand of a user is oriented with a palm of the hand facing toward a viewpoint of the user, wherein the double air pinch gesture includes a first air pinch input a release of the first air pinch input and a second air pinch input within a threshold time period after releasing the first air pinch input, displaying, in the environment, a control center user interface.

10. The method of claim 1, wherein performing a system operation that includes displaying, in the environment, multiple representations of applications includes:
in accordance with a determination that the first user input includes a double air pinch gesture comprising two air pinch inputs while a hand of a user is oriented with a palm of the hand facing toward a viewpoint of the user, wherein the double air pinch gesture includes a first air pinch input, a release of the first air pinch input, and a second air pinch input within a threshold time period after releasing the first air pinch input and that a home menu user interface is not currently displayed in the environment, displaying the home menu user interface; and
in accordance with a determination that the first user input includes a double air pinch gesture comprising two air pinch inputs while a hand of a user is oriented with a palm of the hand facing toward a viewpoint of the user, and that the home menu user interface is currently displayed in the environment, ceasing display of the home menu user interface.

11. The method of claim 1, wherein performing the operation associated with the location in the environment toward which the user's attention is directed includes:
in accordance with a determination that the first user input includes a double air pinch gesture comprising two pinch inputs while a hand of a user is oriented with a palm of the hand facing away from a viewpoint of the user, wherein the double air pinch gesture includes a first air pinch input, a release of the first air pinch input, and a second air pinch input within a threshold time period after releasing the first air pinch input, selecting content associated with the location in the environment toward which the user's attention is directed.

12. The method of claim 1, wherein performing the operation associated with the location in the environment toward which the user's attention is directed includes:
in accordance with a determination that the first user input includes a double air pinch gesture comprising two air pinch inputs while a hand of a user is oriented with a palm of the hand facing away from a viewpoint of the user, wherein the double air pinch gesture includes a first air pinch input, a release of the first air pinch input, and a second air pinch input within a threshold time period after releasing the first air pinch input, displaying a cursor at the location in the environment toward which the user's attention is directed.

13. The method of claim 1, wherein performing the operation associated with the location in the environment toward which the user's attention is directed includes:
in accordance with a determination that the first user input includes a double air pinch gesture comprising two air pinch inputs while a hand of a user is oriented with a palm of the hand facing away from a viewpoint of the user, wherein the double air pinch gesture includes a first air pinch input, a release of the first air pinch input, and a second air pinch input within a threshold time period after releasing the first air pinch input, changing a zoom level of content displayed at the location in the environment toward which the user's attention is directed.

14. The method of claim 13, wherein the first air pinch input, the release of the first air pinch input, and the second air pinch input are detected based on a characteristic acceleration of the hand of the user.

15. A computer-readable storage medium storing one or more programs configured to be executed by one or more processors of a computer system that is in communication with a display generation component and one or more input devices, the one or more programs including instructions that when executed by the computer system cause the computer system to:
while a view of an environment is visible via the display generation component, detect a first user input; and
in response to detecting the first user input:
in accordance with a determination that the first user input is performed while a hand of a user is oriented with a palm of the hand facing toward a viewpoint of the user, perform a system operation that includes displaying, in the environment, multiple representations of applications; and
in accordance with a determination that the first user input is performed while the hand of the user is oriented with the palm of the hand facing away from the viewpoint of the user, perform an operation associated with a location in the environment toward which the user's attention is directed.

16. The computer-readable storage medium of claim 15, wherein performing a system operation that includes displaying, in the environment, multiple representations of applications includes:
in accordance with a determination that the first user input includes an air pinch gesture while a hand of a user is oriented with a palm of the hand facing toward a viewpoint of the user and that a home menu user interface is not currently displayed in the view of the environment, displaying the home menu user interface; and
in accordance with a determination that the first user input includes an air pinch gesture while a hand of a user is oriented with a palm of the hand facing toward a viewpoint of the user and that the home menu user interface is currently displayed in the view of the environment, ceasing display of the home menu user interface.

17. The computer-readable storage medium of claim 15, wherein performing an operation associated with a location in the environment toward which the user's attention is directed includes:
in accordance with a determination that the first user input includes an air pinch gesture while a hand of a user is oriented with a palm of the hand facing away from a viewpoint of the user, selecting content associated with the location in the environment toward which the user's attention is directed.

18. The computer-readable storage medium of claim 15, wherein performing a system operation that includes displaying, in the environment, multiple representations of applications includes:
in accordance with a determination that the first user input includes a long air pinch gesture while a hand of a user is oriented with a palm of the hand facing toward a viewpoint of the user, displaying an application switching user interface that includes representations of respective applications that were recently open on the computer system.

19. The computer-readable storage medium of claim 15, wherein performing the operation associated with the location in the environment toward which the user's attention is directed includes:
in accordance with a determination that the first user input includes a long air pinch gesture while a hand of a user is oriented with a palm of the hand facing away from a viewpoint of the user, starting to move at least a portion of a content element positioned at the location in the environment relative to the environment.

20. A computer system that is in communication with a display generation component and one or more input devices, the computer system comprising:
one or more processors; and
memory storing one or more programs configured to be executed by the one or more processors, the one or more programs including instructions for:
while a view of an environment is visible via the display generation component, detecting a first user input; and
in response to detecting the first user input:
in accordance with a determination that the first user input is performed while a hand of a user is oriented with a palm of the hand facing toward a viewpoint of the user, performing a system operation that includes displaying, in the environment, multiple representations of applications; and
in accordance with a determination that the first user input is performed while the hand of the user is oriented with the palm of the hand facing away from the viewpoint of the user, performing an operation associated with a location in the environment toward which the user's attention is directed.

21-74. (canceled)
